(19) United States
(12) Patent Application Publication
(10) Pub. No.: US 2023/0109923 A1
(43) Pub. Date: Apr. 13, 2023

(54) SYSTEMS AND METHODS FOR ELECTRONIC INFORMATION PRESENTATION

(71) Applicant: cultureNow, Inc., Long Island City, NY (US)

(72) Inventors: Abby Suckle, New York, NY (US); Anne Lewison, New York, NY (US); David Giglio, New York City, NY (US); Kritika Dhanda, Brooklyn, NY (US); Karan Saharya, Uttar Pradesh (IN); Maharshi Bhattacharya, Somerville, MA (US); Nicole Piepenbrink, Brighton, MA (US)

(21) Appl. No.: 17/963,734

(22) Filed: Oct. 11, 2022

Related U.S. Application Data
(60) Provisional application No. 63/254,648, filed on Oct. 12, 2021.

(51) Int. Cl. G06F 16/28; G06F 16/487; G06F 16/955

(52) U.S. Cl. CPC G06F 16/287; G06F 16/487; G06F 16/9558

(57) ABSTRACT

A computer-based system for curating disparate data sets for a museum-level user experience includes at least one computer server and a relational database residing at least in part thereon. The relational database includes a plurality of types of data building blocks each representing a respective data set. Each of the types of data building blocks includes a plurality of data elements, and each of the data elements represents a type of data and having a plurality of data points. The data building blocks are linkable by shared data in their respective of the data elements, with at least one of the data elements appearing in more than one of the data building blocks. Software resides at least partially on at least one user computing device which includes a user interface enabling a user to interact with the relational database. Multiple building blocks can be combined to form a data feature.

### RELATED APPLICATIONS

Priority is claimed from U.S. Provisional Patent Application No. 63/254,648 filed Oct. 12, 2021, entitled SYSTEMS AND METHODS FOR ELECTRONIC INFORMATION PRESENTATION, the entirety of which is incorporated by reference herein.

### BACKGROUND OF THE INVENTION

### Field of the Invention

The invention is directed to electronic information presentation. More specifically, the invention is directed to systems and methods of curating and presenting disparate sets of data in a museum-level experience for the user.

### Description of Related Art

Museums are the intellectual lifeblood of any society. They serve many roles, allowing people to learn from and connect with the past, bringing communities together, and educating future generations. Whether they are chiefly concerned with art, science, fashion, or any other topic, museums are an excellent way to interact with the outside world. Add in a guided tour or a knowledgeable docent, and the experience is significantly enhanced.

Conceptually, a museum is a physical container showcasing curated content. The content is brought to the viewer—artifacts are assembled in galleries, to tell stories. If what is being displayed is too large or inaccessible, representations are created (drawings, models, and digital copies) to showcase the material.

Most museums are unable to display all of the items in their collections. Not only does it take several years to plan, curate and install an exhibition, but they do not have sufficient gallery space to exhibit everything in their vaults. By their nature, museum collections are eclectic, depending on acquisitions that reflect donations, budgets, and curatorial expertise. The result is that a significant portion of museum holdings remain off-site. Content that is interesting might never be displayed because there may not be enough compatible material to mount an exhibition. The corollary is that when an exhibition is uninstalled, the content only remains accessible to people who were unable to see it, via the catalog and sometimes online.

It can be difficult or even impossible to go to a museum in person. Some museums are not fully accessible to all, barring some members of the community. Widespread catastrophes such as a pandemic or a significant weather event can prevent entire populations from being able to enjoy a museum. The wealth of digital resources and the past several years of altered behaviors due to the COVID-19 virus have dramatically changed how Americans relate to people, places, history, culture, and information.

Consequently, museums have ventured into the digital realm and are in the process of scanning and digitizing their holdings. Acoustiguides have been prepared for users to navigate them. When that is done, their only option for display beyond their buildings is to feature them as a ‘digital gallery’ on their own websites, or to partner with one of the art & culture websites or app developers such as Bloomberg Connects, Google Arts & Culture, Urban Archive, Smartify, or Cuseum to showcase their collection and their self-guided tours.

Each of these apps takes a different approach. Bloomberg Connects invites museums to upload their curatorial material into an app platform that is navigated through QR codes. Urban Archive merges museum collections of photos and self-guided tours with a map-based app. Google Arts and Culture recreates the ‘museum experience’ by showing objects and exhibitions from participant institutions and telling stories around themes.

Other attempts have been made to create a virtual more specialized museum experience such as the Public Art Archive which supports public artworks. There are online archives and mapping collections—such as David Rumsey Map Collection, the Leventhal Collection, and New York Public Library—that have digitized their historic map collections. With the wealth of printed material becoming available on the internet, state-of-the-art book digitization can be found on Google, iBooks, or Kindle, where the user reads printed material on a computer, phone, or iPad. All of these digital exhibitions are ‘flat files’, platforms that primarily do a single thing. The user must navigate between multiple websites to bring together the various content being offered.

At the other end of the spectrum, there are multiple virtual experience platforms from prerecorded self-guided tours to ‘immersive 3D’ experiences which have been built. Each has its limitations either in content, scale, or media.

### SUMMARY OF THE INVENTION

The invention asks the questions:

What if the concept of a museum were flipped and the physical container was removed so that the world outside became the exhibition?

How can you create a curated museum level experience that would explain how places came to be to any user irrespective of their location?

How do you link the physical geography to the built environment (such as architecture) to the cultural insertions (such as public art) to the people who had the impact?

How do you show what happened in a spot over time as well as what might occur in the future, given factors like climate change?

And how do you tell the stories both online and through smartphones to the viewer who is standing in the place itself in a way that is both immediate and not a cacophony of extraneous information?

In other words, wouldn't it be ideal to take advantage of the features that smartphones have and utilize them to create a museum of the world outside—one that travels with the user? The user could point their smartphone at a work of art or a building and listen to the artist, historian or curator explain their work while looking at the many images, drawings, and documents about it that may be not otherwise readily accessible. The phone also tells them what's nearby and helps them navigate to it, helps them take a self-guided tour or curate one of their own, find information, meet the people involved, attend exhibitions and programs, and perhaps also add content. How do you combine some of the encyclopedic and curatorial information of Wikipedia with the connection and relational insights of Facebook, LinkedIn, and other social media with the geotagged locations of Google in a way that is information rich but easy to navigate?

With the vast amount of information that is available online, the burden falls on the user to spend precious time navigating this scattered information on multiple websites to search for relevant material. Museum professionals and librarians have developed data management systems unique to their individual disciplines and institutions. There are different database systems developed for visual information libraries, document archives, public libraries, historic content, public art, architecture, periodicals, and media, as well as the more technical data-driven maps, etc. What is missing is a single platform that knits these elements together to display the disparate and siloed, but broad-ranging material; a system that has many data fields that are critical to the understanding of each area and then fields that can be common to all. The first step would be to define what is needed to describe each element and organize it and then create the content management system and accommodate all the potential variations.

To fill this gap in historic and cultural data management, the invention provides an interactive, curated digital repository of historic and cultural information that provides deep-linked searches for a variety of data sources, including (but not limited to) data on historic and current people of renown, sites, maps, artworks, and documented events of importance, as well as secondary items that augment these elements, such as podcasts, tours, climate data maps, and other media.

The digital repository brings out the interconnectedness of these mentioned items—the links that have existed between seemingly unrelated historic figures, places, events, and artifacts. The categorization and organization of this data are such that the platform offers users a text-light, easy-to-use, visual and accessible representation of the database, and various levels of relations that exist within its contents. The database, through the web and the mobile app (hereafter referred to as “the platform”), acts as assists and guides, offering a comprehensive set of digital tools for exploring areas through a cultural and historic lens. It intends to enhance the exploratory experience whether the visitor is on foot or sitting behind a computer screen, all the while ensuring flexibility. It intends to enhance the exploratory experience whether the visitor is on foot or sitting behind a computer screen, all the while ensuring flexibility.

Additionally, through user accounts, the platform allows different types of curators, organizations, and institutions (including museums) to contribute to the platform with data that is credited to them, thus enriching the repository overall. The invention essentially includes systems and methods for electronic information collection management and presentation and tools that are not available to curators of physical museums, allowing them the flexibility to develop exhibitions that are independent of the amount of content available to display in a single location. These exhibitions could be small for a limited or specialized audience or large for a national or international audience, thus giving them the opportunity and flexibility to create exhibitions whenever they are ready and not on a fixed schedule. The inventive relational database enables scale where needed without requiring any links beyond the minimum. The digital collection is divided into Building Blocks or Features or Elements such as Sites and People (equivalent to the objects), Images, Media, Maps (how the material is displayed), and Events. Information is displayed to the user through Collections, Tours, and Playlists because of the connectivity between the Elements, via list, grid, and page views, as well as multiple Map Views which both layer and highlight the tiered relationships between the information. The platform can accept extremely high-quality content (very high-resolution TIFF images and PDFs). Supporting it are Historic and GIS (Global Information System) ‘big data’ maps that are accurately georeferenced and show what places looked like in the past or might look like in the future.

Additionally, there are many filtered views available for the user. There are interactive data Relationship Maps that are created showing the tiered and linked relationships between the building blocks and the elements. Curators have the opportunity to describe links that exist between seemingly unrelated historic figures (People), places, stories, and artifacts (Sites).

There are multiple ways for the User to experience the platform so that it is not only interesting and informative, but easy to navigate for different kinds of Users, be they tourists, explorers, researchers, teachers, designers, or architects. On one end of the spectrum are casual Users and at the other the stewards (Admin Curators) of our cultural assets who need accurate documentation of what might be impacted during extreme events such as climate change. Consequently, how the information is presented to these different audiences needs to be extremely engaging, accessible, and highly informative.

The Building Blocks—Typologies and Categorization of the cultureNOW Virtual Museum Database

The basis of the cultureNOW platform is the ‘Building Blocks’. ‘Site’ (see FIGS. 3A and 3B) carries a broad meaning as it is intended to cover everything that can be geotagged, ranging from a work of public art to a large planning project that might be encountered in the ‘outside world’. The title of the next major Building Block, ‘People’ (see FIGS. 4A, 4B, and 4C) is used expansively to include People encompassing a Person (Plural: Individuals), an Organization, a Publication, or Animal who have a connection with any of the Sites. The ‘Images’ (see FIGS. 5A and 5B) Building Block references all relevant imagery (historic or otherwise) including maps, photographs, drawings, and documents. The two other Building Blocks are ‘Maps’ (see FIGS. 8A, 8B, and 8C) and ‘Special Features’ (see FIG. 7). Lastly the platform also includes an ‘Event’ (see FIG. 9) module for upcoming (and past) programs and Event Series. All the aforementioned Building Blocks consist of ‘Elements’ and are presented to the user through multiple online interfaces.

Organizational Structure and Relations

These Building Blocks form the root of the structure into which all the curated data is organized.

Next, for each of these Building Blocks, the basic required information will be identified. For Sites, these include Title, Date (of construction, demolition, or of any event that occurred on the Site), Category (what kind of Site or building it is—museum, government, archaeological dig site, infrastructure, etc.), Location (coordinates, street address(s), in case of multiple addresses associated with the Site), People (related to the Site, maybe an architect, etc.), Description about the Site, any Associated Sites, Images of the Site (from history, current, etc.), Podcasts (associated with the Site, maybe made by experts who are knowledgeable about it), Awards and Designations, Events and Tours (this draws from the Dates), Maps, On this Day, and In this Photo (this also draws from the associated Images).

For People, the basic information would include Name, Contact, Affiliation, Date, About, Associated Sites, Images, Podcasts, Awards and Highlights, Events and Tours, Maps, On this Day, and In this Photo. Similarly, for Events and Maps, the basic information helps place the item in history as well as geography.

It must be noted that within these Building Blocks, part of the interconnected and nested information includes:
Information about Sites in the People Building Block, such as Associated Sites, Events and Tours.
Information about People, Location, Events, and Images in Sites, such as Location, Associated Sites, People, On This Day/In this Photo, etc.
Information about People, Related Sites, and Events in Images, Podcasts, Events, and Maps.

This brings out the uniqueness of the platform, in that it allows for a thorough cross-referencing across the categories as and when the data is being added to the platform. Let's take George Washington as an example. By the time his basic information is added and made Live on the platform, users can already see how he is connected to various historic Sites, Events, Images, and other historic figures (who are already part of the database and thereby the platform) by virtue of how the platform structures new information. Curators or users with special access can set up relational insight for the frontend users as well as position data, both historical and geographical, at the onset with no extra effort on their part.

The frontend UI and backend Content Management System aid in this cross-referential organization by offering the flexibility to choose between adding new text and media and/or connecting existing information from the database (by way of dropdown menus, for instance) to newly added data when required.

Referencing is made even more granular by Building Block-specific tools (Special Features) where the interconnectedness of more than one Building Block is accurately established: such as on the In This Photo feature (see FIG. 19), where Sites and People can be tagged on to Images, as well as On This Day/In This Month/In This Year (see FIG. 17), What Happened Here (see FIG. 15), and Places Over Time (see Timeline FIG. 16).

Exploration Tools

To be able to explore these Building Blocks, there are many exploration tools for the user. Podcasts (see FIG. 6), for instance, are organized into Playlists (see FIG. 12). These can be themed around a topic, a location, a person, an organization, an event, or a site. If the user doesn't want to listen to a curated one, they can either edit a saved copy of the Playlist or create a customized one of their own. Tours (see FIG. 11) also reflect actual physical tours that a user might take as well as virtual tours, made available to the user online, that describe multiple places along a defined route and across a historic timeline. The virtual tours are organized by themes such as ‘resiliency’, ‘archeology’, ‘architecture’, ‘planning’, and so on, in keeping with the typology of places contained therein. They could also describe the places featured in historic events, such as the Revolutionary War. The user has the flexibility to either utilize one of the preassembled tours or utilize some content and customize it to accommodate their interests. A teacher, for instance, might create some podcasts, sites and a tour to highlight a subject that the class is studying and may only be relevant to those students.

Site/Artifact Identification, Thematic Search and Near Me

While walking on a suggested or custom-built tour, the tourist might encounter buildings, plazas, statues, or other artifacts that, although not part of the tour, are in the vicinity of other relevant sites. The app user can take pictures of such artifacts (see FIG. 27) and using image recognition, the app provides the user with all the related information available on the platform, through varying degrees of connections. This may include, but is not limited to, relevant buildings/artifacts in the neighborhood, people associated with the site, events that may have occurred there, podcasts made by a knowledgeable person that offer insight and perspectives on the artifact, etc. The user can also utilize the ‘smart search’ feature and search for meta tags.

If a user is exploring an area, not just as part of a tour but also on foot, with the phone app as an informational guide, the ‘Near Me/What's Around Me’ (see FIGS. 14 and 22) feature in the app makes suggestions about what the user might find interesting in their vicinity, including sites, events, people, and tours. The dynamic nature will allow for multiple enhancements that can be tailored to the specific interests, locale, and available time of the user. For the tourist who might be interested in finding out about an artwork or a building they are looking at, they need only enter their location, snap a photo or type in a query and the platform will present whatever content is available. As the user walks through the city, the user has the ability through an action button to receive pop-ups on the phone or on the map to alert to “On This Date”, “What's Around”, as well as available podcasts and “Then and Now” maps and photographs. Geo-located recommendations for visiting nearby sites and “what's on now” at various cultural sites will encourage exploration and curiosity. These recommendations are generated by the cultureNOW platform based on the location of the user, through cutting-edge features such as image recognition and geo-location.

Image Search

The platform incorporates image recognition software allowing the user to point their smartphone at a building, artwork, plaque, or even a street corner and the phone will let the user know what they are looking at, what happened in this place, or show you a “Then and Now” slider with historic photos of what the area used to look like. These are linked to media which includes images and podcasts. This will work via reverse image search software that geotags the user and searches the images within the platform with the same metadata supplemented by GoogleLens. It will also work on the website with a different user interface.

Contextualizing in History—Historic Referencing

In this Photo

The platform uses the latest in facial recognition and image tagging for the ‘In This Photo’ (see FIG. 19) feature,

where images of renowned people and places across the database have been identified and accordingly tagged to inform the user of who or what each image shows. It is being used in four main ways. The user can look at a historic photo or drawing of a historic scene and the people and places represented are labeled and hyperlinked to their respective pages on the cultureNOW platform; a cityscape or aerial photo where the buildings are labeled and hyperlinked; a document or drawing such as an architectural plan where detail are highlighted; or a book where a portion of the text is labeled, cited, or referenced.

On this Day/Month/Year

This feature offers a way to shift from a site-centric exploration to a time/date-centric exploration. Because descriptions are date tagged, the platform can filter by date and a user is apprised of all the events documented in the cultureNOW database that may have occurred on this date, related to various sites, people, and artifacts through time (see FIG. 17).

Then and Now

Through this feature, a visitor can see changes over time using the ‘Then and Now’ image slider comparison of two or more images of the same location from different points in time (see FIG. 18).

Places Over Time

This feature utilizes the description by date field to create a timeline for every site with more than one date event (see Timeline FIG. 16).

What Happened Here

Since every site is geotagged, the platform can display the stories and events and the place where they occurred or places nearby (see FIG. 15).

Georeferencing in History

Map View

All content on the platform, since geotagged, can be displayed in a Map View. Each item page for people, sites, or events, has a ‘Map View’ that the user can access to see the location of their item of interest. Whether it's a landmark—a building, a sculpture, or the location of a historic event—the route of a tour, a region within a city, or sites neighboring the user's item of interest, all these can be viewed as pins, route-lines, and areas marked as polygons on an inbuilt map within the cultureNOW platform. ‘Maps’, as a separate element that provides access to all this data, is also accessible through the main menu on the Home Page (see FIG. 14).

Historic Maps, Data Maps, and Interactive Data Relationship Maps

The Map feature is made even more robust and comprehensive through the use of Historic Map, Data Map overlays, and Relationship Mapping interfaces.

The historic map interface (see FIG. 8B, 8C) overlays a scanned, georeferenced, historic map onto the present-day satellite basemaps, to show to the user how the area being explored may have looked at a particular moment in history. A user can view these maps, overlaid on the ‘Map View’ 81 along with other location pins, route lines, and areas for context, and can also toggle transparency, to understand how the spatial arrangements from the past are positioned today.

Using data from open data sources such as USGS (U.S. Geological Survey) and NOAA (National Oceanic and Atmospheric Administration), the platform has various data-generated maps or GIS maps (see FIG. 8B) that encompass topics of climate, demographics, population movement, and other large scale events that, cross-referenced with the georeferenced cultural asset database, provide an accurate risk assessment.

Interactive Data Relationship Mapping 63 (see FIG. 20A, 20B, 20C, 20D, 23A, 23B) creates a superimposed network of buttons on a bespoke map interface, that demonstrates the various linkages between seemingly disparate building blocks. Querying on the cultureNOW database through the app or the web platform apart from a textual search method also provides the user with a holistic view of the database and its relation to the user's search query (with the primary search query as the focus), using the Relationship Map Dashboard. The user can view and sift through various connection hierarchies as well as different levels of connection between the primary search query and the related/associated people, places, and events.

All these additional map features are unique to cultureNOW and make the platform more interactive and dynamic.

User Accounts

To access this repository, the user can sign in for varying levels of access depending on their end goals. User Accounts (see FIGS. 21A and 21B) on the platform are divided into two main categories catering to a wide range of individuals and organizations with varying agendas: Guest Users and Account Holders.

Guest Users are allowed to browse the Website and Mobile App. They also have the ability to Share content on Social Media.

Account Holders are users who have repeated interaction with the site, and create personal or organizational accounts with their email IDs.

The four types of Account Holders are described below.

Curator accounts are of two types. Admin Curators are high-level super users that have complete editing ability. They can review and modify every element in the platform to either edit it or filter it out of a specific table before publishing, including adjusting all the tiered relationships between Sites, People, Dates, Media, and the written content to describe them. Limited Curator accounts are designed for the Collection Manager of a Public Art Collection who would have the ability to adjust the content specifically for their collection. The site has additional collection management features (repair, accessions, notes) to aid them.

Portfolio accounts could be educational, businesses, or other organizations that might want to tailor the museum content to their particular audience and utilize the platform for more specialized material. They would be able to create their own Podcasts and Sites, select whatever digital museum content is appropriate, and then publish them to their individual audiences. Analytics can be provided to show who accessed the information, for how long, etc.

Another level of Portfolio accounts provides the ability to choose from a limited palette of options to dress the user interface screens for the website and app so that they would be personalized. Typical account holders include architectural firms, professorships, educational institutions, etc.

Explorer accounts mimic museum memberships and are tiered ranging from free to paid. These include Individual, Duo, Family, and Patron.

The content on the platform can be viewed either through the website or the phone app.

Web Site and Mobile App

The Website Layout is such that the home page highlights the major components of the collection and introduces the user to the different features that are available on the platform. Every day different sites, events, tours, playlists, and other items are featured. As the user scrolls down, they can explore some of the highlights or go to the menu bar to view the collections, maps, or additional material. The user has the option to click on one of the images or search the site. There is also a reverse image search where the user can upload a photo from their phone, drive, or computer and the platform will identify it if it is in the database.

The Mobile App, although fed by the same database as the website, is organized differently.

Lastly, the Content Management System (see FIG. 21C) has been organized to allow the curator a great amount of flexibility in how the information is entered into the database. Via backend access to the platform, collection management allows for adding, deleting, and editing content and functionality varying depending on the type of user accessing the system.

In one embodiment, the invention is a computer-based system for curating disparate data sets for a museum-level user experience of presentation of the data sets, having at least one computer server and a relational database residing at least in part on the computer server. The relational database includes a plurality of types of data building blocks, each of the types of data building blocks representing a respective data set, each of the types of data building blocks including a plurality of data elements, each of the data elements representing a type of data and having a plurality of data points. The data building blocks are linkable by shared data in their respective of the data elements, at least one of the data elements appearing in more than one of the data building blocks and functioning as a linking node to respective common of the data building blocks. Software resides at least partially on at least one user computing device, the software including a user interface enabling a user to interact with the relational database. The shared data may further include at least one of interconnected or nested data, thereby enabling cross-referencing across the data building blocks. The plurality of types of data building blocks may include at least two of sites, people, images, maps, or media. The interconnected or nested data may include site data in the people building block; at least one of people, location, events, or images in the sites building block; at least one of people, sites, or events in the images building block.

Preferably, the inventive system further includes a content management system in communication with the relational database and adapted to allow a curator user to connect existing information from the database between different types of data building blocks. The content management system preferably further includes a plurality of building block-specific modules allowing the curator user to link at least two of the data building blocks via predetermined data elements.

The software may preferably receive geolocation information from the user computing device and alert the user via the user interface when the user computing device is within a predetermined distance of a geotagged one of the data points. The software may preferably receive image information from the user computing device and alert the user via the user interface about any of the data points that are connected to the received image information. The image information user alerts may include hyperlinks, activatable by the user via the user interface, that link to other of the data points.

The interconnected data may include date-tagged map image data having the same location but different date tags. In addition or the alternative, the interconnected data may include date-tagged map image data having the same location but different date tags, wherein the interconnected date-tagged map image data is presented on the user interface as two or more images of the same location at different points in time. In the latter case, the user interface enables the user to toggle between the two or more images via a slider selectively showing a first part of one of the images and a second part of another of the images simultaneously.

The relational database may further include data features each including multiple of the data building blocks.

The software may further include a relationship mapping visualization module, adapted to display on the user interface hierarchical relationships between at least one of: i) two of the data building blocks; ii) two of the data features; or iii) one of the data building blocks and one of the features.

The software may further include a portfolio management module, adapted to enable a user to create a private portfolio of data with customizable and selectable of at least one of the data building blocks or the data elements and links therebetween.

In an embodiment, the invention is a relational database structured to enable curation of disparate data sets for a museum-level user experience of presentation of the data sets. The relational database includes a plurality of types of data building blocks, each of the types of data building blocks representing a respective data set, each of the types of data building blocks including a plurality of data elements, each of the data elements representing a type of data and having a plurality of data points. The data building blocks are linkable by shared data in their respective of the data elements, at least one of the data elements appearing in more than one of the data building blocks and functioning as a linking node to the respective common of the data building blocks.

The shared data may further include at least one of interconnected or nested data, thereby enabling cross-referencing across the data building blocks. The plurality of types of data building blocks may include at least two of sites, people, images, maps, or media. The interconnected or nested data may include: site data in the people building block; at least one of people, location, events, or images in the sites building block; at least one of people, sites, or events in the images building block.

The relational database may further include a content management system in communication with the relational database and adapted to allow a curator user to connect existing information from the relational database between different types of data building blocks. The content management system may further include a plurality of building block-specific modules allowing the curator user to link at least two of the data building blocks via predetermined data elements.

The relational database may further include data features each including multiple data building blocks.

### BRIEF DESCRIPTION OF THE DRAWINGS

FIG. 1 is the ORGANIZATIONAL STRUCTURE of the database system linking curated data and media in time and place, in accordance with an embodiment of the invention.

FIG. 2 is a flow chart of the data entry main logic flow when entering a Site LOCATION, in accordance with an embodiment of the invention.

FIG. 3A is a detailed flow chart of data organization within SITE category, in accordance with an embodiment of the invention.

FIG. 3B is a flow chart of the data entry main logic flow when adding SITES, in accordance with an embodiment of the invention.

FIG. 4A is a flow chart of the detailed form data entry main logic flow when adding PEOPLE, in accordance with an embodiment of the invention.

FIG. 4B is a flow chart of the data entry main logic flow when adding PEOPLE type, in accordance with an embodiment of the invention.

FIG. 4C is a detailed flow chart of data organization within PEOPLE credited projects, sites, and albums, in accordance with an embodiment of the invention.

FIG. 5A is a flow chart of data organization and presentation associated with IMAGE types, in accordance with an embodiment of the invention.

FIG. 5B is a flow chart of the data entry main logic flow when adding and editing IMAGES, in accordance with an embodiment of the invention.

FIG. 6 is a flow chart of the data entry main logic flow when adding and editing PODCASTS, in accordance with an embodiment of the invention.

FIG. 7 is a flow chart of the data entry main logic flow when adding SPECIAL FEATURE Recipes, in accordance with an embodiment of the invention.

FIG. 8A is a flow chart of the data entry main logic flow when adding MAPS, in accordance with an embodiment of the invention.

FIG. 8B is a detailed flow chart of data organization within MAP types, in accordance with an embodiment of the invention.

FIG. 8C is a flow chart of the data creation and entry main logic flow when creating and uploading a georeferenced MAP, in accordance with an embodiment of the invention.

FIG. 9 is a flow chart of the data entry main logic flow when adding EVENTS, in accordance with an embodiment of the invention.

FIG. 10 is a flow chart of the data entry main logic flow when adding EVENT SERIES, in accordance with an embodiment of the invention.

FIG. 11 is a flow chart of the data entry main logic flow when adding TOURS, in accordance with an embodiment of the invention.

FIG. 12 is a flow chart of the data entry main logic flow when adding PLAYLISTS, in accordance with an embodiment of the invention.

FIG. 13 is a flow chart of data organization within COLLECTIONS, in accordance with an embodiment of the invention.

FIG. 14 is a flow chart of data organization within the HOME PAGE, in accordance with an embodiment of the invention.

FIG. 15 is a flow chart of data organization within the WHAT HAPPENED HERE feature, in accordance with an embodiment of the invention.

FIG. 16 is a flow chart of data organization within the TIMELINE and the PLACES OVER TIME features, in accordance with an embodiment of the invention.

FIG. 17 is a flow chart of data organization within the ON THIS DAY/IN THIS MONTH/IN THIS YEAR feature, in accordance with an embodiment of the invention.

FIG. 18 is a flow chart of the data entry main logic flow when adding and editing THEN AND NOW Images, in accordance with an embodiment of the invention.

FIG. 19 is a flow chart of the data entry main logic flow when adding and editing IN THIS PHOTO image tagging, in accordance with an embodiment of the invention.

FIG. 20A is a flow chart of data organization within the RELATIONSHIP MAPPING feature, in accordance with an embodiment of the invention.

FIG. 20B is a flow chart of data representation at various scales within the RELATIONSHIP MAPPING feature, in accordance with an embodiment of the invention.

FIG. 20C is a flow chart of data reorganization when a first-degree Child becomes a Parent within the RELATIONSHIP MAPPING feature, in accordance with an embodiment of the invention.

FIG. 20D is a detailed flow chart of data representation between Sites and People within the RELATIONSHIP MAPPING feature, in accordance with an embodiment of the invention.

FIG. 21A is a detailed flow chart of data entry for various tiers of platform USERS, in accordance with an embodiment of the invention.

FIG. 21B is a flow chart of data access and representation to various tiers of platform USERS, in accordance with an embodiment of the invention.

FIG. 21C is a flow chart of the CONTENT MANAGEMENT SYSTEM data entry structure, in accordance with an embodiment of the invention.

FIG. 22 is a flow chart of data access and representation to platform users via SEARCH, in accordance with an embodiment of the invention.

FIG. 23A is an exemplary screenshot depicting RELATIONSHIP MAPPING VISUALIZATION in accordance with an embodiment of the invention.

FIG. 23B is an exemplary screenshot depicting RELATIONSHIP MAPPING VISUALIZATION NETWORK DIAGRAM in accordance with an embodiment of the invention.

FIG. 24 is an exemplary screenshot depicting the Website Site FRONTEND UI in accordance with an embodiment of the invention.

FIG. 25 is an exemplary screenshot depicting the CONTENT MANAGEMENT SYSTEM—Add a Site—Image Tab in accordance with an embodiment of the invention.

FIG. 26 is an exemplary screenshot depicting the IN THIS PHOTO TAGGING and the THEN AND NOW IMAGE SLIDER on the LARGE IMAGE VIEW, in accordance with an embodiment of the invention.

FIG. 27 is an exemplary screenshot depicting the IMAGE SEARCH/IMAGE RECOGNITION in accordance with an embodiment of the invention.

FIG. 28 is an exemplary screenshot depicting the TIMELINE and PLACES OVER TIME features in accordance with an embodiment of the invention.

FIG. 29 is an exemplary screenshot depicting LOCATIONS Element in accordance with an embodiment of the invention.

FIG. 30 is a block diagram of an exemplary computing environment within which various embodiments of the invention may be implemented and upon which various embodiments of the invention may be employed.

### DETAILED DESCRIPTION OF THE INVENTION AND DRAWINGS

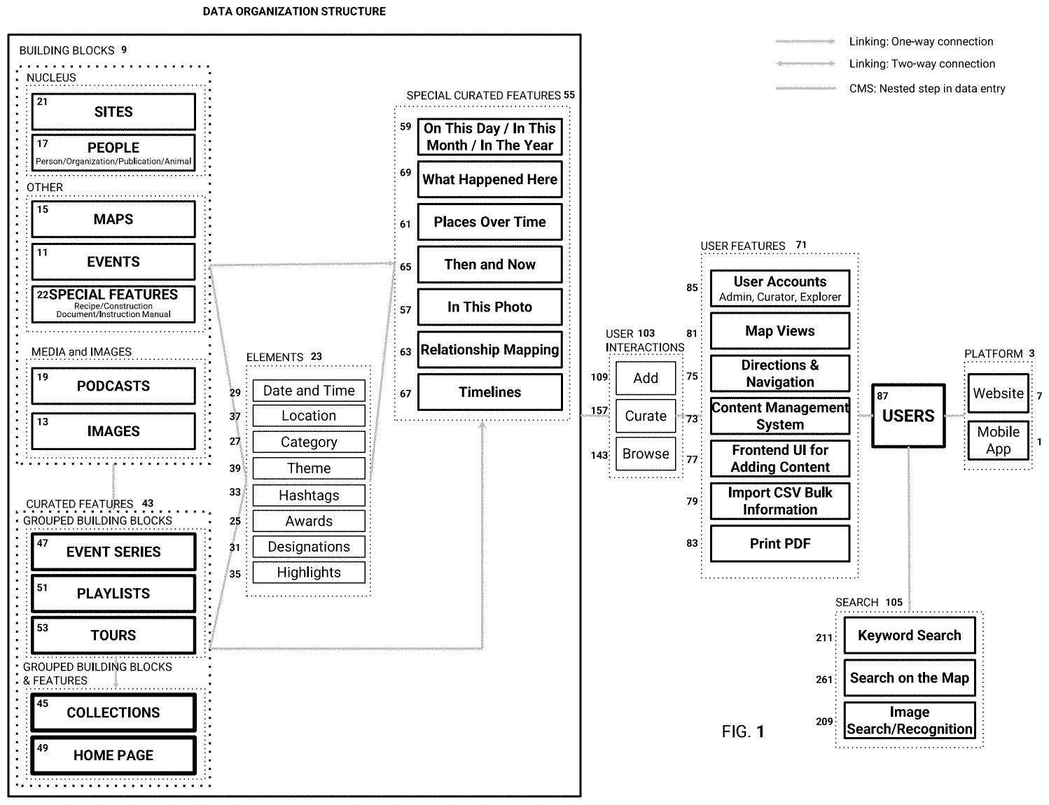

Description will now be given with reference to the attached FIGS. 1-30. It should be understood that these figures are exemplary in nature and in no way serve to limit the scope of the invention, which is defined by the claims appearing hereinbelow.

Organizational Structure

FIG. 1 outlines the structure of the Content Management System, which is described in more detail below. It is conceived as a relational database. The foundational components are called Building Blocks 9. They are listed below and described more fully in the sections devoted to them. Sites 21 and People 17 (which includes a Person, Organization, Publication, and Animal) form the nucleus of the virtual museum. Maps 15 and Events 11 are location and date-dependent. Special Features 22 include Recipes, Construction Documents, and Instruction Manuals. Media and Image Building Blocks consist of Podcasts 19 (both audio and video) and Images 13 (including Drawings and Documents).

Elements 23 are data points that sit within Building Blocks and Features and act as linking nodes connecting them to each other. They serve an important role by situating information in place, space, and time. Typically a relational database will have some fields common to multiple tables so that the changes in one table replicate in others. Here, Elements are linking nodes that anchor the information in place, space, and time. The Elements are: Date and Time 29, Location 37, Category 27, Theme 39, Hashtags 33, Awards 25, Designations 31, and Highlights 35. Probably the most important Element is the Location function. Every single data point on the platform can be geotagged. This includes all the Building Blocks and Features.

Curated Features 45 are composed of grouped Building Blocks or Features, combined and packaged in various ways. Both automatically and/or manually produced, these features require a less-involved data entry and curation process than Special Curated Features. Events, for instance, can be grouped into an Event Series 47. For example, an all-day symposium (Event Series) would consist of multiple panel discussions (Events). Similarly, Podcasts are grouped into Playlists 51, and Sites are grouped into Tours 53. Museums display their content in galleries. Here, the Building Blocks are organized into Collections 45. There are many Collections because it is possible to organize the information in many ways—by type of content, category, or theme. Following the museum analogy, the Home Page 49 is a temporary exhibition where content changes daily.

Special Curated Features 55 set the platform apart from a typical museum. These are interactive features available to curators that cohere data and media into new visual representations of place, space, and time. They require more involved data entry and curation and are described in the relevant sections. The On This Day/In This Month/In This Year 59 feature describes date events. What Happened Here 69 links Events and Stories category Sites to locations. Places Over Time 61 creates a timeline of events at a single location. Then and Now 65 shows Images—2 or more photographs or drawings are overlaid with a slider to illustrate how buildings or streetscapes have changed over time. In This Photo 57 utilizes image tagging to search for People or Sites that appear in Images. Relationship Mapping 63 displays the ‘six degrees of separation’ linking People with Sites. It is a visual, interactive representation of interconnected cultureNOW data, made possible by the complex and nuanced linkages between Building Blocks and Elements. Most Building Blocks and Features have a Timeline 67 to show how a place changes over time and the stories that had an impact on the place.

Because the museum is virtual and the database is very large, users need to be able to find the content that they are looking for. The Search 105 component is robust, including a filtered typed Keyword Search 211, Searching on the Map 261 (including exploring an area on the visible map area and what's near the user), and Image Search/Recognition 209 (where a user can simply take a photo of an item, or find one on their computer, and the search engine will identify if it is in the collection).

There are multiple User Features 71 programmed on the Website 7 and Mobile App 1, which are addressed in their specific sections. They include: User Accounts 85, the Content Management System 73, Map View 81, Directions and Navigation 75, Frontend UI for adding user content 77, importing CSV bulk information 79, and printing PDFs 83 (a specially formatted print version for any of the material on the platform).

User Feature:

Website Layout

The website is laid out to provide the user with multiple options for viewing content. The Home Page (landing page) has been designed in a museum format to highlight the major components of cultureNOW content and introduce the user to different building blocks and features that are available on the platform. Every day different Sites, Events, Tours, Playlists, and other items are showcased. As the user scrolls down, they can explore some of the highlights or go to the menu bar to view Collections, Maps, or additional material.

The user has the option to click on one of the sections to go to the Building Block or Feature. There is also a smart Keyword Search with the option to filter the search results by Item Type, Category, Date, Theme, Location, etc. The search results can be viewed as a List, Grid, or Map View. Each view has a quick preview mode where more information about the item can be seen. There is also a reverse image search where the user can upload a photo from their phone, drive, or computer and the platform will identify it if it is in the database.

The Page View is the typical way individual content is displayed to the User. The Site pages are laid out with written information on the left column, a Banner Image on the top, and available content displayed in thumbnails. If there are date events, a Timeline appears. Clicking on any item on the timeline will scroll to the item on the right side of the page related to the date on the Timeline. It will also highlight the relevant content on the left and right sides by making all other content transparent. Since Sites encompass everything from artifacts and buildings to events and stories, Depending on the Site, the Page View display could include more content. It would also show the associated and related sites and people.

The content on the People pages is arranged similarly, with information about the Person/Organization/Publication/Animal on the left. A grid view of thumbnails is on the right side arranged hierarchically with Sites directly connected appearing on the top. Below them are Related Sites. Then the user will see publications, writings, additional photographs, drawings, Playlists curated by the person, and Playlists featuring the person. If the person's work has been featured in a Tour, Event, or Podcast, that will also appear. Similarly, any attached Maps will be displayed. Similar to Sites, each photo is clickable. Clicking on an Image takes the user to the Large Image View. If the user clicks on text, they will be taken to the page for that item (Site, Podcast, Map, etc.).

The Large Image View enables the user to view individual images more closely. They can zoom in on the images on a large scale and see illustrative captions and descriptions to tell complete stories about each image.

There is a Map View of every Building Block and Feature, which allows the user to geographically locate items and to overlay Historic and GIS Maps (if they are available). Relationship Mapping Visualizations show the relationships between Building Blocks and Features over time on an interactive interface.

The website has different layouts for each Building Block and Feature including Playlists, Tours, Podcasts, Collections, etc. which are detailed in their respective sections.

Tours are an example of a Grouped Building Block. Tours are displayed on the website frontend with a typical user interface layout, along with a few salient features.

Mobile App Layout

The mobile app is similar to the website and has all the same content. It is arranged differently and employs the use of multi-touch sensors, transparencies, and thumb scrolls owing to the scope and limitation of the interface. While the bulk of curatorship and administrative checks will occur on the website, the mobile app presents a more distinct, visual, and dynamic interface to a user on the go. The focus is on Images, Media, and Maps, where textual descriptions are used to augment the user experience rather than dominate the screen. This vision informed the development of the UI and UX for the app, which aims for an intuitive layout with fewer buttons. For example, pages that showcase Building Blocks and Features are systematized using collapsible tabs that allow the user to access About, Images, Media, Maps, Events Stops, and Special Features (i.e. recipes) pages. The Timeline Feature appears above these tabs. On the Large Image View, the touch-screen mobile interface allows users to zoom in/out on the Images.

A Map View is also available for each item. The user can overlay Historic or GIS Data Maps (when available), turn on and off Labels, and zoom in on Maps. Clicking on a point marker shows the user more information about the item with an image thumbnail and description of the item in a pop-up at the bottom of the screen. Within the Map View, there are list views of Search results, Collections, etc., and a navigation menu that allows the user to Explore, and find What's Near the User and how to get there, using the Directions and Navigation User Feature. The user can also listen to Podcasts or a Playlist while navigating elsewhere on the app. One of the most unique features is the Map View on the Home Screen, where the user will be able to see a Site overlaid onto both present-day and Historic Maps as they navigate.

Elements:

Locations

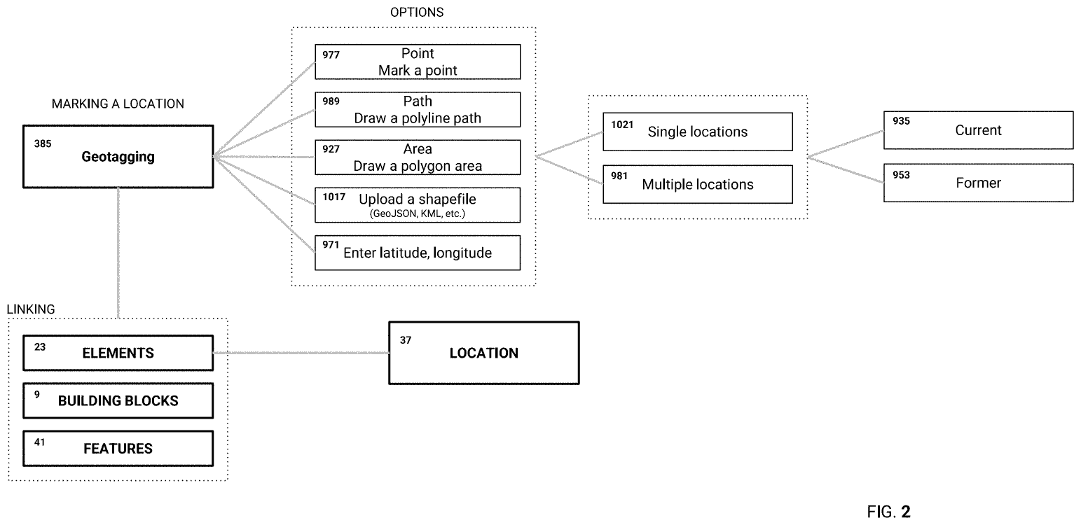

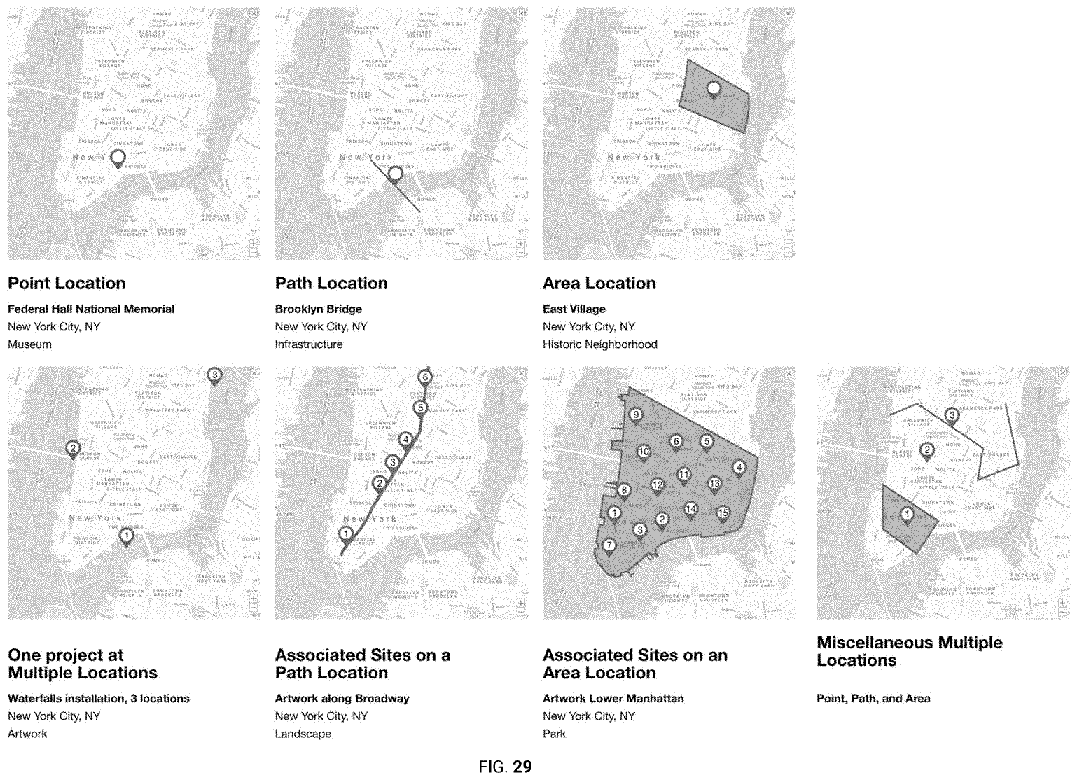

FIG. 2, FIG. 29

As shown in FIG. 2, every Element 23, Building Block 9, and Feature 41 can be geotagged 385 with Locations 37 either directly (by entering the Location on CMS) or indirectly (through the Building Blocks linked or contained therein). This allows the cultureNOW relational database to pin data to the map (see FIG. 29). Typically, the process of geotagging begins with entering the address into the map API, which displays a suggestions dropdown. This list is not restricted to any single country, and therefore allows data from every part of the world to be entered. This process also creates a single Location 1021 point marker 977 on the map, which is defined by a single set of latitude & longitude coordinates 971 called Site Location. Further, the curator can also enter information related to a path Location (such as railway or subway lines, bridges, streets, and walking paths) or area Location (such as a park or historic district). In the former case, the curator can draw and edit a polyline path 989 on the map interface, which creates a string of coordinates corresponding to the Element/Building Block/Feature. In the latter case, the curator can draw and edit a polygon area 927 that inputs all underlying coordinates in the map API, allowing the user to create a bounded area. Alternatively, in both cases, the curator can upload a GIS shape file 1017 (i.e., a geospatial vector data format typically composed of 3 mandatory files—.shp, .shx and .dbf; and optional files—.xml, .prj, .sbn).

The curator also has the option to override the address if the address that comes up in Google does not seem appropriate. There is a notes field for additional information if the Site is hard to find—for example, the curator can describe where an artwork is located (i.e. in the lobby). The curator can also adjust the pin for the site that will appear on the Map View. This can be helpful for marking exact locations—for example, locating a sculpture in the middle of a park.

In certain cases, the Element/Building Block/Feature can have multiple Locations 981. A large-scale artwork series, for instance, could have installations in several places at the same time. In certain cases, the Element/Building Block/Feature could have been relocated over time; to this end, the curator can link the locations entered by dates, and mark them as ‘current’ 935 or ‘former’ 953 locations.

Building Blocks:

Sites

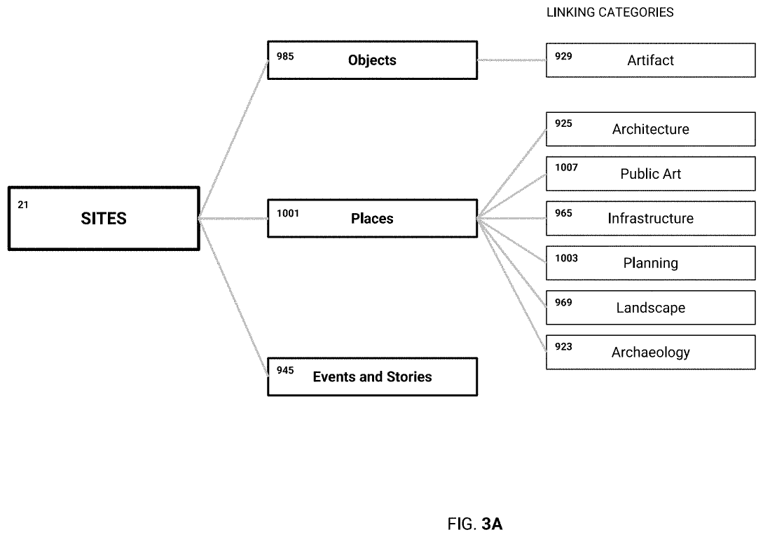

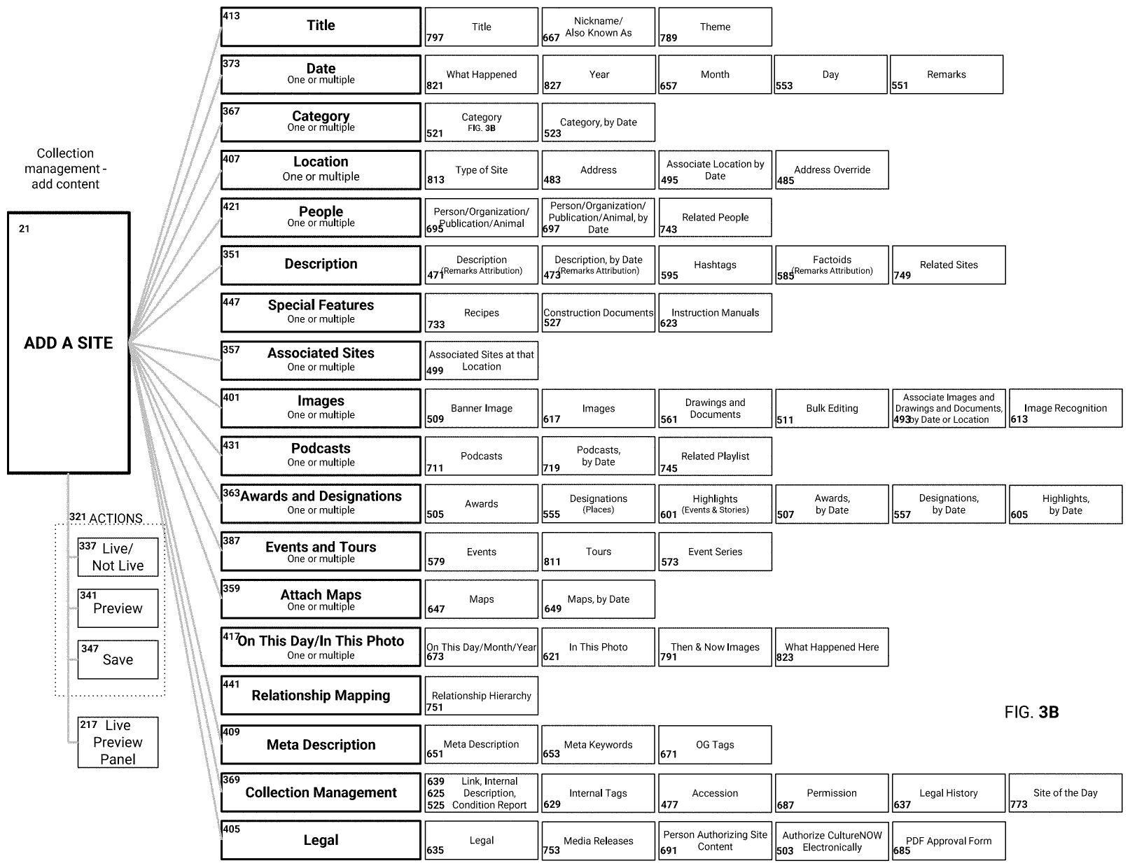

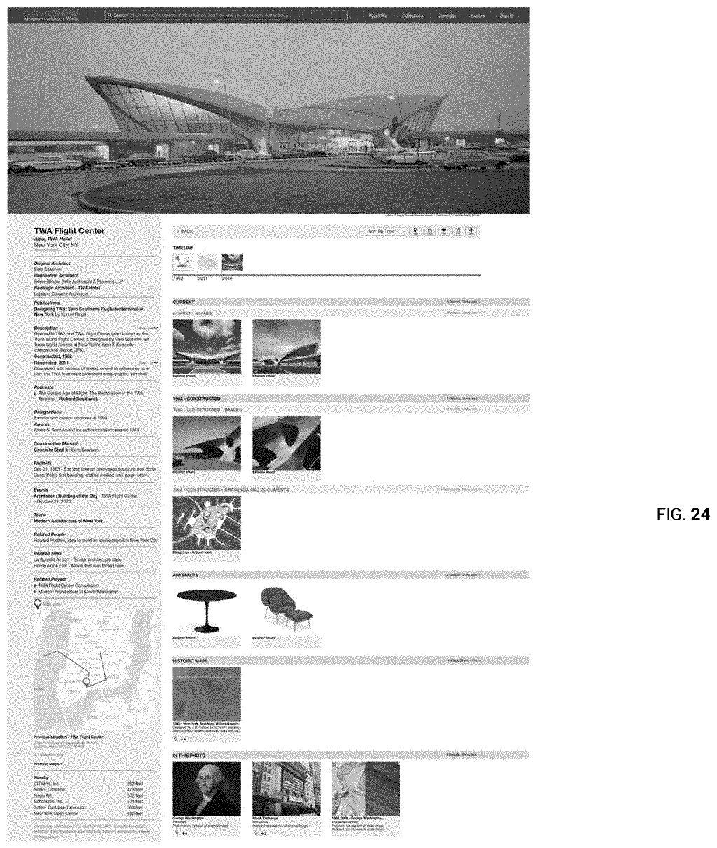

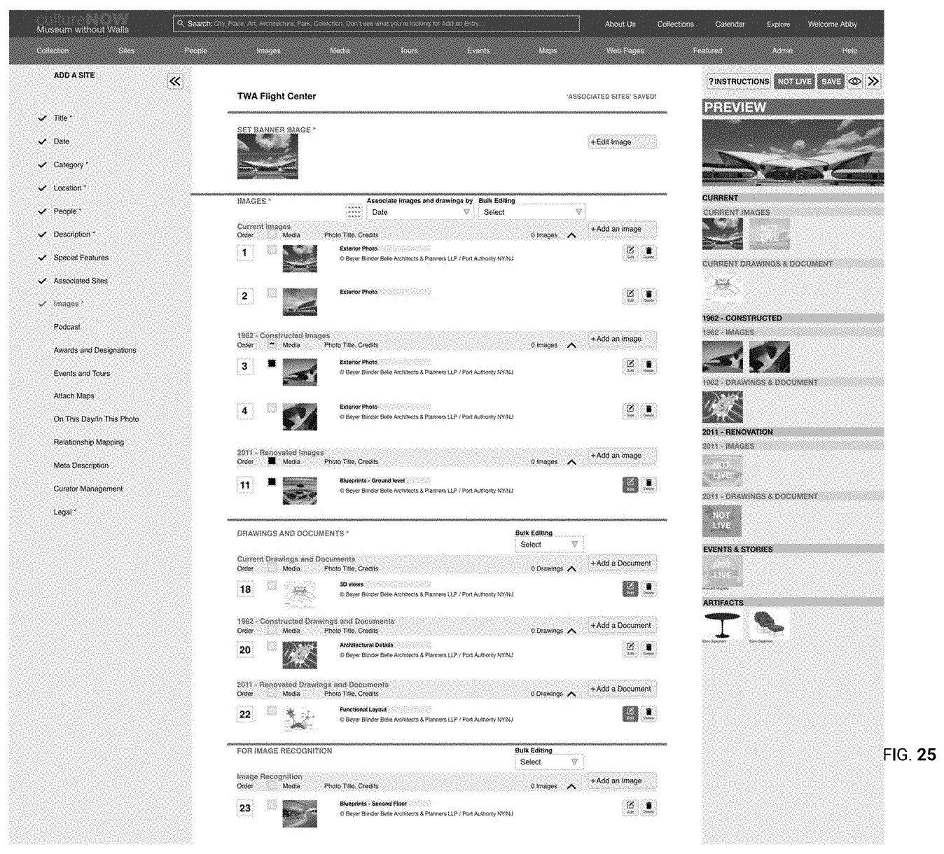

FIG. 3A, FIG. 3B, FIG. 24, FIG. 25

Definitions

This Building Block describes multiple items ranging in scale from an artifact to an artwork, a building, a city, a landscape, a planning project, infrastructure, or a historic or recent event and story. This is a broad definition, and there are differences in how various Site types are described, mapped, and linked. A Site can exist in one or multiple locations, marked by a point, path, or bounded area FIG. 2.

There are several Site types FIG. 3A that fall into three larger categories—Objects 985, Places 1001, Events and Stories 945. Artifacts 929 are objects of historic provenance and/or cultural significance that are linked to People, Sites, and Events. Places include the following: Public Art 1007 includes works of art that are visible in the public realm, commissioned by public organizations, or housed in publicly-accessible collections. This category includes artwork that might be semi-accessible to the general public, such as a mural in a lobby, and any artwork that a public agency has commissioned, whether it is ‘fixed’ to a public space or part of a collection. It encompasses multiple mediums, including sculptures, murals, architecture, fountains, memorials, texts, reliefs, glass, mosaics, tapestries, paintings, drawings, digital work, etc. Architecture 925 includes buildings, both historic and recent, as well as interior spaces. Planning 1003 projects include large-scale proposals for urban development. These include strategies for physical and policy design, such as historic preservation. The platform showcases these projects through maps, drawings, and documents. Archeology 923 describes the study of ancient and medieval human pasts through material remains. Landscape Architecture 969 describes the planning, design, and management of natural environments. Infrastructure 965 describes the networks that connect places, including systems for transportation (roads, bridges, airports, railroads, subways), information (networks, pneumatic tubes), and energy (grids). Events and Stories encompass historic or recent events. It is very broad and ranges from major cultural events to factoids. The categories range from celebrations to military, from health and safety to politics, and from inventions to milestones (i.e. releasing a film, publishing a book, fighting a battle).

Content Management System

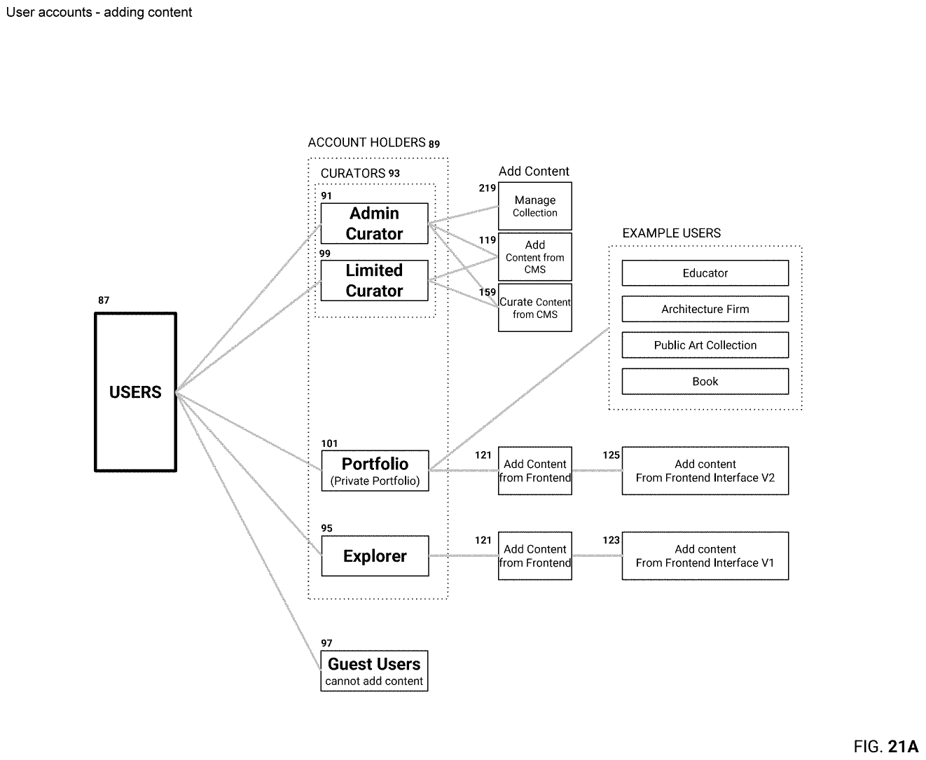

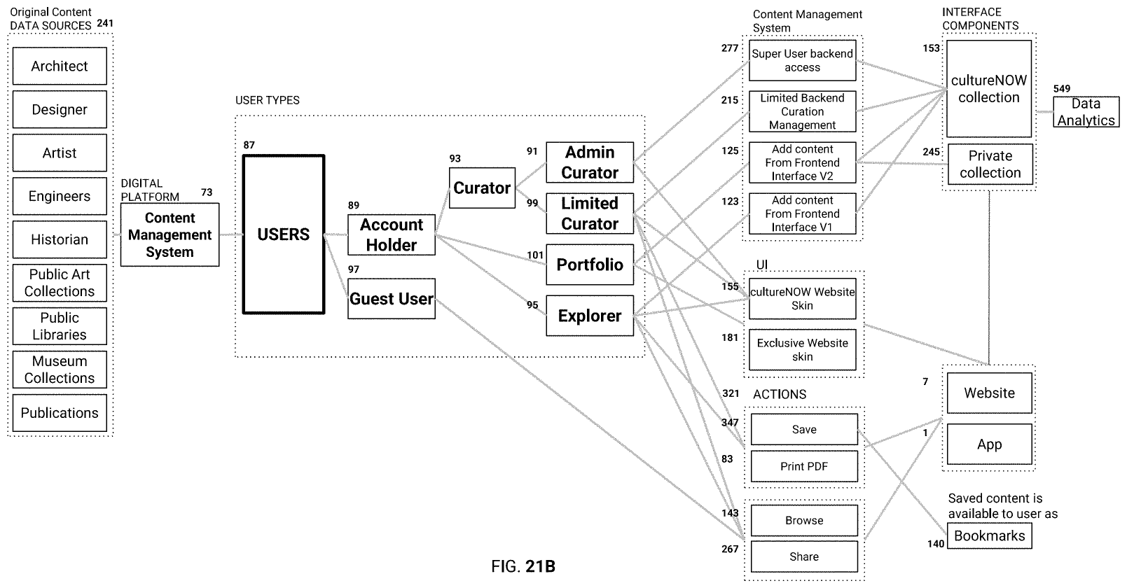

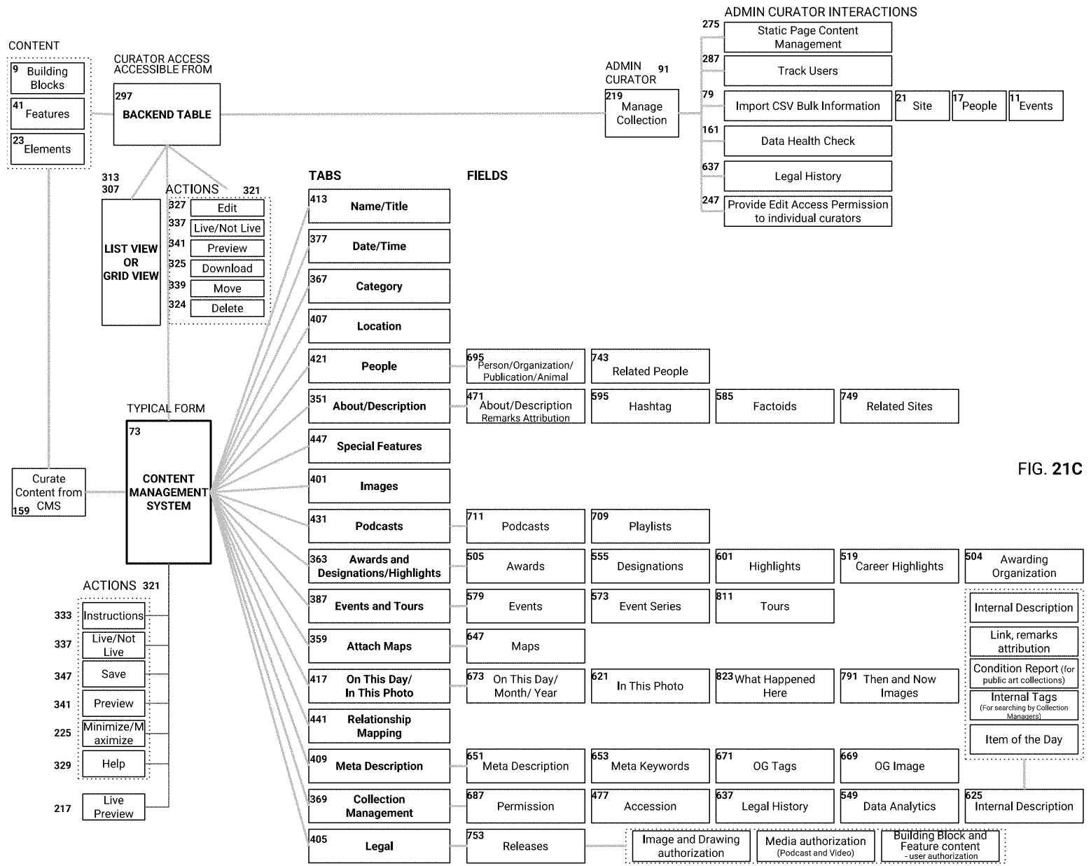

Sites on the CMS are accessed through a List view or Grid View. Refer to Backend Table & Form under Content Management System (See FIG. 21C, FIG. 25).

To become part of the virtual museum collection, every single Site needs to be described. The minimum data requirements for creating an individual Site include: a name and geotagged location so that people know how to find it, a category (i.e. art, architecture, event), and an image (which requires a photographer or source credit) so that users can see what it looks like. There must also be a written description that lets users know why it is interesting.

Beyond that, there are infinite variations available to enable the curators to describe it better and to cover multiple anticipated conditions—additional media can be attached; Sites can have more than one location; and multiple dates can be associated with them. Site locations can be marked as a point, path, or bounded area (i.e. a park).

As shown in FIG. 3B, every new Site 21 is given a Title 413, 797—this can be a formal name or its official title. It may also have a nickname 667. For Stories and Events, this will be the concise description of what happened (similar to a newspaper headline). Themes 789 are a series of checkboxes that the curator can use to highlight aspects of the site which might be important to visitors for searching. Themes options include: cultural Landmark or iconic event, ephemeral, historic, resilience, and unbuilt.

See information about the Date 373, 821, 827, 657, 553, 551 section and fields within the Content Management System description.

A site is defined by its Category 367, 521. It can have more than one; categories are tiered depending on the type of site. For architecture, the category could be the program (i.e. theater, workplace). For public art, it would be the type of art (i.e. sculpture, mural). Categories can be organized by date 523—for example, a building might have originally been constructed as a factory and then transformed into a museum.

All sites must be given a Location 407. Depending on the type of Site 813, locations can be marked as points, paths, or areas (such as a park or historic district), and can overlap with other sites (refer to FIG. 2). The site can be positioned by its address 483 or by inserting its latitude & longitude coordinates. The user can enter the appropriate information by typing the address, drawing or uploading a shape file. If the address is typed, the curator can type any address that is recognizable in Google anywhere in the world. The curator also has the option to override the address 485 if the address that comes up in Google does not seem appropriate. There is a notes field for additional information if the site is hard to find—for example, the curator can describe where an artwork is located (i.e. in the lobby). The curator can also adjust the pin for the site that will appear on the Map View. This can be helpful for marking exact locations—for example, locating a sculpture in the middle of a park. Sites can have multiple locations. An artwork, for instance, could be in several places at the same time. A site could also change its locations—for example, a sculpture that has been moved over time. Different locations can be associated by date 495.

The next tab allows curators to link People 421 to Sites. People, and the roles they played, are either credited to a Site 695 (if they had a direct role in shaping it) or entered as Related People 743 (if their role is secondary). They are added from a text field in addition to a dropdown menu that shows what is in the database—the role of the person on that project can then be listed. A person may have different roles on different sites. As part of the People building block, organizations and publications can be credited to sites. Credited people can be categorized and arranged by date 697. When adding a related person, a remarks text field allows curators to describe the role a person played.

A Description 351, 471 field contains text explaining the significance of a Site. There is additional space for remarks attribution 471 which will let the curator pull a passage from a book, for instance, and credit the book (that information will appear on the publication portfolio page). Different descriptions can be written and associated with various dates 473. This is especially helpful for buildings that may have been renovated and added to multiple times. See information about adding Hashtags 595 under Content Management System. The curator can also add factoids 585 if there is some interesting information, and relate other Sites 749 to the one being curated.

The Special Features 447 section contains additional items, such as Recipes 733, Construction Documents 527, or Instruction Manuals 623.

Associated Sites 357 share the same address or are located within the defined area of the Site being curated 499. For example, a work of art inside of a building would be associated to that site. Similarly, artworks can also be located within a park. A campus or historic district could include many sites within it (i.e. buildings). Associated sites could also be historic or recent events that took place at a site. The curator has the option of disconnecting them so that they are not visible on the frontend if they are not relevant to this particular Site. The curator also has the option of adding additional Sites to associate with this one if there is something else in the database that is appropriate.

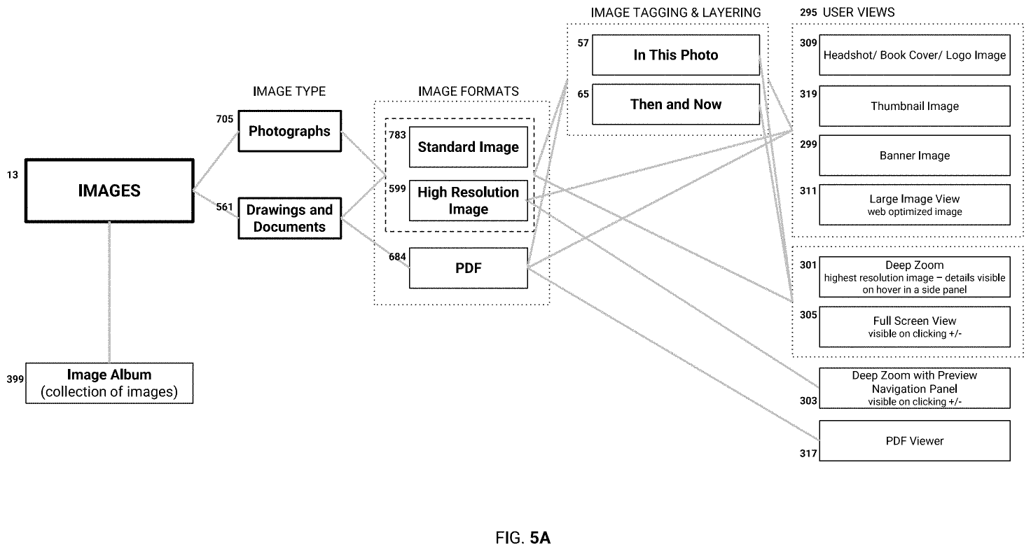

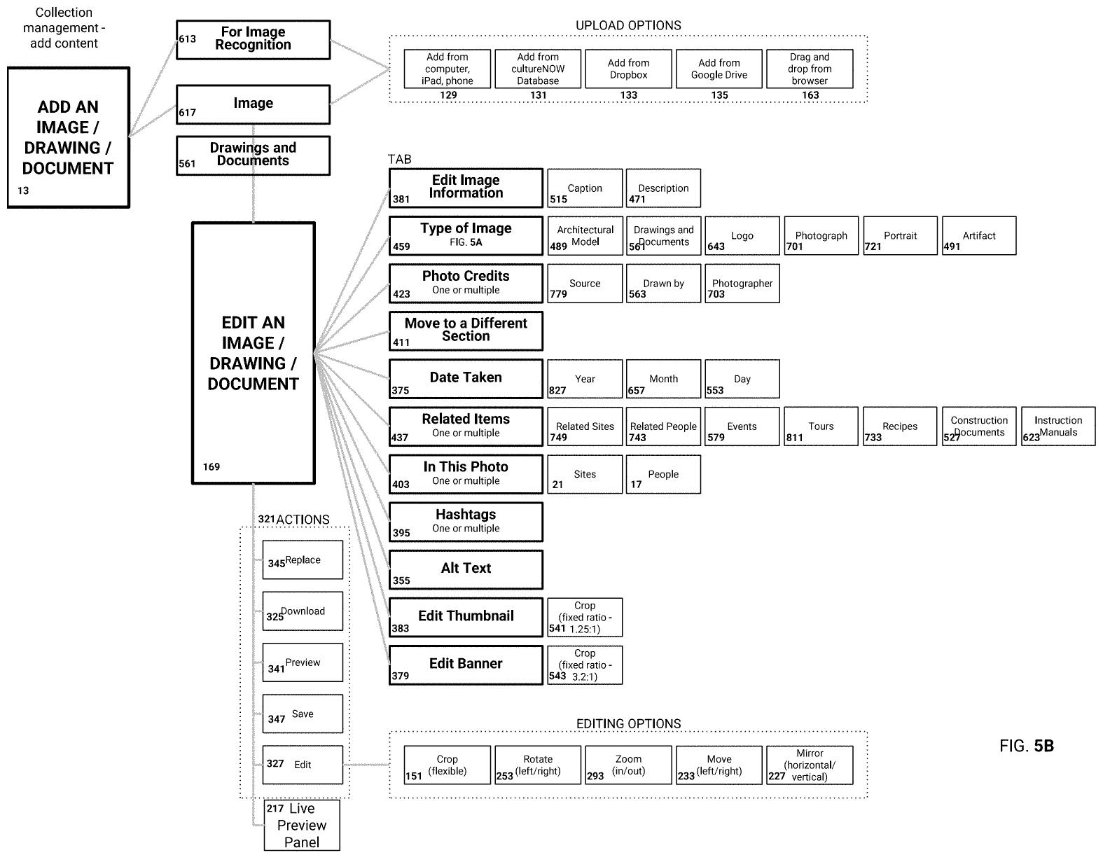

Images 401 (See FIG. 25) may be added to Sites. Every Site needs at least one image which will be the banner 509 and thumbnail to identify it (refer to FIGS. 5A and 5B). The curator can upload any amount of images. They can be rearranged and edited individually or in bulk 511. Multiple file types can be accepted by the database. The images can be high-resolution TIFFs which will enable the zoomed-in feature (refer to FIG. 5A)—this is particularly helpful for drawings and documents where the visitor might want to read the information on the image. There is a grid view available for the curator to help sort the images. There is a light amount of image adjustments that are available (cropping, rotating). Every image can be credited with the photographer and/or source, identified by type (model photo, aerial view, elevation, etc.), edited, and captioned. Drawings and Documents 561 which can be PDFs (such as planning reports) can also be added. Additional information (when was the photo taken) can be added. Images can also be arranged and rearranged by date or location 493. Refer to Images for information about Image Recognition 613.

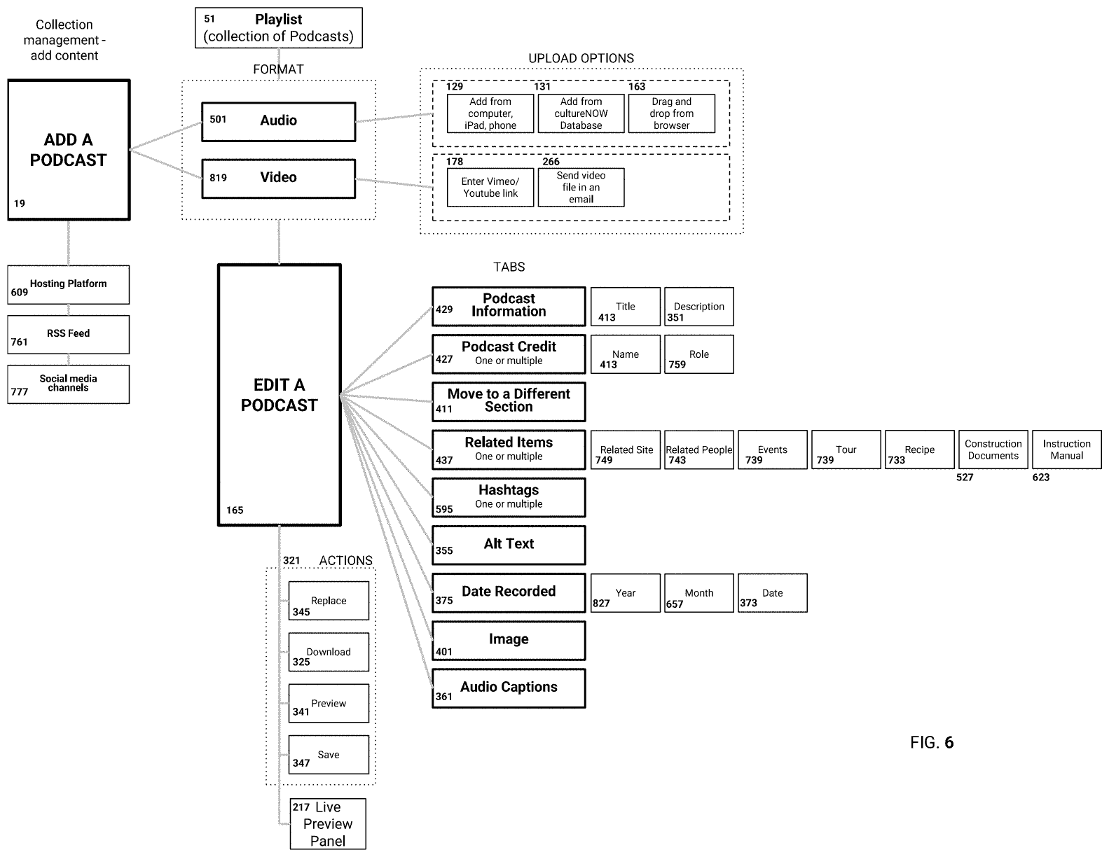

Next, the curator can connect Podcasts 431, 711 by uploading them to the Site page. The curator can link videos via YouTube and Vimeo to the Site (refer to FIG. 6). Like images, they can be organized by date 719. If it is appropriate, the curator can upload or select an Image for the header. If the Site has more than 2 Podcasts, a Playlist will be generated. The curator can also link a related Playlist 745, with the ability to add descriptions in a remarks text field about the media.

Within the Awards & Designations 363 section, the curator has the opportunity to attach Awards 505 (from a dropdown list) or Designations 555 (only to places), such as a landmark status. On Events and Stories pages, Designations are called Highlights 601 instead, but are treated the same way. All of these can be organized by date 507, 557, 605. The curator also has the opportunity to add any additional relevant information pertaining to the award or designation in a text field, like what an award or designation is for (i.e. the first time a high-rise timber building was built in NY).

In the Events and Tours 387 section, the curator can then link the Site to any Event 579, Tour 811, or Event Series 573.

See information about the Attach Maps 359, 647, 649 functionality within the Content Management System description.

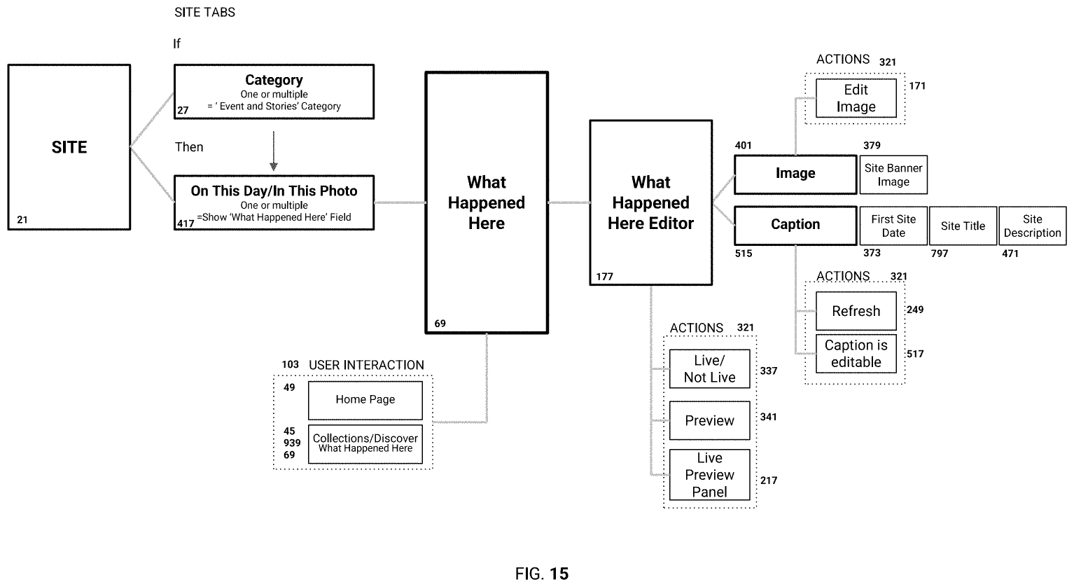

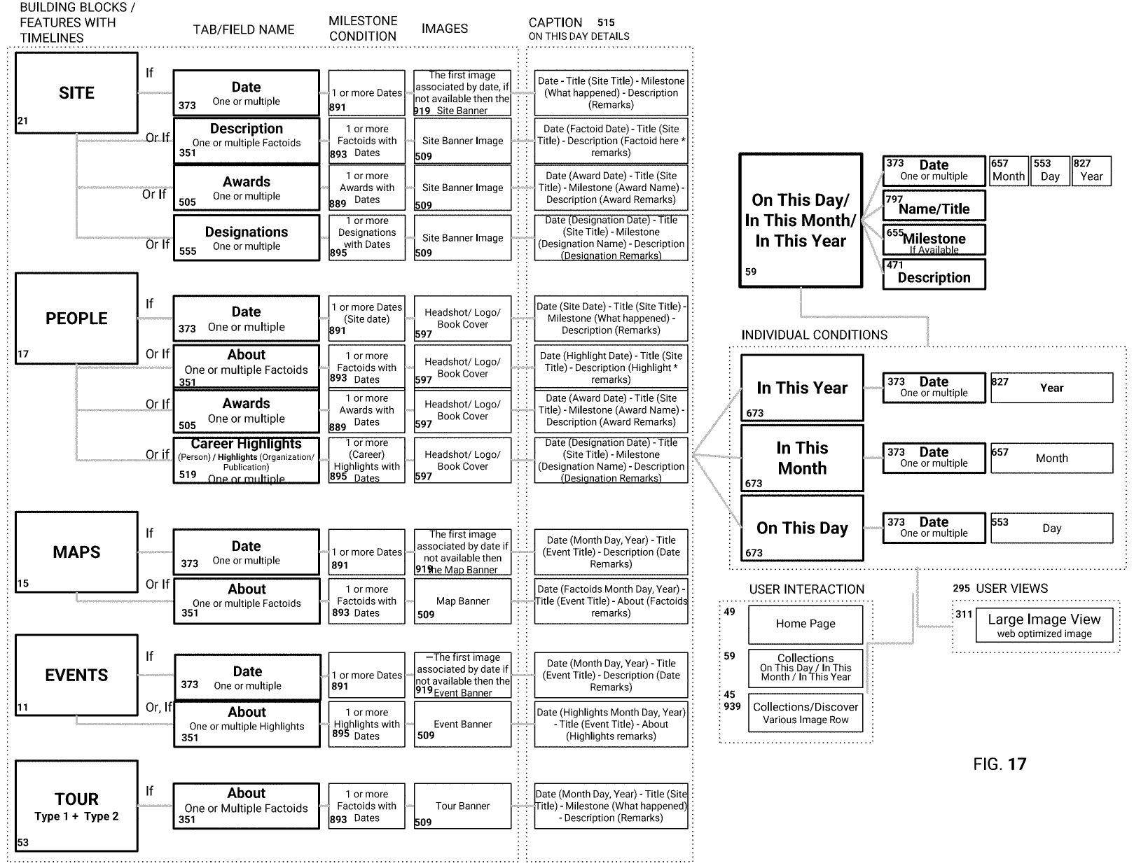

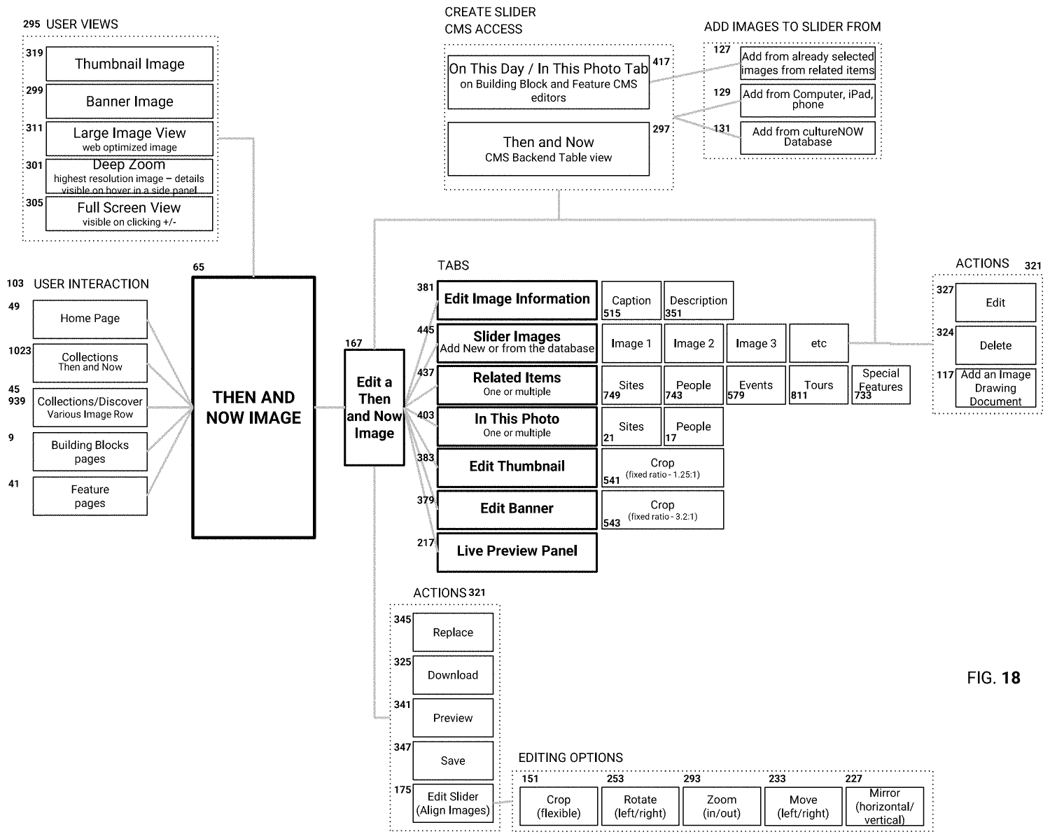

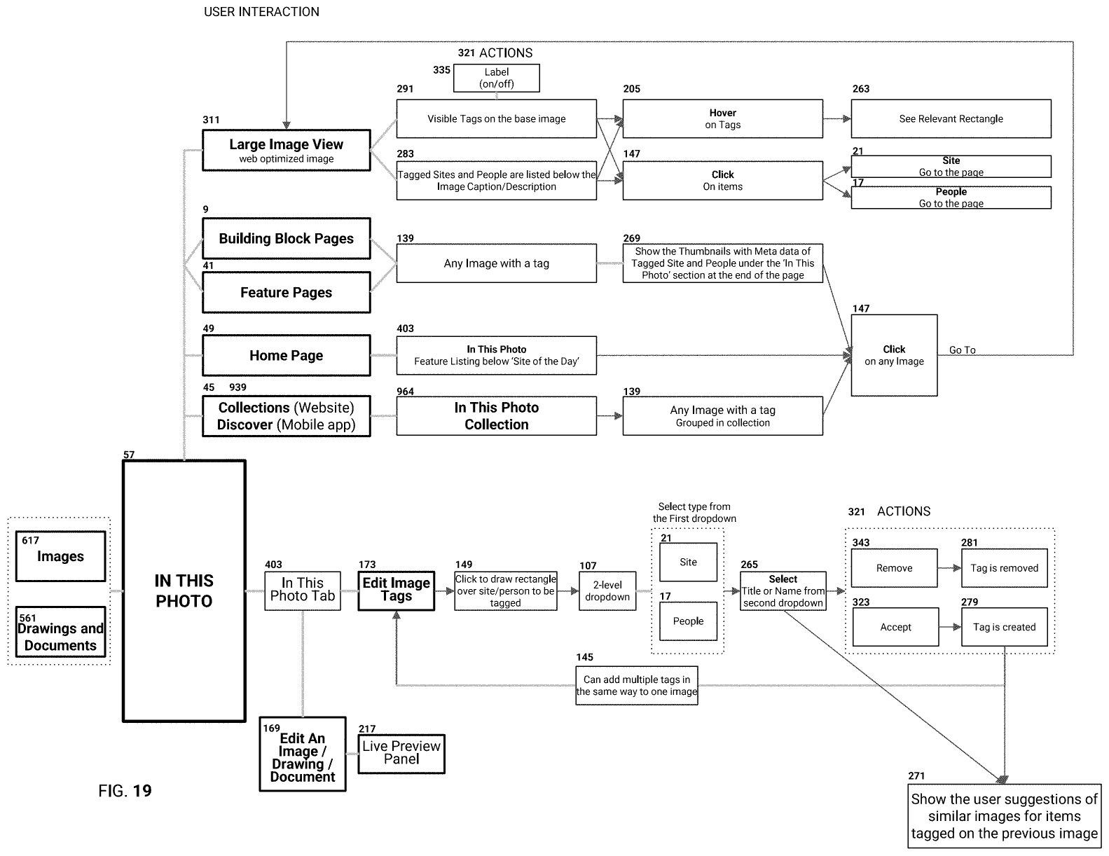

In the On This Day/In This Photo 417 section, the curator can work on the following items: On This Day/In This Month/In This Year 673 (see FIG. 17), In This Photo 621 (see FIG. 19), Then and Now Images 791 (see FIG. 18), and What Happened Here 823 (see FIG. 15).

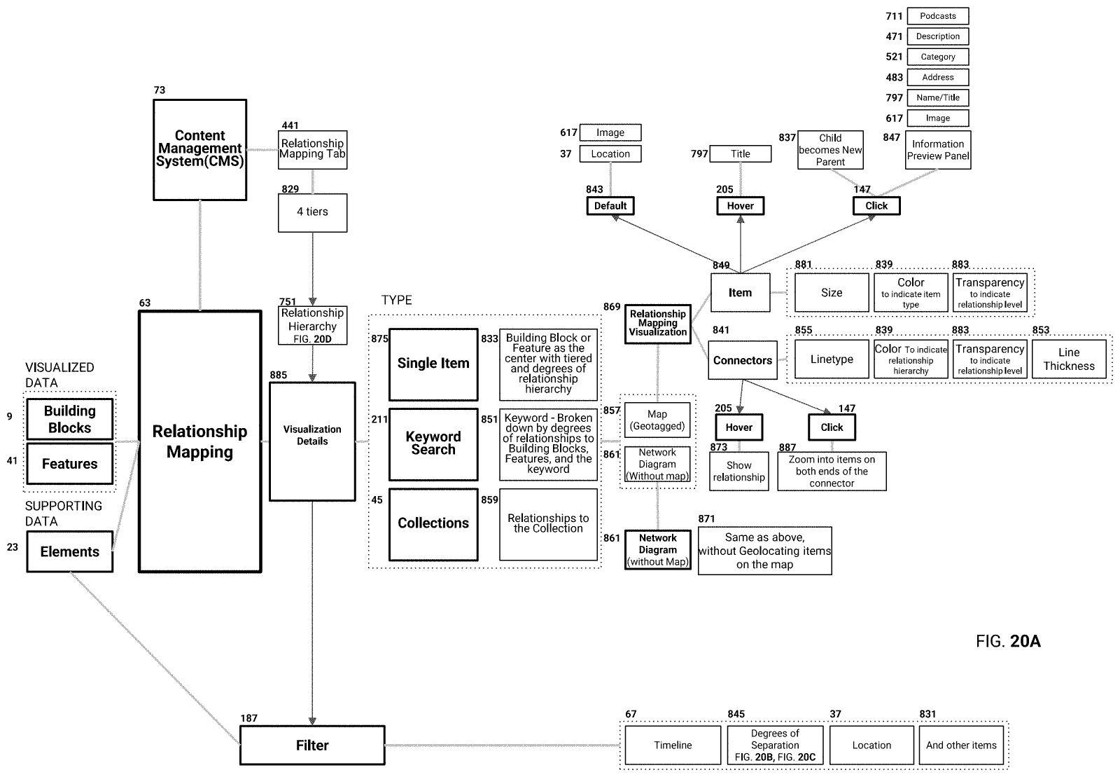

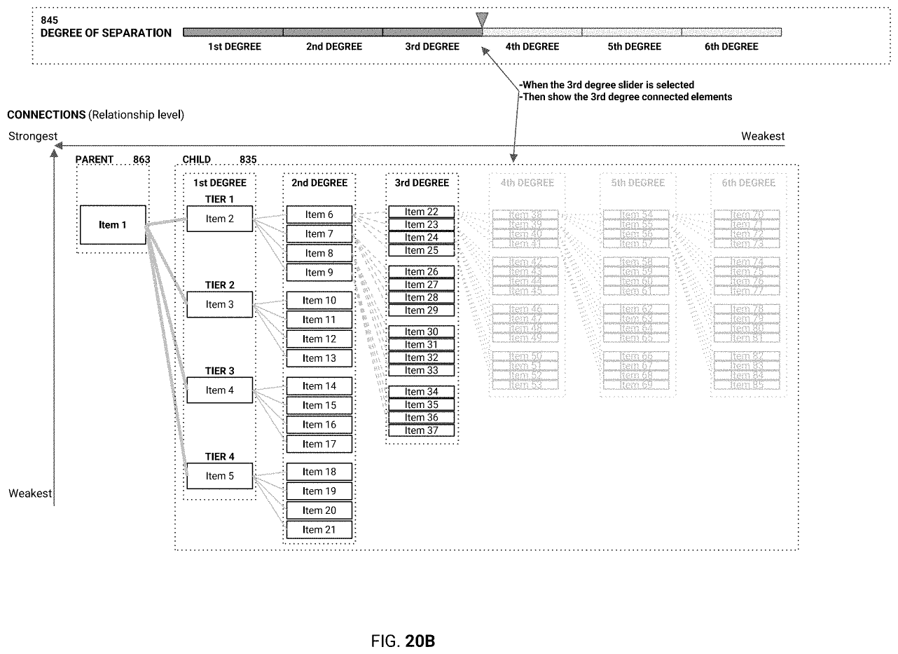

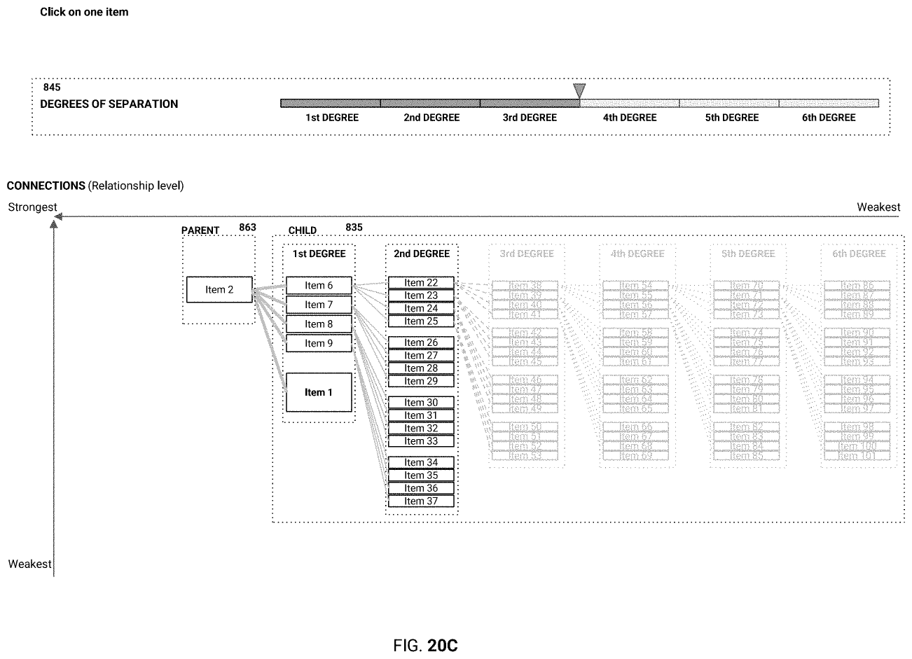

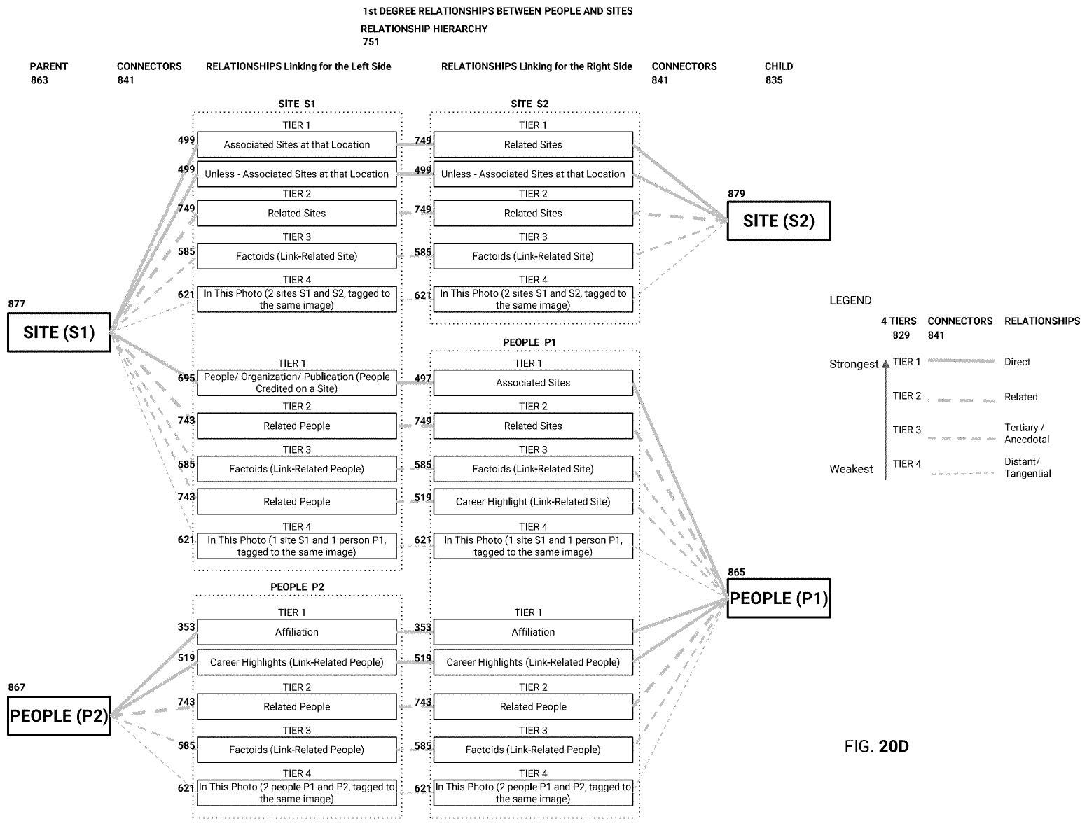

Refer to the following diagrams and descriptions for information about the remaining data entry sections: Relationship Mapping 441, 751 (see FIG. 20A, 20B, 20C, 20D); as well as Meta Description 409, 651, 653, 671; Collection Management 369, 639, 625, 525, 629, 477, 687, 637, 773 (see FIG. 21C); Legal 405, 635, 753, 691, 503, 685; and Live Preview Panel 217 under Content Management System.

Refer to Content Management System regarding user Actions 321, including Live/Not Live 337, Preview 341, Save 347.

Frontend UI

Website

FIG. 24

A typical site (See FIG. 24) with no associated sites and no timeline is straightforward. The main site screen has a banner image. On the left side is a panel with all the descriptive information about the site showing dates, designations, podcasts and related tours, people, events, playlists, and other sites. The right side has thumbnails of all the images attached to the site. These are organized from current photos, drawings and documents, maps that are attached, and ‘In This Photo’ or Then and Now images.

There are permutations in the site view when the site has multiple locations, a timeline, or associated sites. The user has the option of sorting the information alphabetically, or by date or people.

App

Sites on the app appear differently. They can be accessed from the search, collections, or discover buttons. Here because there is less real estate available the main features are tabbed. The user can click on about, maps, images, media (podcasts or videos), or special features such as recipes.

Building Block:

People

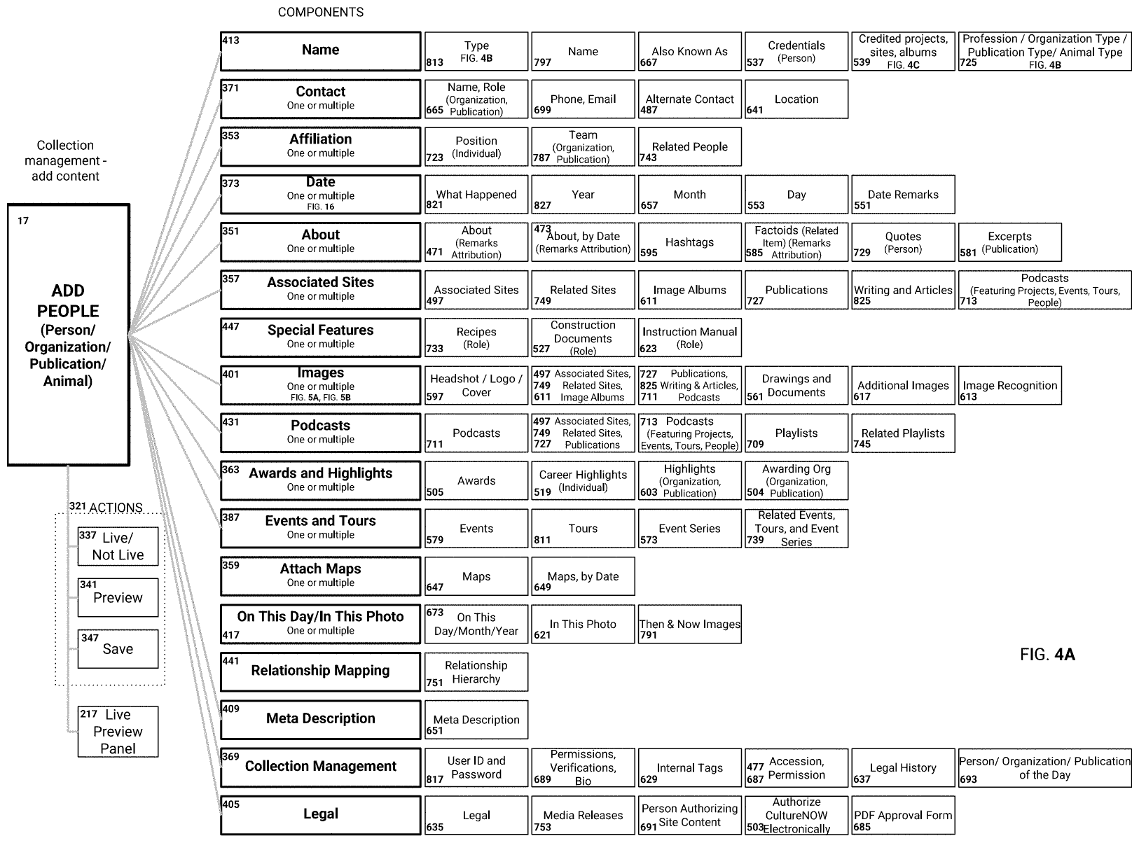

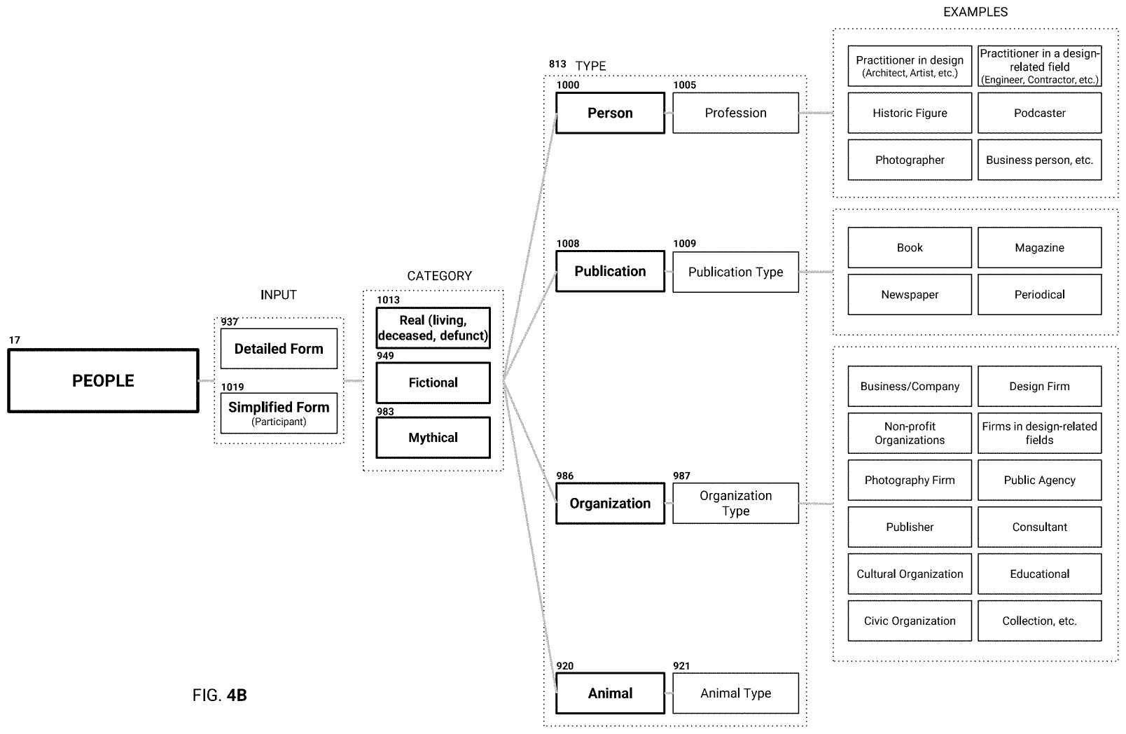

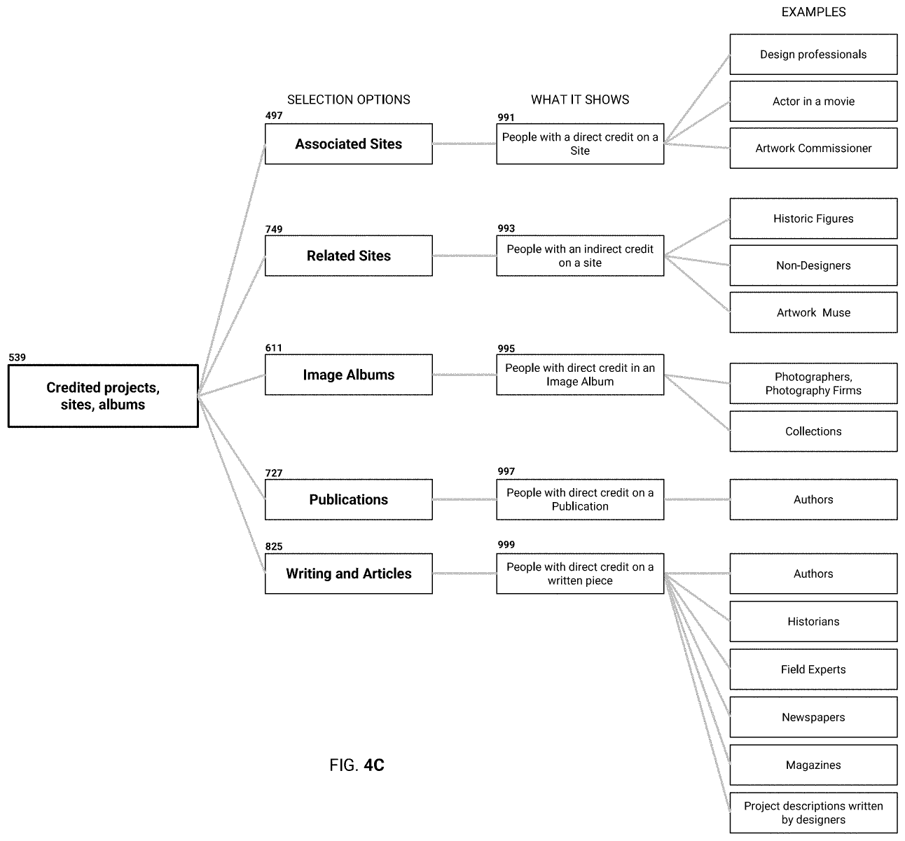

FIG. 4A, FIG. 4B, FIG. 4C

Definitions

A person (living or historic), an organization, a publication, or a participant who is either connected to or disconnected from other building blocks. These larger categories are further broken down into different types depending on their role—historic figures, artists, architects, curators, authors, photographers, muses, etc.

As shown in FIG. 4B, there are 3 categories of people. They can be Real 1013—(either living or deceased/defunct); Fictional 949; or Mythical 983.

There are two different kinds of data entry forms when creating a People page. A simplified form 1019 is used for adding Participants. Individuals in this category may have a single occurrence connecting to the database. For example, they may have participated in a program as a panelist or moderator. Or they may be the photographer of a single image on the platform. This is a way of entering just enough information about a person that would be sufficient for their role. The simplified form can be converted into a detailed form anytime. A detailed form 937 contains multiple fields with a complex network of relationships and metadata.

There are four types of people in the database:

(1) A Person 1000 is an individual who has some connection to a Site in any capacity. They can have one or multiple professions 1005. This includes practitioners in design disciplines and design-related disciplines—artists, architects, landscape architects, planners, engineers, etc. They could also be a historic figure. They could also be someone who has had a more curatorial role: authored Podcasts (podcasters), given Tours (tour guides), or written a book (authors, editors). Photographer—Photographers are people credited for their images on the platform. They automatically get a portfolio of image albums FIG. 4C, which showcases individual sites which are visible on the website or app on their ‘person page’.

(2) Publications 1008 include any written and/or published work excerpted on the platform. They automatically receive a Publication page, which contains a portfolio album that will showcase the individual sites. A publication could also be an organization (i.e. the New York Times). Publication types 1009 include books, newspapers, magazines, and periodicals.

(3) Organizations 986 are categorized by type 987, including companies, design firms (i.e. architecture, planning, landscape architecture, engineering, etc.), collections (i.e. a Public Art collection), institutions (i.e. museums, universities, libraries) and companies that have contributed or been the subject of content such as images and artifacts. Photography firms are credited for their images on the platform. They automatically get a portfolio of image albums that showcase individual sites FIG. 4C. Individuals who are affiliated with an organization would be credited with any of the images or sites that they are related to.

(4) Animals 920 include all categories and types 921. For example, animals that are featured in Events and Stories, or that are the subject of Public Art.

FIG. 4C details credited projects, sites, albums, which are generated from a series of checkboxes that allow the user to decide which sections will show on the frontend of People pages. Depending on what is selected, the relevant section will show up on the right side of the frontend website.

The checkbox options include:

Associated Sites 497—For People with a direct credit on a Site.

Related Sites 749—For People with an indirect credit on a Site (i.e. historic figures, non-designers, muses).

Image Albums 611—For People with a direct credit in an image album (i.e. photographers, collections, publications).

Publications 727—For People with a direct credit on a publication (i.e. authors, editors, publishers).

Writing and Articles 825—For People with a direct credit on a written piece (i.e. authors, historians, publications with text attributed across other Building Blocks and Features within the database). Remarks Attributions get collated under the Writings and Articles section if selected. This enables the database to both track and show the portions of written material on the frontend of the website and app such as a book or portions of an article.

Content Management System

The admin portal is shown as a list view with a table. Each column represents one of the tabs in the entry. They are filterable and searchable.

The first step in creating a People 17 page in the database, as outlined in FIG. 4A, is selecting a type 813: person, organization, publication, or animal. These types can be real (living or deceased/defunct), fictional, or mythological—refer to FIG. 4B. The type selection will influence the way a Name 413 is entered, as either first and last names (individual) or a single name (organization, publication, animal). Nicknames 667, if applicable, can also be added. For individuals, credentials 537 can be added to follow their name (i.e. MD, AIA)—these appear in a dropdown list, with the option of adding more. A profession (architect, author, teacher), organization type (Public Art collection, museum), publication type (book, magazine, newspaper), or animal type (dog, elephant) 725 should be specified. These appear in dropdown lists, with the option of adding more. More than one can be selected. For example, someone could be an architect as well as an author or teacher. Refer to FIG. 4C regarding credited projects, sites, albums 539.

A Contact 371 section establishes a database for organization and collection admins. One primary and multiple alternate contacts 487 may be added, using the following fields: names and roles 665 (for organizations and publications), phone numbers and emails 699, and locations 641. Locations can be previous or current. Additional locations can be added, and a list of locations can be reordered. For historic figures, these could be a birthplace, residence, or gravestone.

The data entry options that appear within the Affiliation 353 section depend on the page type. For individuals—their position 723 within an organization they owned/worked for, or within a publication they wrote. For Organizations and Publications—The team 787 members who currently work or formerly worked for/in them. For example, an architect works for an architectural firm, or a photographer for a photography firm. This field links one Building Block page to another with a first-degree connection. Adding Related People 743 (person, organization, publication, animal) establishes a second-degree connection between Building Block pages. There is an option to reorder multiple entries.

One or multiple Date 373, 821, 827, 657, 553 milestones can be added to People. For example, an organization could be founded, a person born, or a publication launched. The curator can add additional remarks 551 about each milestone. Multiple dates will create a timeline for that person. There is an option to reorder multiple entries.

An About 351, 471 text field contains a description of the subject. Different About descriptions can be written for and organized by date 473. There is a space for remarks attribution in all about fields. See information about adding Hashtags 595 under Content Management System. The curator has the option to add one or multiple Factoids 585 (brief or more trivial information about the person). Factoids can be linked to another person, a Site, a Tour, an Event, a Map, an Image, or a Podcast, establishing a third-degree connection. Quotes 729 can be added to individuals, and Excerpts 581 to publications.

The Associated Sites tab 357 shows the curator which sites, podcasts, publications, related sites, and writing the subject has been linked to. Associated Sites 497 are directly connected to the person and their role on the site. This field links people to sites as a first-degree connection. Related Sites 749 have an indirect connection to people. A remarks field provides space for explaining the relationship between them. This field links people to sites as a second-degree connection. Image Albums 611 contain a collection of images for photographers. Publications 727 appear for authors and editors. Writings and Articles 825 for authors and publications with remarks attribution. Podcasts—Featuring Projects, Events, Tours, and People 713 appear for podcasters. The curator can reorganize multiple entries, or go to any relevant entry to adjust it if needed.

Special Features 447 contains recipes 733, construction documents 527, and instruction manuals 623, with the role of the subject specified and linked.

The Images 401 section contains a headshot of an individual or animal, a book cover or logo of a publication, or a logo of an organization 597. There are places to review and change the banner images for Associated Sites 497; Related Sites 749; Image Albums 611; Publications 727; Writings and Articles 825; and Podcasts 711. Similarly, Drawings and Documents 561 or Additional Images 617 can be added that might be credited to the subject, but not attached to a specific site. Curators can also add additional images for Image Recognition 613 which would not show up on the front. Refer to FIGS. 5A and 5B for more information about Images.

Podcasts 431, 711 can be uploaded for or by the subject. Podcasts attached to Associated Sites 497, Related Sites 749, and Publications 727 appear here. Podcasts featuring Projects, Events, Tours, and People 713 also show here. There are two types of Playlists that can be attached here: Playlists curated by a person or organization 709, or Playlists that are related 745 to the subject. The curator can also add remarks about the person's relationship to the related playlist.

In the Awards and Highlights 363 section, the curator can add Awards 505 for any person type page. Career Highlights 519 can be added for an individual and Highlights 603 for organizations, publications, and animals—both of these include entry fields for dates, remarks, and remarks attributions. Organizations and Publications who give awards (Awarding Organizations 504) and a list of their awards also appear within organization and publication pages.

Events and Tours 387 include the addition of Events 579, Tours 811, and Event Series 573. If they are already directly linked to a person or organization, they will appear here. The curator can connect an event where the person has a direct role (as the sponsor, host, or speaker). They might have created a tour or be a partner organization for it. If it is an Event Series (like a film festival) there would be a different role. This would be a first-tier connection. The next section is an opportunity to relate Events, Tours, and Event Series 739 to a People page. In this case, the People may have a second-tier (rather than direct) connection with the item.

See information about the Attach Maps 359, 647, 649 functionality within the Content Management System description.

In the On This Day/In This Photo 417 section, the curator can work on the following items: On This Day/In This Month/In This Year 673 (see FIG. 17), In This Photo 621 (see FIG. 19), and Then and Now Images 791 (see FIG. 18).

Refer to the following diagrams and descriptions for information about the remaining data entry sections: Relationship Mapping 441, 751 (see FIG. 20A, 20B, 20C, 20D); as well as Meta Description 409, 651; Collection Management 369, 817, 689, 629, 477, 687, 637, 693 (see FIG. 21C); Legal 405, 635, 753, 691, 503, 685; and Live Preview Panel 217 under Content Management System.

Refer to Content Management System regarding user Actions 321, including Live/Not Live 337, Preview 341, Save 347.

Frontend UI

Website

On a typical Person/Organization/Publication/Animal page, the banner image is visible with a black overlay and changes every time the page is refreshed. On the left side, one of these image types is visible—a headshot of a person or animal, a logo of an organization or publication, or a book cover of a publication. Below the banner image section on the left, a panel contains all the descriptive information about People—names, designations, professions or Organization/Publication/Animal type, dates, highlights, Podcasts and Related Tours, People, Events, Playlists, and other Sites. The right side has thumbnails of Sites, Related Sites, Image Albums, writings and articles, etc. depending on what is selected on the CMS title checkbox. Additional photos; Drawings and Documents; Podcasts—Featuring Projects, Events, Tours, and People; Historic Maps; In This Photo; Then and Now Image sections show by default if they have content available for the people page. The user has the option of sorting the information alphabetically, or by date or people.

Mobile App

People on the app can be accessed from the Search, Collections, and Discover buttons, which include Organizations and Publications as well. Due to screen size restrictions, the main features are tabbed, just like in Sites. The user can click on About, Images, Media (podcasts or videos), Maps, or Special Features (such as Recipes). If the person is a photographer, Albums show up in the Images section instead of Projects (which is the case for Architects, Artists, Engineers, Historic Figures, and non-Designers). It works similarly for organizations as well.

Building Block:

Images

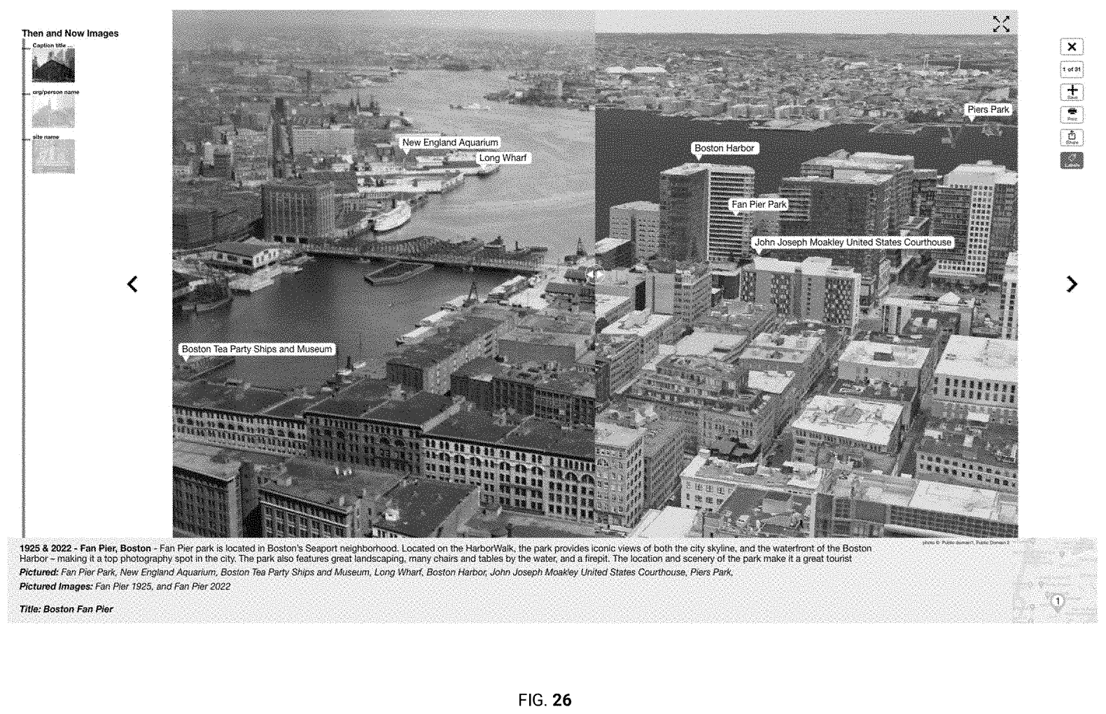

FIG. 5A, FIG. 5B, FIG. 26

Definitions

Every Building Block and Feature must have at least one image associated with it. Typically there are multiple. They can be photographs, drawings, and documents. There is a Large Image View feature allowing the user to zoom in on the image which is particularly helpful with drawings and documents that have a lot of detailed text.

When an image is uploaded on the platform it gets processed into generating various web-optimized image formats relevant for mobile phones and low/high-resolution computer screens. All images get processed into various sizes—Banner Thumbnail, Headshot/Logo/Book Cover, web-optimized full image in various resolutions.

FIG. 5A shows the organization and presentation of data according to Image types.

Photographs 705 refer to allowed image formats except for PDF files. This consists of images that could be exterior, interior, detail, artwork, landscape, aerial, event, portraits, etc. Drawings and Documents 561 consists of PDF files, as well as JPEGs and other file types, that qualify as more of a document than a photo (i.e. plan, section, or elevation drawings; sketches; renderings; diagrams). Drawings can be either Image or PDF files. Documents only include PDF files. These could be any of the above or reports, planning documents, etc.

The Standard Image 783 formats include most image formats—JPEG, JPG, PNG, GIF, SVG, TIF, TIFF, WebP, etc.

Images can also be High-Resolution 599, such as TIFF files. The maximum size of the original image can be 100 MB. These images are uploaded through deep zoom technology. The software allows for efficiently viewing the images. A preview navigation panel allows the user to pan around and zoom in on the large, high-resolution image. The images are broken into tiles at different resolutions and displayed as required.

When a PDF (Portable Document Format) 684 is uploaded, the first page is converted into an image and treated the same as any other image. From the large image view, the user views the PDF reader.

For information about In This Photo 57 image tagging (see FIG. 19) and Then and Now 65 image layering (see FIG. 18), refer to Special Curated Features.

An Image Album 399 is created from a collection of Images, credited to one person, organization, or publication. These are visible on collections and People pages.

Content Management System

As shown in FIG. 5B, there are 2 purposes for adding an Image 13 to the platform—for Image Recognition 613, or for frontend display 617, 561. The purpose determines the data entry sequence. Photos for Image Recognition do not require any data entry beyond uploading one or more photos. Image files can be uploaded from a computer, iPad, or phone 129; the cultureNOW database 131; Dropbox 133; Google Drive 135; or dragged and dropped from a browser 163. Acceptable image formats include: .jpg, .png, .tiff, .gif, .webp, etc.

FIG. 5B also outlines the process for editing an Image 169, which begins with Edit Image Information 381—entering preliminary information about the media, including writing a Caption 515 and Description 471 in text fields. Captions are image titles, while descriptions provide more detailed information.

Images are categorized by Type 459. Image type options are available in a dropdown list—these include: architectural model 489, drawings and documents 561, logo 643, photograph 701, portrait 721, and artifact 491. Users also have the ability to add a new image type to the dropdown list, if needed.

The website requires legal authorization for each image uploaded on the platform. If a viable Photo Credit 423 is not entered, the user does not see it on the front. Credit types include: source 779, drawn by 563, and photographer 703 (users can add new ones if needed). Images can have multiple credits—for example, an image might be taken by a photographer for a newspaper (source). Through credits, images are linked to People pages (individuals, organizations, publications). Names are selected from a dropdown list of People already in the database.

Curators can move Images to a different section 411 within the CMS. A search bar with dropdown suggestions provides this functionality.

Entering the Date an Image was taken 375 (year 827, month 657, and day 553) or produced links Images to other content via date data. Dates are especially relevant for historic images. The user has the option to show or hide the date from a frontend user via a checkbox choice.

Curators have the ability to link an Image to one or multiple data points by adding Related Items 437. Related items can include: Related Sites 749, Related People 743, Events 579, Tours 811, Recipes 733, Construction Documents 527, or Instruction Manuals 623. Users can add these via a search bar with dropdown suggestions.

See information about In This Photo 403 image tagging for both Sites 21 and People 17 under Special Curated Features FIG. 19.

See information about adding Hashtags 395 under Content Management System.

Alt Text 355 serves as an additional description for Image Recognition and Meta Tagging, aids with SEO Management, displays in place of an image on a webpage if the image fails to load, and provides ADA accessibility to content. It is auto-filled with the title or name of the Building Block/Feature, but the default text can be overridden.

In Edit Thumbnail 383, curators can preview and adjust the way an image will appear as a thumbnail. The image cropper is fixed in a 1.25:1 ratio 541, which the user can scale and/or move around to capture the desired portion of the image for display.

In Edit Banner 379, curators can preview and adjust the way an image will appear as a banner. The image cropper is fixed in a 3.2:1 ratio 543, which the user can scale and/or move around to capture the desired portion of the image for display.

When editing 327 an Image, users have the option to perform a number of Actions 321. They can replace the image with another 345; download the image to their device 325; preview the Image frontend display page 341; save changes made in the editor 347; and edit the image itself by cropping 151, rotating 253, zooming into or out of 293, moving 233, or mirroring it 227.

See information about the Live Preview Panel 217 under the Content Management System description.

Frontend UI

Website

FIG. 5A includes User Views 295. Headshots, Book Covers, and Logo Images 309 are all displayed with a 1:2 aspect ratio, as a cropped version of the original image that is optimized for web view. The crop defaults to the center of the image. The user can override the default and manually select the section of the image they want to highlight for the Headshot/Book Cover/Logo image. This is only used for the main image on the People, Podcast, and Tour pages.

Thumbnail Images 319 are displayed with a 1.25:1 aspect ratio, as a cropped version of the original image that is optimized for web view. The crop defaults to the center of the image. The user can override the default and manually select the section of the image they want to highlight for the thumbnail image. This is used for all images.

Banner Images 299 are displayed with a 3.2:1 aspect ratio, as a cropped version of the original image that is optimized for web view. The crop defaults to the center of the image. The user can override the default and manually select the section of the image they want to highlight for the banner image. This is used for all images.

The Large Image View 311 (See FIG. 26) displays a web-optimized image. When an image is uploaded, it is processed into multiple sub images—thumbnail small size/low resolution (for the timeline or mobile app), thumbnail large size/high-resolution (for the website), web-optimized image large size/high-resolution (for the website), web-optimized image small size/low resolution (for the mobile app), etc.

From a Site page, a user can open the Large Image View 311 by clicking on any of the images. These images can be zoomed in multiple times. They are organized by date event. The user can scroll down the images and zoom to many levels. On the side of the screen is a thumbnail of the entire image so that the user can move the zoomed-in section as needed. High-resolution images can be zoomed in as needed.

From an Individual/Organization/Publication/Animal page, a user can also access the Large Image View 311 and zoom in on high-resolution images. There is a navigation window. They are organized in a carousel.

Deep Zoom 301 opens when the user clicks on the full-screen icon on any image in the Large Image View. This allows the user to efficiently view image details. It allows users to pan around and zoom into any part of the image. The zoomed-in detail view of that part of the image is displayed on the left side of the screen. The user sees the Web-Optimized 3X image here.

The Full Screen View 305 opens when a user clicks on the full-screen icon that appears on any image in the Deep Zoom image view. The image expands to fill the entire window, and a zoom feature (magnifying glass with +/−) allows the user to enlarge it to its fullest extent. The user sees the original image resolution here.

The Deep Zoom with Preview Navigation Panel 303 feature is only for High-Resolution Images that are uploaded through the Deep Zoom software. A small preview panel, which shows the entire image, has a rectangle that reflects the area of the image that is visible to the user. The remaining part of the screen is filled with the zoomed-in part of the image. The user can zoom in/out from the main screen by scrolling or through the +/−slider on the preview panel.

In the PDF Viewer 317, the user sees the first page of the PDF in the Large Image View. Clicking on the full-screen icon takes the user to a PDF reader with the PDF which opens in a new tab.

App

The app has similar Image views as the website—Large Image View, Full Screen View, Deep Zoom with Preview Navigation Panel for High-Resolution Images, and the PDF Viewer. The app does not have the Deep Zoom View. Instead, the user is able to see Image details by zooming in with two fingers on the Full Screen View.

Building Block:

Podcasts

FIG. 6

Definitions

Audio and video files that are meant to supplement other data on Site and People pages. Audio files are held on a hosting platform (Podbean), while videos are embedded from YouTube or Vimeo.

Content Management System

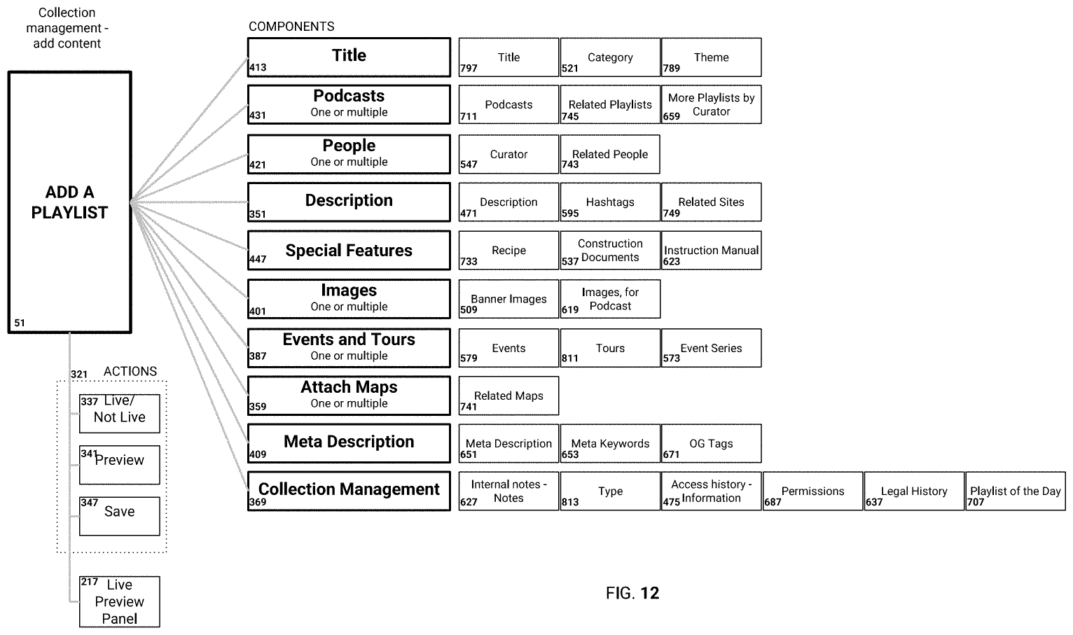

As shown in FIG. 6, users have the option to upload and/or add Podcasts 19 in an Audio 501 or Video 819 format. Audio files can be uploaded from a computer, iPad, or phone 129; the cultureNOW database 131; or dragged and dropped from a browser 163. Video files can be added via a YouTube or Vimeo link 178, or sent in an email 266. Podcasts are hosted on an external platform 609 and provide an RSS feed 761 that is plugged into social media channels 777. A collection of Podcasts becomes a Playlist 51 (refer to Playlists FIG. 12).

FIG. 6 also outlines the process for editing a Podcast 165, which begins with entering preliminary Podcast Information 429 about the media. Curators determine what Podcasts are called by entering a Title 413 in a text field. Description 351 text, entered in a text field, describes what the Podcast is about, in terms of content and relevance.

Podcast Credits 427 are added via a name 413 dropdown list, from which curators can link to People (individuals or organizations). There are different options for assigning their relationship to the Podcast, via a role 759 dropdown list—for example, author, creator, source, owner, narrator, etc.

Curators can move a Podcast to a different section 411 within the CMS. A search bar with dropdown suggestions provides this functionality.

The Related Items 437 section serves the purpose of linking Building Blocks and Features to Podcasts. For example, a Podcast could be geotagged via a linked Site or Event. Related items can include: Related Sites 749, Related People 743, Events 579, Tours 811, Recipes 733, Construction Documents 527, or Instruction Manuals 623. Users can add these via a search bar with dropdown suggestions.

See information about adding Hashtags 595 under Content Management System.

Alt Text 355 serves as an additional description for Image Recognition and Meta Tagging, aids with SEO Management, displays in place of an image on a webpage if the image fails to load, and provides ADA accessibility to content. It is auto-filled with the title or name of the Building Block/Feature, but the default text can be overridden.

In the Date Recorded 375 section, users can add dates (year 827, month 657, and day 373) related to the podcast, which is important for situating them within timelines. The user might decide to enter the date uploaded if the podcast is a video on YouTube or Vimeo.

Each Podcast is displayed with a banner Image 401 in browsing collections, search results, and playlists. Typically the image is selected from those that are already connected to the Building Block or Feature, or the user can add a new image to the database.

Auto-generated Captions 361 for audio and video Podcasts provide an ADA accessibility option for accessing the media.

See information about the Live Preview Panel 217 under the Content Management System description.

Frontend UI

Web site

Within other Building Block pages, a list of attached or related Podcasts appears on the left-hand side of the screen along with other linked text. If the user clicks one of these, a Podcast player will appear in the bottom left corner of the screen.

The user can also view the Podcast on its own Building Block page, where all linked data appears. On this page, users can play the Podcast or add it to a listening queue. A pop-out window option expands the Podcast player into full-screen mode.

App

Within other Building Block pages, Podcasts are accessed via the “Media” tab. In Collections pages, they appear in the “List” view along with other content and media. When a Podcast is selected, a Podcast player overlays at the bottom of the screen. A pop-up option expands the Podcast player to full screen. Responsive sizing allows the Podcast player to adapt to various screen sizing and orientations.

Podcasts can also be viewed on their own Building Block page, where all relevant information is displayed. This page also contains a Map View that displays Sites mentioned in the Podcast as well as related Podcasts and Podcasts by the same author/source.

Building Block:

Special Features

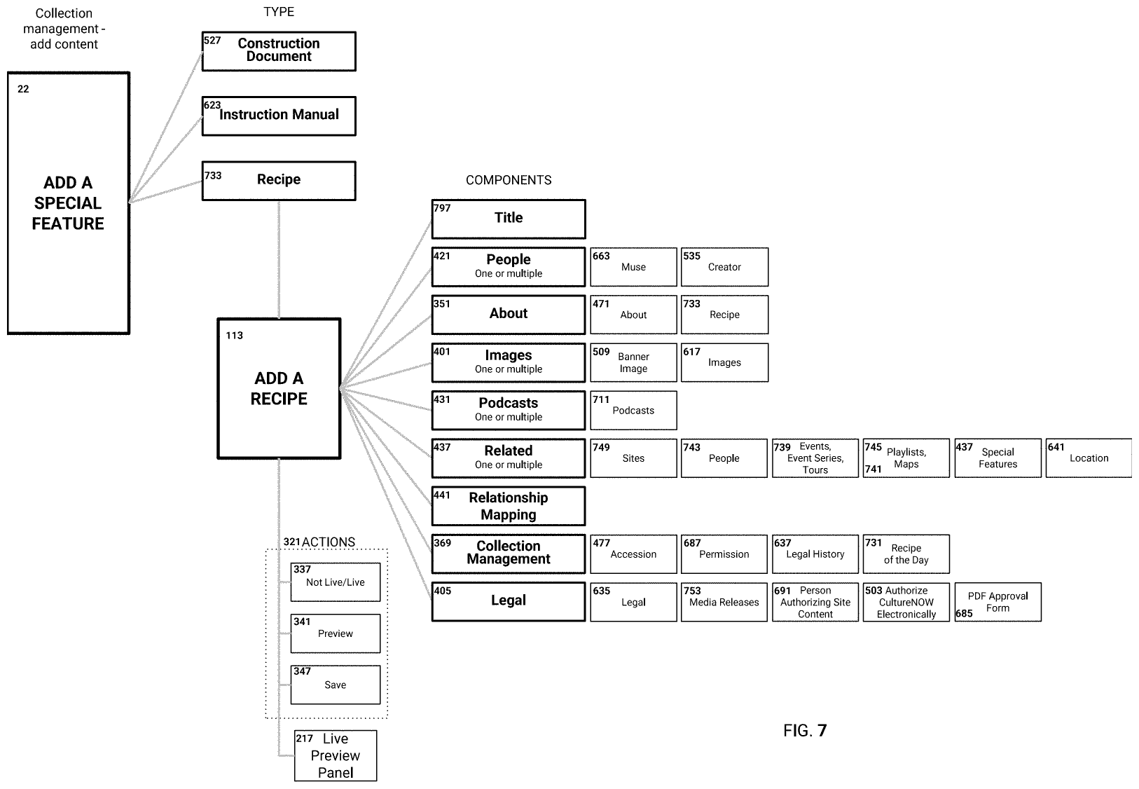

FIG. 7

Definitions

Special Features are details that have a different feature set, structure, functionality, sequence, or layout that set them apart from any of the Building Blocks or Features. Each Special feature will be linked to other Building Blocks and Features, and will be accessible to the user from its own Collection. The CMS for each would also be different.

Currently, the Special Features categories in which users can add content are: Recipes 733, Instruction Manuals 623, and Construction Documents 527. This list will expand as the platform grows and new Special Features are added.

Content Management System

The data entry sequence for adding a Recipe 113 will be used here as an example of the process for Special Features 22. The CMS process, outlined in FIG. 7, begins with entering a recipe Title 797 (name) into a text field.

There are two types of People 421 to associate with recipes—a muse 663, someone who inspires a recipe, and a creator 535, the inventor of a recipe. Names are selected from a dropdown list of People already in the database, which links recipes to the related Building Blocks.

A description About 351, 471 the recipe, that describes it or speaks to its relevance/importance, is entered into a text field. The details of a Recipe 733—ingredients, process, and instructions—are also entered into a text field.

Users can upload Images 401, 617 or choose from images in the database to associate with the recipe. See information about banner 509 and thumbnail cropping in Images FIGS. 5A and 5B.

The Podcasts 431, 711 section allows curators to associate audio or video media with the Recipe. Refer to Podcasts FIG. 6 for more information.

Related 437 items serve the purpose of linking Building Blocks and Features to recipes. Related items can include: Sites 749; People 743; Events, Events Series, and Tours 739; Playlists 745, Maps 741; and recipes or other Special Features 437. Users can add these via a dropdown. Locations 641 get added automatically from the linked related items.

Refer to the following diagrams and descriptions for information about the remaining data entry sections: Relationship Mapping 441 (see FIG. 20A, 20B, 20C, 20D); as well as Collection Management 369, 477, 687, 637, 731 (see FIG. 21C); Legal 405, 635, 753, 691, 503, 685; and Live Preview Panel 217 under Content Management System.

Refer to Content Management System regarding user Actions 321, including Live/Not Live 337, Preview 341, Save 347.

Frontend UI

Website

Each Special Feature has a different website layout. Recipes have a typical layout with a banner Image on top, and all relationships and related content on the left side. The right side contains the About section and the recipe along with the images and the In This Photo section.

App

Each Special Feature will have a different layout. Recipes have a typical layout with a banner Image on top with About, Recipe, Images, and Media tabs.

Building Block:

Maps

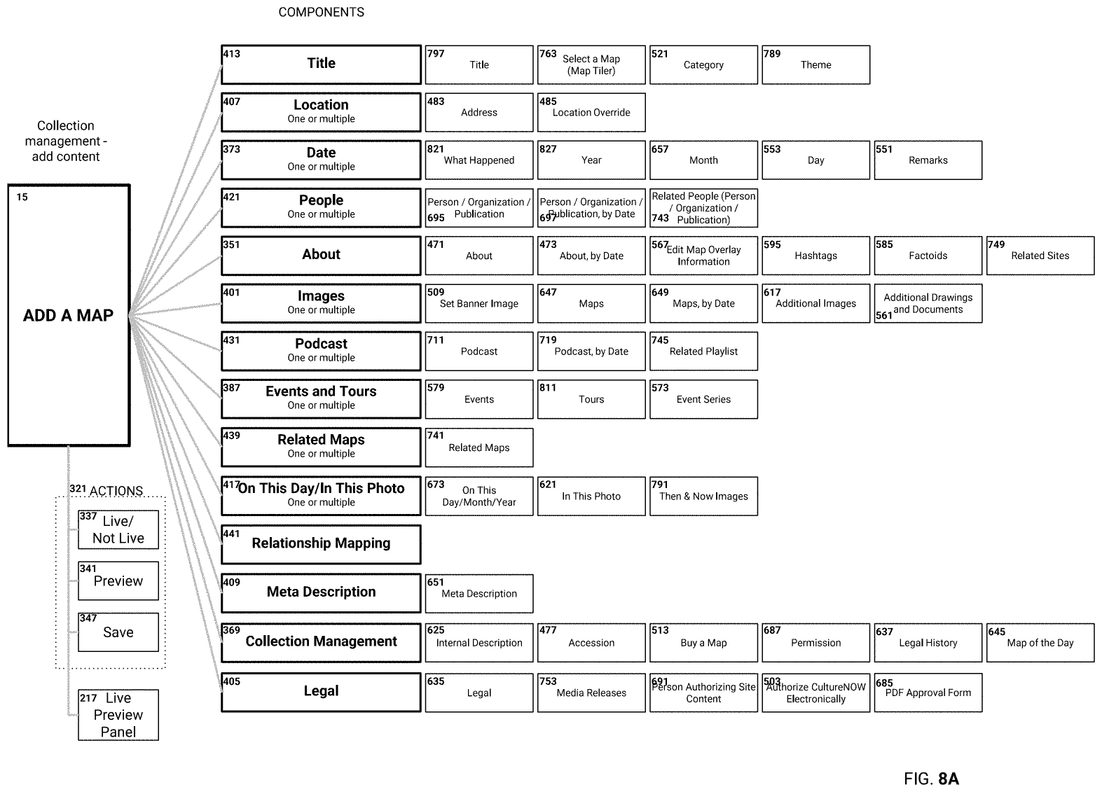

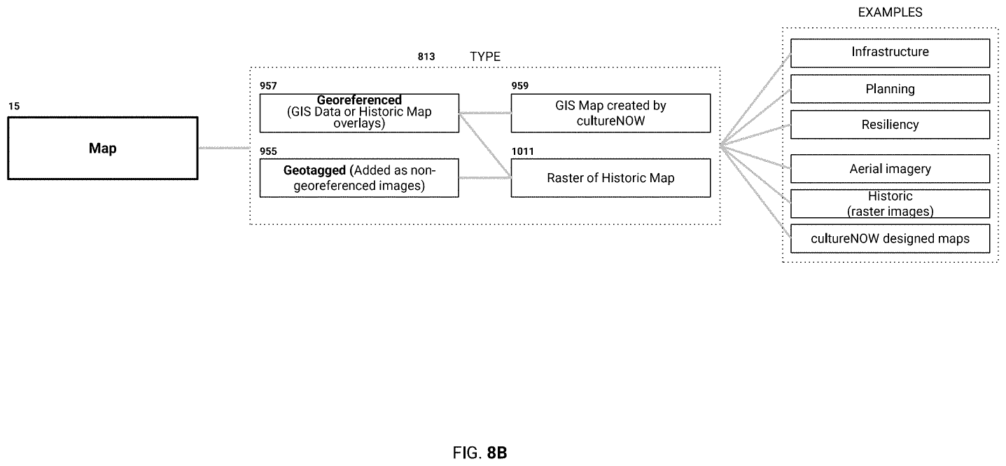

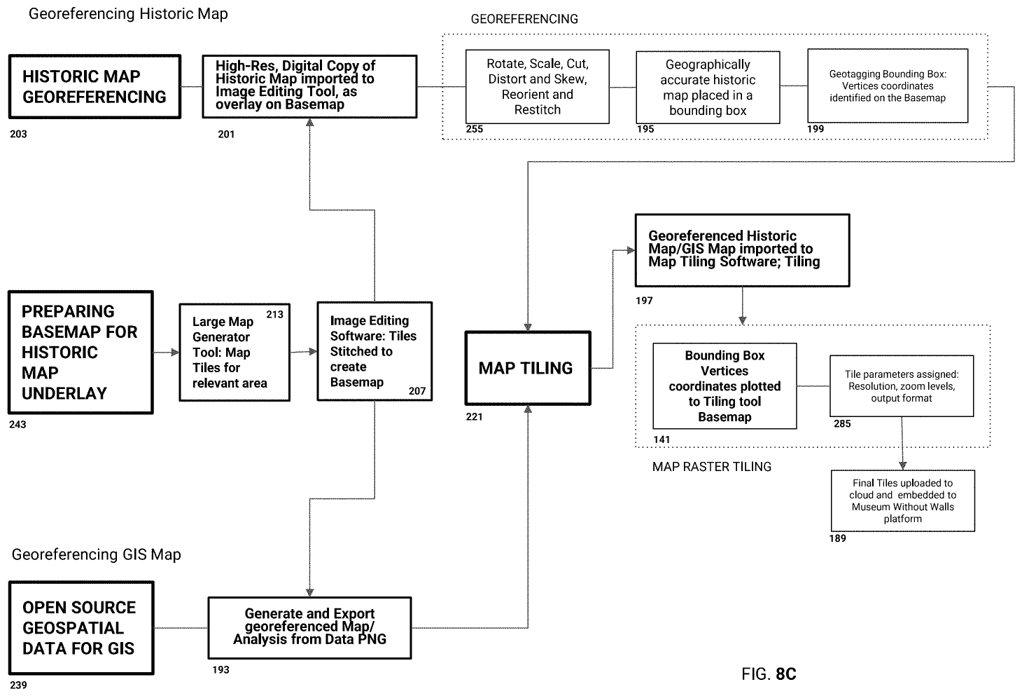

FIG. 8A, FIG. 8B, FIG. 8C

Definitions

Digital Street Map is the basemap powered by Google Maps, to be used as an underlay for mapping locations of sites, people, events, and artifacts in the form of Pins, Routes, Areas, Historic Map overlays, and GIS Map overlays.

GIS (Global Information System) maps are generated from large datasets typically from government sources. An example is the NOAA (National Oceanic & Atmospheric Administration Anticipated sea level rise in 2050 and 2100 or the Frequency of Wildfires in the US from the US Geological Survey). They are also georeferenced and pinned to the basemap.

KML (Keyhole Markup Language) is the digital format used to express geographic annotation and visualization by storing locations and modeling information.

GeoJSON is an open standard geospatial data interchange format that represents simple geographic features and their nonspatial attributes. Based on JavaScript Object Notation (JSON), GeoJSON is a format for encoding a variety of geographic data structures.

Historic Maps are hand-drawn or printed maps from history, created prior to satellite imagery. They are digitally scanned and adjusted to accuracy in the platform, to keep the original character of the map with only discrete changes in position to make them more aligned with the geographically accurate underlying basemap (georeferenced).

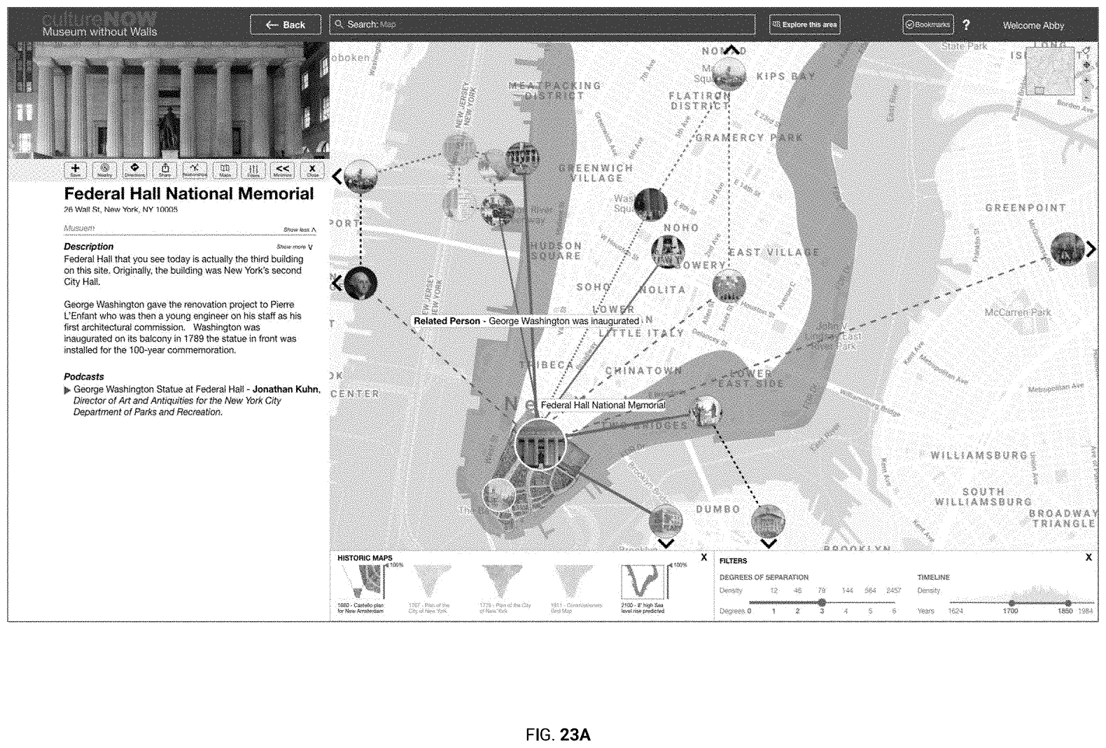

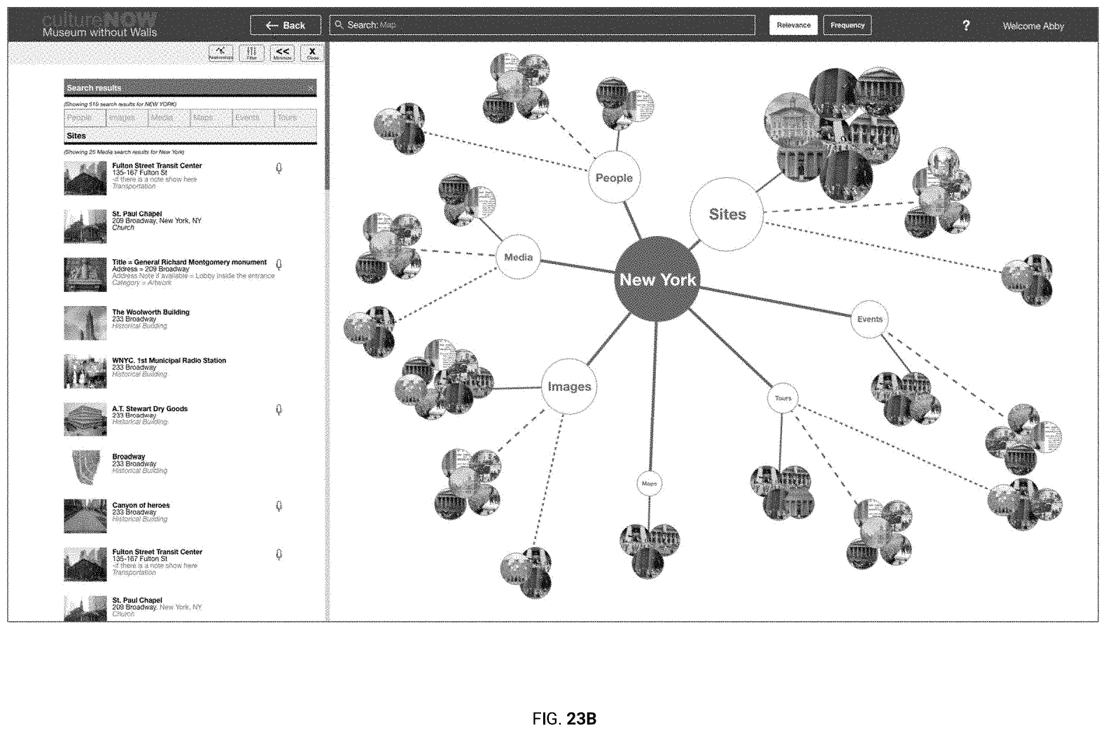

CultureNOW curators use a proprietary workflow (see FIG. 8C) that uses industry-standard image editing and mapping tools to modify and accurately georeference these historic maps 203 based on current satellite images. A user can view these maps, overlaid on the Map View FIG. 23 (refer to Map View under User Features 81), along with other location pins, route lines, and areas for context, and can also toggle transparency, to understand how the spatial arrangements from the past are positioned today. These maps show up as icons below the map page, with a brief description and users can click on individual icons to activate the overlay (see FIG. 23).

Refer to Relationship Mapping under Content Management System (see FIG. 20A, 20B, 20C, 20D).

Features

All Building Blocks of the platform (Sites, People, etc.) have a Map View to show a geographic reference (refer to Map View under User Features).

Content Management System

Every Site is geotagged. It is given GIS coordinates that will work on Google Maps. Many Sites such as works of art may not have a street address. The website is set up so that they can be adjusted manually to reflect their location. Sites such as infrastructure may be a path. This can be drawn. And they can be an area. This can be precisely drawn on the maps.

Additionally, there are a series of historic and GIS maps that have been adjusted and pinned to Google Maps.

There are three ways that Maps can be added to a Site:

FIG. 8A—They can be uploaded as images.

FIG. 8C—High-Resolution Maps, historic or otherwise, can be georeferenced by curators, through an established workflow and uploaded to the platform.

FIG. 2—The shape files can be directly uploaded into the platform as GeoJSON or KML files.

The data entry sequence below pertains to the first method of adding Maps 15, shown in FIG. 8A.

Curators add a Map name in a Title 413, 797 text field. If the map has been uploaded to the Site through tiling software 763, then it will need to be connected to the database which can be done here. The map will be assigned a category 521 and a theme 789, which both pull from a dropdown menu and can be rearranged.

If a map is uploaded as an image, it can be positioned with a Location 407, and geolocated by entering an address 483 and/or coordinates. The location should be described (neighborhood). The map can also be adjusted in the preview mode along with the marker location. If a map has multiple disconnected components, the curator can add them individually. The curator has the option of selecting a point, path, or area and drawing the boundaries on the Site. For instance, If a KML shape file is uploaded that needs refinement, the curator has the ability to move the boundaries (refer to Locations FIG. 2 under Elements). Location override 485 provides the option to change how this appears to a frontend user.

In the Date 373 section, curators can enter ‘What Happened’ 821 date events (drawn, surveyed, photographed, published, redrawn, etc.) and their associated year 827, month 657, and day 553. A remarks 551 text field describes the event's association with the Map, location, and date.

The curator can add People (individuals, organizations, and/or publications) 421 who are directly associated to the Map 695. These can be organized by date 697. Related People 743 would also be linked here. The remarks fields accommodate any curatorial input.

The About 351, 471 text field contains a description of the Map. Descriptions can be written and organized by date 473. There is a provision for editing and supplementing the overlay map section 567 with additional information. Hashtags 595 (refer to Content Management System), interesting factoids 585, and Related Sites 749 can also be added and reordered here.

The curator can add Images 401, set and crop the banner 509 and thumbnail and add any additional images 617 or drawings and documents 561 that are appropriate. Additional Maps 647 can also be added here and can be organized by date 649. The images can be credited and captioned and reorganized as needed.

Audio and video Podcasts 431, 711 can be added in this section and they can be associated with any date 719. As they are uploaded, the curator can select the thumbnail image, title them, credit them, and describe them. The curator can also add Related Playlists 745.

The Events & Tours 387 tab allows the curator to connect the Maps to Events 579, Tours 811, and Event Series 573 on the database. Once added, they can be rearranged and described.

The Map can be attached to other Related Maps 439, 741 which establishes a two-way relationship between them.

The curator relates the map and then can describe the relationship and why it is relevant.

In the On This Day/In This Photo 417 section, the curator can work on the following items: On This Day/In This Month/In This Year 673 (see FIG. 17), In This Photo 621 (see FIG. 19), and Then and Now Images 791 (see FIG. 18).

Refer to the following diagrams and descriptions for information about the remaining data entry sections: Relationship Mapping 441 (see FIG. 20A, 20B, 20C, 20D); as well as Meta Description 409, 651; Collection Management 369, 625, 477, 513, 687, 637, 645 (see FIG. 21C); Legal 405, 635, 753, 691, 503, 685; and Live Preview Panel 217 under Content Management System.

Refer to Content Management System regarding user Actions 321, including Live/Not Live 337, Preview 341, Save 347.

Frontend UI

Website

Maps appear on the frontend of the website as a collection. As a separate element, it provides access to all mapping data, accessible through the main menu on the home page. The Map page typically shows all the relevant location pins, route lines, and areas, depending on the user's current location and/or the area the user wants to examine. On the left, the user can see these same geolocated items as a list under an explore option. Clicking on these items makes the Map zoom into their location. Additionally, the user can zoom in and zoom out. Based on the area covered in the view, historic and GIS data maps appear as thumbnails with a brief description at the bottom of the page; users can click on individual or multiple thumbnails to activate the overlay. Users can also toggle transparency, to understand how the spatial arrangements from the past are positioned today.

App

Within other Building Block pages, Maps are accessed via the “Map” and the “Images” tab. In Collections pages, they appear in the “List” view along with other content and media, such as a Then and Now map.

FIG. 8B shows the organization of data according to Map 15 types 813.

Map types include:

Georeferenced 957 Maps that are overlaid on the basemap on the cultureNOW platform. This includes GIS Maps and digital images of historic maps that have been georeferenced by curators at the cultureNOW.

Geotagged 955 images that have an address attached to them. This includes historic maps that are uploaded as images but are not georeferenced or overlaid on the cultureNOW basemap.

These Maps can include infrastructure, planning, resilience and climate prediction maps, as well as aerial imagery, raster images of historic maps 1011, and data maps developed by cultureNOW 959.

FIG. 8C outlines the process for georeferencing Historic and GIS Maps. Georeferencing refers to the process of transforming a scanned map or aerial photograph, so it appears “in place” on a spatially referenced map (Google Maps, OpenStreetMap, etc.). Popular georeferencing tools match a series of ground control points (which are locations that can be accurately identified in real-world coordinates) with locations on a raster dataset (historic maps). In the final outcome of the transformation, the raster or historic map, although approximately accurate, may be warped, stretched, and distorted and may have some degree of error. CultureNOW curators use a proprietary workflow that uses industry-standard image editing, mapping, and tiling tools to modify and accurately georeference these historic maps based on current satellite images.

As shown in FIG. 8C, there are two types of Maps that are georeferenced, a digital version of a historic map 201 or a GIS map 193. In both cases, the first step is to create a high-resolution basemap 243—a satellite image of the area on which the historic map is to be placed and edited. This map is typically generated from various online tools, in the form of tiles 213 which are then carefully stitched together 207 using image editing software. Once the basemap is ready, the digital copy of the historic map is imported onto the basemap in the image editing software 201. Using transformational tools in the software, such as rotating, scaling, cutting, distorting, and skewing 255, the historic map is made to match the underlying basemap in terms of streets, historic structures, and other elements that have remained unaltered in the time between now and the creation of the historic map. Within the image editing software and the underlying basemap in place, and both maps aligned north-south, the now geographically accurate historic map is then placed into the smallest possible bounding box that encompasses the entire map 195. Two opposite corners of the bounding box are selected—either Northwest and Southeast or Northeast and Southwest—and the coordinates are noted from the basemap 199.

Once the reworked and restitched historic map is exported as a PNG with the extents of the bounding box signifying the extents of the final PNG image, it is then imported into a tiling software 221, 197. The tiling software uses the two sets of coordinates to plot the newly created image onto a web map 141. Since the map, in its final destination on the cultureNOW platform will be zoomable, the curators determine the various parameters for the desired end effect, including resolution, zoom levels (which decides the total number of tiles generated), and output format 285. The resulting tiles and the embed code provided by the tiling software are uploaded to cloud storage from where they are embedded to the cultureNOW platform 189.

For GIS Maps, once data is processed and used to create maps in GIS software, the maps are exported in PNG format 193. The process for creating a basemap, and tiling and embedding it on the cultureNOW platform 189 remains the same as in the case of historic maps.

Building Block:

Events

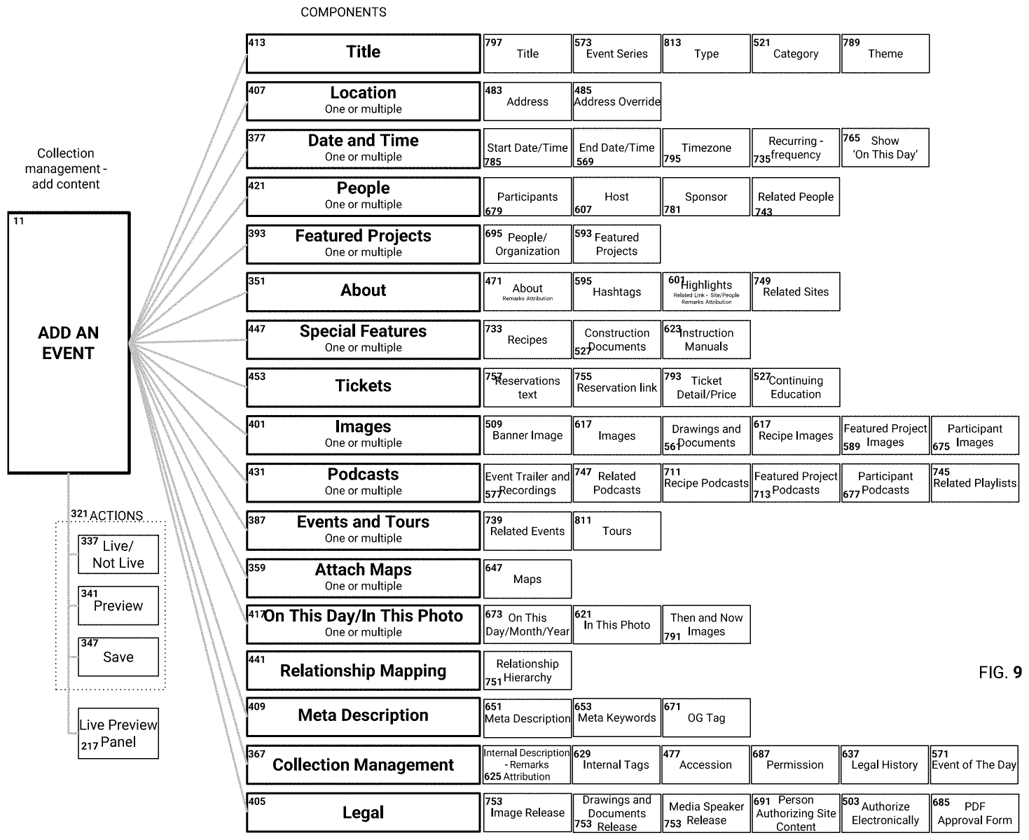

FIG. 9

Definition

Any virtual or in-person program hosted or promoted by cultureNOW, including lectures, gatherings, workshops, etc. (i.e. Cocktails & Conversations). Events connect to a platform-wide calendar. Many Sites have an Event feature that promotes upcoming Events and allows the user to reserve tickets, put them on their personal calendar, and navigate to the venues. The platform enhances this by linking People, Images, media, and Sites to the Events.

Some Events have Building Blocks and Special Features associated with them, such as publications (documents, books), videos, and recipes. cultureNOW, for instance, has a series of programs that have original cocktails created for them. The recipes are contained in their own collection and are downloadable with information about their provenance and who they were created for.

Content Management System

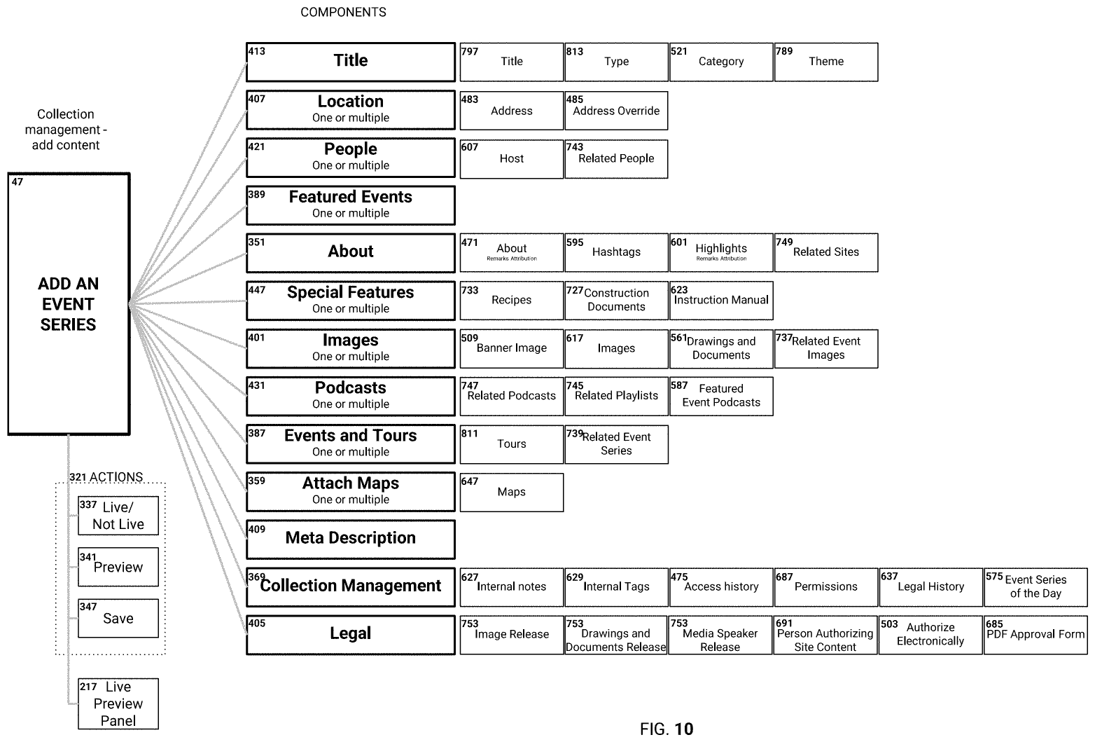

As shown in FIG. 9, the first CMS section when adding an Event 11 to the database—Title 413—includes an Event name 797; an association or attachment to an Event Series 573, if the Event is connected to or part of a grouping of Events (see Event Series FIG. 10); Event type 813 (i.e. exhibition, lecture, etc.); Event categories 521 (i.e. architecture, historic, etc.); and any Event themes 789 (i.e. culture, housing, etc.).

Adding a Location 407 (geolocated address 483 and latitude/longitude coordinates) to an Event links it to the platform-wide basemap. Multiple addresses can be added. Address override 485 provides the option to change how this location appears to a frontend user.

Within Date and Time 377, curators can enter a start date/time 785 and end date/time 569 (if different) for the Event. The curator can also select a time zone 795 if the time zone for the Event is different from theirs (which is the default). Via the Recurring action button, Events dates and times can be set as repeating, with either daily, weekly, monthly, or yearly frequencies 735. Multiple dates and times can be added for multi-day Events. By selecting a checkbox, curators control whether the Event will appear within the On This Day feature 765 (refer to On This Day/In This Month/In This Year FIG. 17 within Special Curated Features)

People 412 are attached to Events in a few different ways. Participants 679 are entered with their event role, name, and profession. Participants must be individuals, and cannot be organizations. Multiple participants can be added and reordered according to the desired hierarchy. Event Hosts 607 and Sponsors 781 are entered with just their name; they can be either individuals or organizations. In addition to names of Related People 743, the Remarks text field allows the curator to include notes about their relation to the Event. The curator can add information about People that is not present in the database if needed.

The Featured Projects 393 section allows the curator to add projects and/or Sites that will be featured during the Event. This is accomplished by first selecting names from the previously entered list of People (individuals and organizations) 695, and then selecting from an auto-populated list of projects 593 associated with that person which ones the curator would like to feature on the frontend.

An About 351, 471 text field allows the curator to enter a description for the Event; there is space for remarks attribution as well. Hashtags 595 can be added as well (refer to Content Management System). Highlights 601 tell stories and related information about the Event. Highlights include a date (day, month, year); a link to a related Site or Person in the database, if applicable; and a description of what happened there. Related Sites 749 are secondary, linked Sites that the curator wishes to link with the description of the Event. For example, if the Event were a walking tour, this is where the curator could add events and stories Site types.

Special Features 447 contains recipes 733, construction documents 527, and instruction manuals 623, with the role of the subject specified and linked.

Within the Tickets 453 section, the curator can add a reservation name 757 and RSVP link 755. Variable pricing 793 can be added by associating different prices for different categories of attendants (i.e. members, seniors, students, etc.). Information about qualifications for continuing education credits 527 can also be entered here, including the organization name, credit amount, credit name, and credit subcategory.

Any image within the Images 401 tab can be selected and set as the Event banner image 509, with the same image cropper that's used throughout the platform to set aspect ratios for banners. The curator can add/upload images 617 and/or drawings and documents 561 as well. There must be at least one piece of media in either section. If a recipe has been added, one or more images can be uploaded to accompany the recipe 617. In featured project images 589, the curator can select photos from projects that will be featured during the Event. Participant images 675 allows the curator to add headshots of participants or organization logos.

There are different kinds of Podcasts 431 that can be added to Events—Event trailer and recordings 577, related Podcasts 747, and recipe Podcasts 711. Media can be dragged and dropped between and across these three sections. Featured Project Podcasts 713 and participant Podcasts 677 auto-populate based on projects and participants previously entered—all the podcasts associated with selected projects and people appear here. Related Playlists 745 can also be added.

In Events & Tours 387 the curator can add and link to Related Events 739 and Tours 811.

See information about the Attach Maps 359, 647 functionality within the Content Management System description.

In the On This Day/In This Photo 417 section, the curator can work on the following items: On This Day/In This Month/In This Year 673 (see FIG. 17), In This Photo 621 (see FIG. 19), Then and Now Images 791 (see FIG. 18), and What Happened Here 823 (see FIG. 15).

Refer to the following diagrams and descriptions for information about the remaining data entry sections: Relationship Mapping 441, 751 (see FIG. 20A, 20B, 20C, 20D); as well as Meta Description 409, 651, 653, 671; Collection Management 369, 639, 625, 525, 629, 477, 687, 637, 773 (see FIG. 21C); Legal 405, 635, 753, 691, 503, 685; and Live Preview Panel 217 under Content Management System.

Refer to Content Management System regarding user Actions 321, including Live/Not Live 337, Preview 341, Save 347.

Frontend UI

Website

The Event page is a typical frontend page with a Banner image on top. All details, text content, and Location information sit on the left below the Banner Image. Affiliations, About, Podcasts, other Images, featured projects, Historic Maps, and In This Photo appear on the right below the Banner Image. The Events Page also has a minimizable interactive Calendar overlay on the left side of the Banner Image. The Calendar shows dates when events are listed. The user is able to explore the events calendar; from here, the user is able to sign up for the Event or go to the partner page to RSVP. The user can also add Event details using the Add to Calendar feature. The user can explore Upcoming Events, Past Events, or a record of cultureNOW Exhibitions under the Events menu.

App

The App has similar features/content as the website for an Event. The layout has 5 tabs—About, Images, Media, Map, and Special Features. The layout is typical for these tabs. The Calendar to explore Upcoming Events, Past Events, or cultureNOW Exhibitions is visible under the Calendar menu tab. The user can add Event Details using the Add to Calendar Feature.

Features:

Curated Feature:

Event Series

FIG. 10

Definition

Events Series 47 are a grouping of Events. For example, a large or multi-day Event can have separate programs within it.

Content Management System

Similarly to Building Block pages, adding an Event Series 47 (see FIG. 10) begins with entering a Title 413, 797, up to 2 Event Series types 813 (i.e. exhibition, lecture, etc.), up to 3 categories 521 (i.e. architecture, historic buildings, etc.), and up to 3 themes 789 (i.e. culture, housing, etc.).

Adding a Location 407 (geolocated address 483 and latitude/longitude coordinates) to an Event Series links it to the platform-wide basemap. Multiple addresses can be added. Address override 485 provides the option to change how this location appears to a frontend user.

An Event Series Host (individual, organization, or publication) 607 can be linked within the People 421 section. The curator can also link Related People (individuals, organizations, and publications) 743 associated with the Event Series.

Within Featured Events 389, the curator can add individual Events within the Event Series. This can be accomplished by either adding an existing Event from the cultureNOW database or by adding a new Event. Multiple Event entries can be recorded via drag and drop.

An About 351, 471 text field allows the curator to enter a description for the Event; there is space for remarks attribution as well. See information about adding Hashtags 595 under Content Management System. Highlights 601 tell stories and related information about the Event Series. Highlights include a date (day, month, year); a link to a related Site or Person in the database, if applicable; and a description of what happened there. Related Sites 749 are secondary, linked Sites that the curator wishes to associate with the description of the Event Series.

Special Features 447 contains recipes 733, construction documents 727, and instruction manuals 623, with the role of the subject specified and linked.

Any image within the Images 401 tab can be selected and set as the Event Series banner image 509, with the same image cropper that's used throughout the platform to set aspect ratios for banners. The curator can add/upload images 617 and/or drawings and documents 561 as well. There must be at least one piece of media in either section. Within Related Events Images 737, the curator can select photos from Events connected to the series.

Related Podcasts 747 and Related Playlists 745 can be added and linked to an Event Series in the Podcast 431 section. Featured Event Podcasts 587 auto-populate based on Events previously linked—all the podcasts associated with selected Events appear here.

The curator can add and link to related Tours 811 and Event Series 739 in the Events & Tours 387 tab.

See information about the Attach Maps 359 functionality within the Content Management System FIG. 8A description.

Refer to the following diagrams and descriptions for information about the remaining data entry sections: Meta Description 409, 651, 653, 671; Collection Management 369, 639, 625, 525, 629, 477, 687, 637, 773 (see FIG. 21C); Legal 405, 635, 753, 691, 503, 685; and Live Preview Panel 217 under Content Management System.

Frontend UI

Website

The Events Series page has a typical layout with a Banner Image on top. All Affiliations and related content appear on the left below the Banner Image. A Timeline of Events, About the Event Series, Highlights, Event thumbnails, Recipe thumbnails, Photos and Drawings, Historic Maps, and In This Photo and Then and Now Images show up on the right side below the Banner Image. The Event Series collection is accessible within the Events menu, under Recurring Events.

App

The Events Series layout is similar to other mobile app pages. The app Event Series tabs include About, Events, Media, Map, and Recipe. The Event Series collection is accessible within the Calendar menu, under Recurring Events.

Curated Feature:

Tours

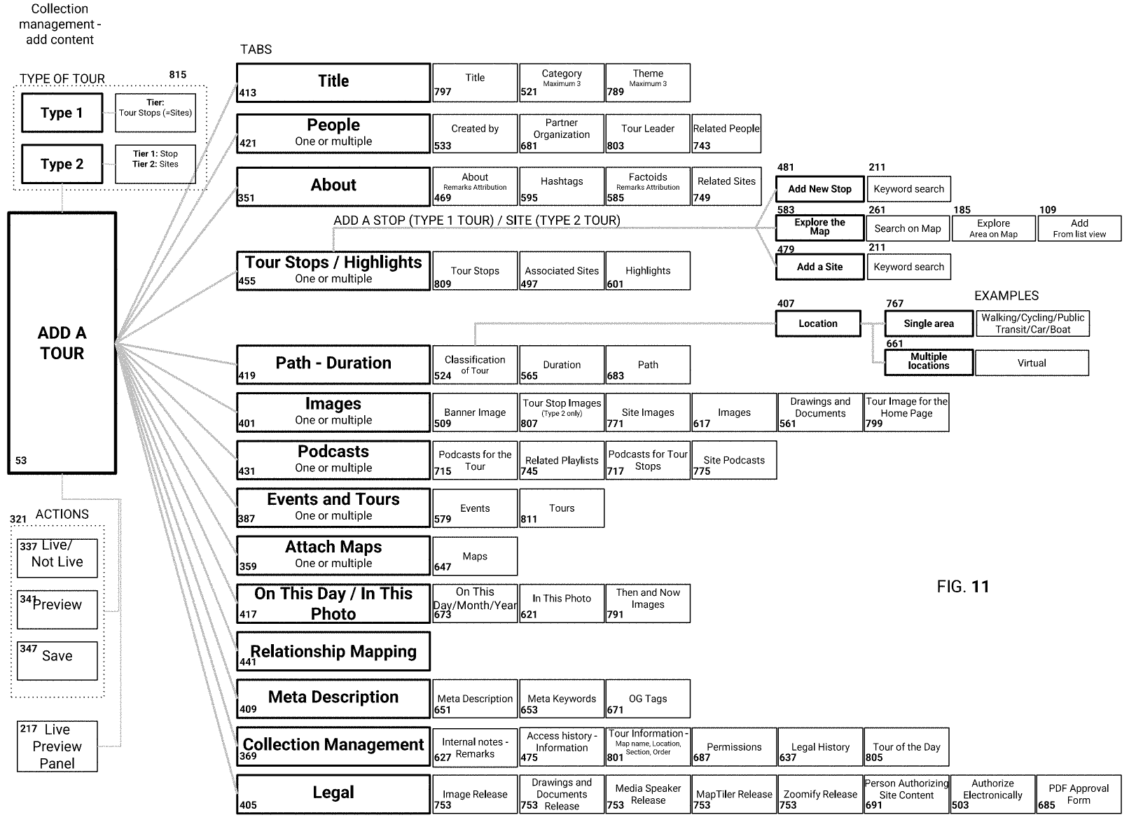

FIG. 11

Definitions

A Tour is a curated list of Sites arranged as a virtual walking tour with stops. The ability to quickly create a self-guided Tour is one of the hallmarks of the platform. The process mimics that of creating an actual walking Tour, where the curator selects a theme, identifies a group of Sites along a route with a defined starting and ending point, and tries to weave the stories associated with the stops into a continuous narrative. A major benefit of the interface is that Sites that are not geographically adjacent can also be arranged to create a virtual Tour.

Type 1 Tour—A Stop functions like a Site, thereby creating only 1 tier of information.

Type 2 Tour—Tier 1 of the information is the Tour Stop, while Tier 2 is the Tour Site.

Content Management System

FIG. 11 outlines the process for adding a tour. The curator has the ability to put together two types of tours: Type 1 and Type 2. Type 1 Tours only consist of Tour Stops (stop=site), while Type 2 Tours consist of Tour Stops as well as Tour Sites. In the latter case, Tour Sites can be grouped under a single Tour Stop, and multiple such Tour Stops make up a Tour 815.

The first data entry section includes a Title 413, 797, which would be the name of the Tour. The curator can add up to 3 Categories 521 and up to 3 Themes 789.

The next section allows the curator to add People 421 associated with the Tour itself. The curator first adds the person or organization that has conceptualized and curated the tour under Created By 533. Then the Partner Organizations 681 for the tour can be listed, followed by the name of the Tour Leader 803. The Related People 743 field allows the curator to link the names of people, organizations, and publications that are related to the tour by theme or content.

In the About tab 351, a text field allows the curator to enter a description for the Tour; there is space for remarks attribution 469 as well. See information about adding Hashtags 595 under Content Management System. Factoids 385 tell stories and related information about the tour. Factoids include a date (day, month, year); a link to a related Site or Person in the database, if applicable; and a description of what happened there. Related Sites 749 are secondary linked Sites that the curator wishes to associate with the description of the tour.

The curator can add Tour Stops/Highlights 455, either through the dropdown suggestion list or on the accompanying map interface. Under each Tour Stop, the curator can group together Associated Sites 497. Highlights 601 allows the curator to showcase up to 3 Tour Stops under the highlighted section on the frontend.

The user can use the following methods for adding a Stop on the Type 1 Tour or adding a Site on the Type 2 Tour. The Add New Stop 481 button allows the curator to add a new Tour Stop through the dropdown suggestion list. Explore the Map 583 button allows the curator to add a new Tour Stop by selecting sites on a map interface. The curator begins with a keyword search 211 to narrow down the area being explored 185, which allows the system to list 109 out all sites contained within the Map View, from where the Sites can be added as Tour Stops. The Add a Site 479 button allows the curator working on a Type 2 Tour to add a new Site under a Tour Stop through the dropdown suggestion list. A Stop for the Type 2 Tour is a Text field, which can simply be typed in by the curator.

Within the Path—Duration 419 section, the curator can define the Classification of the Tour 524 which allows them to define the type of transportation that may be required to conduct the Tour in person or virtually. Tours can be classified into those which are geographically adjacent in a single area 767 (i.e. the same city) or spread across multiple locations 661 (such as different cities, states, countries, or continents). In the former case, examples of self-guided tours may include walking, cycling, public transit, car, or boat. In the latter case, the Tour Stops cannot be physically traversed, and therefore only accessed virtually. The curator can define the approximate Duration 565 of the tour if conducted in person, as well as the Path 683 which maps out the route.

Any image within the Images 401 tab can be selected and set as the tour banner image 509, with the same image cropper that's used throughout the platform to set aspect ratios for banners. The curator can add/upload images to link to specific Tour Stops 807 and Sites 771 as well. Certain images that are related to the Tour but not a specific site or stop can be placed under Images 617, one of which will be defined as the Tour Image for the Home Page 799. Furthermore, Drawings & Documents 561 can be linked to the tour, such as tour catalogs, posters, printed media, etc.

Podcasts 431 can be added by the curator linked to the Tour 715 at large, or certain specific Tour Stops 717 or Sites 775. Related Playlists 745 can be added and linked to the tour.

Curators can add and link to related Events 579 and Tours 811 in the Events & Tours 387 tab.

See information about the Attach Maps 359 functionality within the Content Management System FIG. 8A description.

In the On This Day/In This Photo 417 section, the curator can work on the following items: On This Day/In This Month/In This Year 673 (see FIG. 17), In This Photo 621 (see FIG. 19), and Then and Now Images 791 (see FIG. 18).

Refer to the following diagrams and descriptions for information about the remaining data entry sections: Relationship Mapping 441, 751 (see FIG. 20A, 20B, 20C, 20D); as well as Meta Description 409, 651, 653, 671; Collection Management 369, 639, 625, 525, 629, 477, 687, 637, 773 (see FIG. 21C); Legal 405, 635, 753, 691, 503, 685; and Live Preview Panel 217 under Content Management System.

Frontend UI

Web site

The user interface for the Tour on the website is the typical frontend layout (refer to Website Frontend general section), along with multiple salient features. An interactive map is unique to the Tour page; it appears in place of the typical banner image. The markers on the map are numbered as per the respective Tour Stops and Sites and are dynamically linked to the thumbnails under the sections for the same. For instance, hovering on the marker would highlight the respective section and thumbnail; clicking on the marker would scroll down the page and take the user to the thumbnail. The timeline is also interactive, allowing the user to click to scroll to the respective thumbnail. In addition to the frontend template, the Tour page also shows a specialized Map View with the starting point of the tour and the address, with an option to access a full window map interface where Historic Maps can be overlaid. In Tour Type 1 there are only Stops and no Sites. Therefore, the thumbnails (with name, description, and list of podcasts) are organized under the heading Tour Stops, arranged in the order defined by the curator on the backend. In Tour Type 2, there are Stops as well as Sites grouped under each Stop. Therefore, the thumbnails for each Site (with name, description, and list of podcasts) are grouped under the subsection with the Tour Stop Name, a description of the Tour Stop, a Tour Stop Image, and podcasts linked to that specific Tour Stop. This is followed by the Tour Photos & Drawings, Historic Maps, and In This Photo sections.

App

The user interface for the Tour on the mobile app is the typical frontend layout (refer to Website Frontend general section), along with multiple salient features. In the Stops tab, the list of Stops and Sites (applicable only to Tour Type 2) appears with thumbnails, name, and address. On clicking “show more”, the view is expanded to show larger thumbnails with an additional description and category for each. Podcasts can be played simultaneously while viewing the information, in a mini-player pinned to the bottom of the screen. This allows the user to navigate through the Tour, read the information for each Stop, and also know more through the podcast, all at the same time, akin to a real-life walking-tour experience. An interactive map that appears in the Map tab shows the markers numbered as per the respective Tour Stops and Sites, which can be clicked to show a collapsible screen with a list of all Stops and Sites (if applicable).

The user can also create, edit or customize their own Tour from the app frontend itself. The user's custom Tour works like a “playlist for sites”, where they can Save As an existing Tour, rename it, and then add or remove certain Stops. The new Tour will be saved in their own User Account Collection. Alternatively, the user can add multiple Sites or Stops from the Search or Explore screens, then go into their User Account Collection to create a customized Tour from the saved Sites. In both cases, the user will be able to view the Tour on a map interface as well as listen to the podcasts already attached to that site in the database.

Curated Feature:

Playlists

FIG. 12

Definition

A collection of audio or video podcasts.

Content Management System

The data entry sequence below (see FIG. 12) outlines the process for curators to add new or edit existing playlists. The structure also applies to automated playlists. Some of the data is automatically populated and then can be overridden or edited/added from the Playlist CMS.

Curators determine what Playlists are called by entering a Title 413, 797 in a text field. Up to 3 categories 521 (i.e. architecture, infrastructure, etc.) and up to 5 themes 789 (i.e. finance, celebration, etc.) can be added.

Curators are able to add and link Podcasts 431, 711 from the cultureNOW database. The curator can also link related playlists 745 that the curator believes matches the subject/theme/category of the playlist being curated. The More Playlists by Curator 659 section auto-populates with other playlists the same curator has previously added.

One or more curators 547 can be added by linking to existing People 421 pages. Related People 743 can also be added and linked, displaying the names of individuals, organizations, and publications that may be connected to the podcasts (thematically or otherwise).

A Description 351 entered in a text field describes what the Playlist is about, in terms of content and relevance. See information about adding Hashtags 595 under Content Management System. The curator can also link to Related Sites 749 that are mentioned in the Playlist's Podcasts, or hold key relevance in terms of subject matter.

Special Features 447 contains recipes 733, construction documents 537, and instruction manuals 623, with the role of the subject specified and linked.

Within the Images tab 401, the Playlist Banner Image 509 is automatically generated by compiling 4 evenly-sized, rectangle, thumbnail images (those associated with the first 4 Podcasts in the Playlist) into a single rectangle. The curator can change the image associated with each Podcast 619 by entering the Podcast editor. Reordering Podcasts influences the banner image composition. The curator also has the ability to change the images that appear within the banner by opening the banner editor and uploading photos from the cultureNOW database. See information about image editing in Images FIG. 5B.

The curator can link to Events 579, Tours 811, and Event Series 573 already existing in the cultureNOW database in the Events & Tours tab 387.

See information about the Attach Maps 359 functionality within the Content Management System FIG. 8A description.

Refer to the following diagrams and descriptions for information about the remaining data entry sections: Meta Description 409, 651, 653, 671; Collection Management 369, 639, 625, 525, 629, 477, 687, 637, 773 (see FIG. 21C).

Frontend UI

Website

The Playlist page is a typical frontend page with a dark overlay on the Banner Image on top. The Banner Image background randomly picks up from any of the Images below. The main Playlist Banner shows up as a group of 6 Podcast Banner Images aligned with the left side of the page. All details, related content, and text information shows up on the left below the Banner Image. There is a Play Button that allows the user to queue all Podcasts in the Playlist. The Podcasts are listed in a vertical list on the right side below the Banner Image. Playlists by the same Curator, other Related Playlists, and Historic Maps show up on the right below the Banner Image. Playlists are accessible within Collections, under the Media Collection.

App

The Playlist page is a typical mobile app page. The main Playlist Banner shows a group of 4 Podcast Banner Images. The app Playlist tabs include About and Media. Playlists are accessible within the Discover menu, under Media.

Curated Feature:

Collections

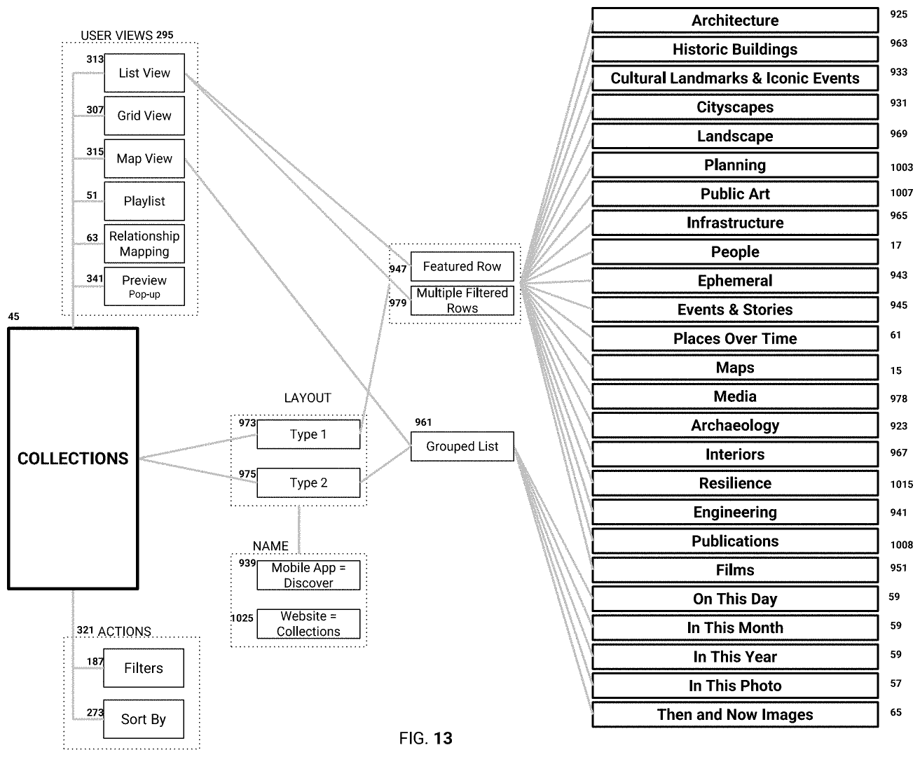

FIG. 13

Definition

Collections display the breadth and diversity of Building Blocks and Features in a coherent way, making it easy for the user to navigate them. There are currently 25 collections. This will change over time as more collections will be added. These are accessed from the menu bar.

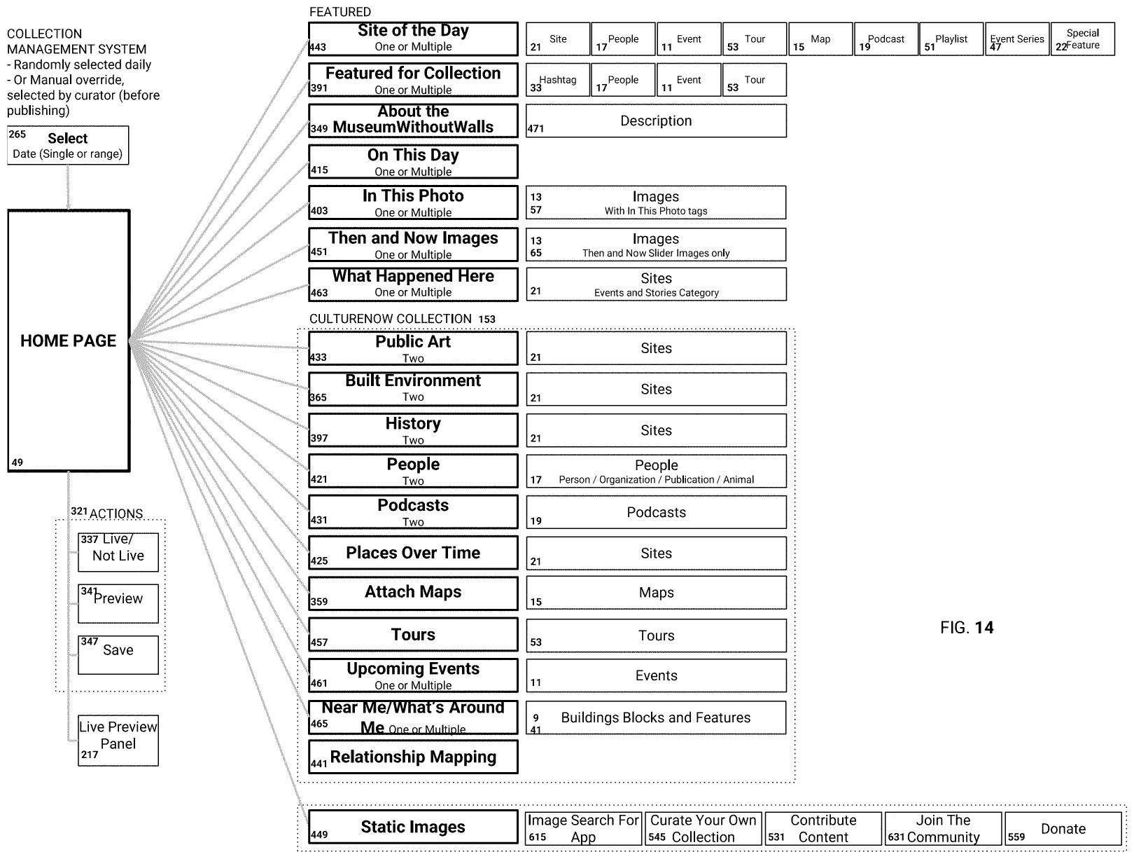

Type 1 973 Layout—A collection of all items in the database grouped by Category, Theme, Building Block, or Feature. 20 Collections have this layout format (refer to FIG. 13). The first row on every collection is the Featured Row 947 which is curated from the Home Page CMS (see Home Page FIG. 14). All other rows are hardcoded for each collection. Each of these rows is filtered by one or multiple criteria 979.

Type 2 975 Layout—The content is automatically populated in these collections for every item in that Feature that is Live. 5 Collections follow this layout (refer to FIG. 13). This is a Grouped List 961 where all items are listed together in one section organized by date (various other sort options are available to the user).

Data Organization

FIG. 13—The 25 Collections

Types of Multiple Filtered Rows 979—Each row of the collection is pre-filtered for specific content by the curator so that each one showcases the collection from different perspectives. Each row could be filtered by one or multiple criteria. Rows filtering options include various Elements, and relationships between Building Blocks and Features:

Date (Recent, Historic, by decade, or by century) for Building Blocks and Features. (Historic Figures from the 16th Century)

Category, Sub Category, Program/Type, or Theme for Sites

People Profession, Organization Type, Publication Type, or Animal Type (Engineers)

People Role on Building Blocks and Features (Podcasters)

Category or Theme for Building Blocks other than Sites and People (Events and Stories Category on Podcasts)

Category or Theme for Features (Infrastructure Category on Event Series)

Location (City, State, or Country)

Awards, Designations for Sites

Awards for People

Hashtags tied to Building Blocks and Features

Building Blocks related to Building Blocks (example all Sites credited to a Person)

Features related to Building Blocks (example all Tours credited to an Organization)

Building Blocks related to Features (example all Podcasts credited to an Event Series)

Features related to Features (example all Tours credited to an Event Series)

Architecture 925—This type 1 collection has Sites that are in the Architecture category. It also has all other Building Blocks and Features of Architecture category or related to the same.

Rows: Featured (tied to an event, the home page featured site), recent buildings, Architecture by decade for the last century, Historic Buildings, by program type, ephemeral, architects, architecture firms, publications credited or connected to architecture, cities, designation, award, sustainable design or resilience, public tag or hashtag, events & stories, tours, events, Podcasts, Playlists, Event Series, Special Features, Images linked to the category.

Historic Buildings 963—This type 1 collection has sites that are Architecture category and the Theme is Historic Buildings. It also has all other Building Blocks and Features of Historic Buildings category or related to the same.

Rows: Featured (tied to an event, the home page featured site), Recent Renovations (date selected), Program/type, Ephemeral, Architect, Architecture Firms or Interior Design Firm or Preservation Organization, Publications directly credited to a site or architecture where historic is checked off, city, designation type, Award, sustainable or resilient, public tags, Events & Stories, Tours, playlists, Podcasts, Events, Event Series, Special Features, Images linked to the category

Cultural Landmarks & Iconic Events 933—This type 1 collection has Sites where the theme is Cultural Landmarks or Iconic Events. It also has all other Building Blocks and Features of Cultural Landmarks or Iconic Events category or related to the same.

Rows: Featured (tied to an upcoming event, or the home page featured site or person), Main category, program type, people who have a site credited as a cultural landmark or iconic event, an organization which has a site credited to them which is themed as a cultural landmark, publications in any category, city, designation, award, public tag, events & stories, tours, playlists, podcasts, event series, events, special features, images

Cityscapes 931—This type 1 collection of Images with Image Type Cityscapes. It also has all other Building Blocks and Features which are related to Images of Image Type Cityscapes or related to the same.

Rows: Featured (tied to an upcoming event, or the home page featured site or person), Recent cityscapes, historic by a date range, by category, ephemeral, people credited with the images such as photographers, an organization type such as a collection, publications in any category, city, public tag, events & stories, tours, playlists, podcasts, event series, events, special features, in this photo—people, in this photo—sites, then & Now photo, images.

Landscape 969—This type 1 collection has Sites that are in the Landscape category. It also has all other Building Blocks and Features of Landscape category or related to the same. Rows: Featured (tied to an event, the home page featured site), recent landscapes, Landscape projects by decade for the last century, by program type, ephemeral, landscape architects, landscape architecture firms, collaborations with architects publications credited or connected to architecture, cities, designation, award, sustainable design or resilience, public tag or hashtag, events & stories, tours, events, Podcasts, Playlists, Event Series, Special Features, Images linked to the category

Planning 1003—This type 1 collection has Sites that are in the Planning category. It also has all other Building Blocks and Features of Planning category or related to the same Rows: Featured (tied to an event, the home page featured site), recent Planning Projects, Planning projects by decade for the last century, by program type, ephemeral, planners (or architects, landscape architects, urban designer, engineer, preservation consultant, or historic figure attached to a planning project), firms attached to a planning project, collaborations with architects, publications credited or connected to architecture, cities, designation, award, sustainable design or resilience, public tag or hashtag, events & stories, tours, events, Podcasts, Playlists, Event Series, Special Features, Images linked to the category

Public Art 1007—This type 1 collection has Sites that are in the Public Art category. It also has all other Building Blocks and Features of Public Art category or related to the same. Rows: Featured (tied to an event, the home page featured site), recent Works, public artworks by decade for the last century, type, ephemeral, artists, collections, firms attached to a planning project, collaborators, publications credited or connected to public art, cities, location (bounded area), designation, award, sustainable design or resilience, public tag or hashtag, events & stories, tours, events, Podcasts, Playlists, Event Series, Special Features, Images linked to the category

Infrastructure 965—This type 1 collection has Sites that are in the Infrastructure category. It also has all other Building Blocks and Features of Infrastructure category or related to the same.

Rows: Featured (tied to an event, the home page featured site), recent Infrastructure Projects, Infrastructure projects by decade for the last century, by subcategory/program type, ephemeral, people (architects, landscape architects, urban designer, engineer, preservation consultant, or historic figures attached to an infrastructure project), firms attached to an infrastructure project, collaborations with architects, publications credited or connected to architecture, cities, designation, award, sustainable design or resilience, public tag or hashtag, public art connected or associated with an infrastructure project, events & stories, tours, events, Podcasts, Playlists, Event Series, Special Features, Images linked to the category

People 17—This type 1 collection has all Persons, Organizations, Publications, and Animals. It also features all other Building Blocks and Features related to specific People.

Rows: Featured (tied to an event, the home page featured site), people by row, organization by type, publication by type, historical figures from (by date), podcasters, authors, cocktails & conversations speakers (event series speakers), in memoriam, by city, awards, Hashtags, events and stories, by name, photographs by photographer name, tours by person or organization, playlists by curator, podcasts by podcaster name, event series by host name, events by person or org name or publication, special features (recipes by creator name) images by person name.

Ephemeral 943—This type 1 collection has Sites where the theme is Ephemeral. It also has all other Building Blocks and Features of Ephemeral category or related to the same. The content is essentially any site that is temporary, removed, demolished, wrecked, ended, etc.

Rows: Featured (tied to an event, the home page featured site), temporary public art installations, pop-up Architecture, architecture necrology, archaeology, unbuilt—(proposals by collection category) unbuilt

Proposals by subcategory/program type, exhibitions, competitions, cities, awards, people (architects, landscape architects, urban designer, engineer, preservation consultant, or historic figures attached to an ephemera project), firms attached to an infrastructure project, collaborations with architects, publications credited or connected to architecture, designation, sustainable design or resilience, public tag or hashtag, public art connected or associated with an infrastructure project, events & stories, tours, events, Podcasts, Playlists, Event Series, Special Features, Images linked to the category

Events & Stories 945—This type 1 collection has Sites that belong to the Events and Stories category. It also has all other Building Blocks and Features of Events and Stories category or related to the same.

Rows: Recent events, past events by decade 1900's, past events by decade 1800's, past events by decades 1700's, past events 17^{th} century, past events 16^{th} century & earlier, subcategory/program type, events & stories at ‘site name’, People, organizations, publications connected to an event, city, awards, sustainable design or resilience, public tag or hashtag, tours, upcoming events, Podcasts, Playlists, Event Series, Special Features, documents linked to the category

Places Over Time 61—This type 1 collection has Sites that have a timeline. It also has all other Building Blocks and Features of Places Over Time category or related to the same.

Rows: Featured (tied to an event, the home page featured site), recent Infrastructure Projects, maps of ‘location’, main category, program type, city, designation, people (organizations, individuals, historic figures) attached to an infrastructure project), firms attached to place over time, publications credited or connected to a place over time, cities, designation, award, sustainable design or resilience, public tag or hashtag, events & stories, tours in ‘location name’, tours, events, Podcasts, Playlists, Event Series, Special Features, Images linked to the category

Maps 15—This type 1 collection contains Maps. It also has all other Building Blocks and Features of Maps category or related to Maps.

Rows: Featured (tied to an event, the home page featured site), category, theme, authors and collections, city, hashtag, organization, maps as art (maps in the public art category), tours, playlists, podcasts, events, event series,

Special Features, Images linked to the category

Media 978—This type 1 collection has audio Podcasts, Videos, and Playlists. It also has all other Building Blocks and Features related to the same.

Rows: Featured (tied to an event, the home page featured site), recently added podcasts, recently added videos, recent playlists, main category, program or subcategory, theme, curators, authors, historic figures, city, hashtag, publications, tours, playlists, podcasts, events, event series, films

Special Features, Images linked to the category, in this photo

Archeology 923—This type 1 collection has Sites that fall under the Archaeology category. It also has all other Building Blocks and Features of Archaeology category or related to the same.

Rows: Featured (tied to an event, the home page featured site), recent renovations, exhibitions, competitions, cities, awards, people by role, firms credited to an archeology project, publications credited or connected to archeology projects, designation, sustainable design or resilience, public tag or hashtag, public art connected or associated with an archeology project, events & stories, tours, events, Podcasts, Playlists, Event Series, Special Features, Images linked to archeology projects

Interiors 967—This type 1 collection has Sites that are in the Interiors category. It also has all other Building Blocks and Features of Interiors category or related to the same.

Rows: Featured (tied to an event, the home page featured site), recent buildings, Interior category sites by decade for the last century, Historic Building interior category sites, by program type, ephemeral, architects, architecture firms, publications credited or connected to architecture, cities, designation, award, sustainable design or resilience, public tag or hashtag, events & stories, tours, events, Podcasts, Playlists, Event Series, Special Features, Images linked to the category.

Resilience 1015—This type 1 collection has Sites where the theme is Resilience. It also has all other Building Blocks and Features of Resilience category or related to the same.

Rows: Featured (tied to an event, the home page featured site), categories, subcategory/program type, cities, awards, people (architects, landscape architects, urban designer, engineer, preservation consultant, or historic figures attached to an resilience project), firms attached to a resilient project, publications credited or connected to resilience, designation, public tag or hashtag, events & stories, tours, events, Podcasts, Playlists, Event Series, Special Features, Images linked to the category

Engineering 941—This type 1 collection has Sites that are in the Engineering category. It also has all other Building Blocks and Features of Engineering category or related to the same.

Rows: Featured (tied to an event, the home page featured site), recent buildings, Engineering sites by decade for the last century, Historic Engineering Sites, by program type, ephemeral, engineers, engineering firms, publications credited or connected to Engineering sites, cities, designation, award, sustainable design or resilience, public tag or hashtag, events & stories, tours, events, Podcasts, Playlists, Event Series, Special Features, Images linked to the category.

Publications 1008—This type 1 collection has all publications. It also features all other Building Blocks and Features related to specific publications.

Rows: Featured (tied to an event, the home page featured site), publication by type, historic publications (by date), publication authors, by city, awards, Hashtags, events and stories, by name, photographs by photographer name, tours by person or organization, playlists by publication name, podcasts by publication name, event series related to publication, events related to publication, special features (recipes by creator name), images by person name

Films 951—This type 1 collection has Sites that are Film Sub Category under the Events and Stories category. It also has all other Building Blocks and Features of Film category or related to the same.

Rows: Recent Film, past Film by decade 1900's up to 1890, subcategory/program type, films at ‘site name’, People, organizations, publications connected to a film, city, awards, sustainable design or resilience, public tag or hashtag, tours, upcoming events, Podcasts, Playlists, Event Series, Special Features, documents linked to the category

On This Day 59—This type 2 collection has On This Day items laid out on pages sorted by calendar dates. The user can click on any date on the calendar to see the others. The items are organized by date. The layout is similar to that of most Building Blocks/Features. The Banner images pull randomly from any of the items on that calendar date with a calendar on the left side of the Banner.

The user can click on the date image and they will be taken to the large image view for the item.

There is an interactive Timeline that contains all items on the page.

A key Map View (only shows items with locations), which takes the user to the large Map View.

In This Month 59—This type 2 collection has In This Month items laid out on pages sorted by calendar months. The user can click on any month on the calendar to see the others. The items are organized by date. The layout is similar to that of most Building Blocks/Features. The Banner images pull randomly from any of the items on that calendar month with a calendar on the left side of the Banner.

The user can click on the date image and they will be taken to the large image view for the item.

There is an interactive Timeline that contains all items on the page.

A key Map View (only shows items with locations), which takes the user to the large Map View.

In This Year 59—This type 2 collection has In This Year items laid out on pages sorted by calendar years. The user can click on any year on the calendar to see the others. The items are organized by date. The layout is similar to that of most Building Blocks/Features. The Banner images pull randomly from any of the items on that calendar year with a calendar on the left side of the Banner.

The user can click on the date image and they will be taken to the large image view for the item.

There is an interactive Timeline that contains all items on the page.

A key Map View (only shows items with locations), which takes the user to the large Map View.

In This Photo 57—This type 2 collection has images with In This Photo Tags laid out on pages sorted alphabetically. The layout is similar to that of most Building Blocks/Features. The Banner images pull randomly from any of the items on that collection.

The user can click on the thumbnails and they will be taken to the large image view for the item.

There is an interactive Timeline that contains all items on the page that have dates.

A key Map View (only shows items with locations), which takes the user to the large Map View.

Then & Now Images 65—This type 2 collection of Then and Now Images. The layout is similar to that of most Building Blocks/Features. The Banner images pull randomly from any of the items on that collection.

The user can click on the thumbnails and they will be taken to the large image view for the item.

There is an interactive Timeline that contains all items on the page that have dates.

A key Map View (only shows items with locations), which takes the user to the large Map View.

We also have 7 other collections: Upcoming Events, Past Events, Exhibitions, Recurring Events (Event Series), Tours, Recipes, and Images, which are accessed from different sections of the navigation menu. The layout and user interaction is similar to the layouts of the collections above.

Frontend UI

Website

The user has the option to sort each of the collections by name, type, location, date, or person or to filter them. As shown in FIG. 13, there are three views that are available.

List View 313 is the default view in which a user sees rows of content, where each row is filtered for a grid view of thumbnails of each site or person with some information, year, title, architect, city, type of building, and any attached media.

Grid View 307 is another way of seeing collection content. It displays a series of thumbnails with limited information.

Map View 315 shows the collection as a list of items on the left side with each row called out, with “show more” and “show less” arrows. It resembles the search. If there are relevant historic maps, they will appear pinned to the bottom of the screen. Tours, Events, Event Series, and other Related Sites will appear as markers on the Map (see Map View 81 under User Features).

Preview Pop-up 341 appears when a user clicks on the preview icon on any thumbnail in the List view. It shows basic information about the Building Block or Feature. The rest of the Collection page is grayed out. From the preview, the user can go to the main item page, or go back to the Collection page. The user will click anywhere outside the pop-up window to close the preview pop-up.

Playlist 51 refers to an automated playlist that is created for each collection (see Playlist FIG. 12).

Relationship Mapping 63 (see Relationship Mapping see FIG. 20A, 20B, 20C, 20D).

Each collection and each row within each collection has various Sort By 273 and Filter 187 options for the user. Both vary depending on what is pertinent to each collection. Possible row and collection Sort By options: title, type, location, date, person, category, theme, etc. Possible collection filters options: type, people (individuals/organizations/animals/publications), podcasts, tours, events, cultural landmarks, historic buildings, unbuilt, dates, location, designations, awards, public tags, themes

App

The collections are shown in the collections menu which appears on the discover button. The user will click on the collection and then be taken to a rolling screen where there are two images to represent each row. The user will need to click on each row to see all of the content. List, Filter, and Map tabs along with the option to sort allow for a more tailored search. The typical filters are similar to the website where the user can check which types of items would be visible, each with options slightly different for sites, people, events, tours, and podcasts.

In the Calendar button, for On This Day, there is a timeline, a grid view, a list view, and a Map View available, to streamline the collections

Curated Feature:

Home Page

FIG. 14

Definition

A dynamic, ever-updating landing page (on both the website and app) that draws on data from the entire platform to provide the user with interesting time, location, and person-based stories and content. The page changes daily, with a few of its elements changing every time the user refreshes their screen. It is similar in both web and mobile applications, with slight variations. On the mobile app, a user will have the option of finding out what is near them.

Content Management System

Like the changing collections in a museum, the Home Page has been designed to allow the curator to change its components daily to reflect themes such as resiliency or climate change, highlight the event calendar ‘Christmas’ or Archtober (architecture month in New York), commemorate an event, a person, a tour, or what's newly added. Each special feature available is showcased on the front page. There are filters for them to be selected. If there is nothing to highlight, the site will revert to a random sequence of featured items.

The content management system for the Home Page (see FIG. 14) is organized somewhat differently than the other sections and should be considered a ‘teaser’ where the user is given a taste of what is in the main collection.

Each Feature can be set for a single date or a date range. They can be done as a group or independently. For instance, a date range might be appropriate for a film festival where the curator can set the items that will appear for the entire festival and then highlight different programs or films that will premiere on different days to feature on the specific date of the event. Similarly, Archtober would be featured during the entire month of October. One of the signature features of Archtober is the ‘Buildings of the Day’. These sites would be set to appear as featured buildings on the appropriate day. Of course, the people connected with the sites (their architects, landscape architects, clients, and photographers) could also be featured with additional material such as image albums for the photographers, and podcasts by the architects. Every day there are different tours and programs that could be highlighted.

Site of the Day 443 is the main building block for the website and app. It will be run in a carousel where the curator could choose Sites 21, People 17, Events 11, Tours 53, Maps 15, Podcasts 19, Playlists 51, Event Series 47, and Special Features 22. In order to do this, the curator can select from the List View and choose a thumbnail for the Image if there is more than one header image available. The curator can also caption each featured selected item to explain why this item has been selected. They can highlight why a building has been chosen as the building of the day, which would only be interesting to audiences that day. When a Curator selects any of the items above as the Item ‘of the Day’, the remaining items (Building Blocks, Features) on the Home Page are selected based on their relationship to the main item, if available. If no related items are available, then the other items are selected randomly by the platform. The curator always has the option to override any of the preselected choices. Every one of the featured items will be actionable; clicking on it will send the user to the appropriate page.

Featured for Collections 391 The curator can select a hashtag 33, People 17, Event 11, Tour 53, and all content relevant to both the selected item and relevant to the Collections will show up on the ‘Featured’ first row of the Type 1 Collection 973.

About the MuseumWithoutWalls 349 contains a description of the virtual museum in a text field 471.

On This Day 415 preselects all the date events from People, Sites, and Events and Stories that happened today. Then the curator may choose not to highlight them. This feature can also be accessed from Site and People pages. Similarly, the curator may decide to adjust the description which will come from the Site description to better describe the relevance of the event and story. The action button will send the user to the ‘On This Day’ Site page. The images will cycle on a carousel. Refer to On This Day (FIG. 17) for more information.

In This Photo 403 draws from the images where any of the featured ‘Site of the Day’ items are tagged 13, 57. Again, the curator has the option to recaption the image if needed to better describe it. The curator can assign an image to this section if nothing is available or if the random image is not appropriate. The items will cycle on a carousel. The action button will send the user to the ‘In This Photo’ Collection. Refer to In This Photo (FIG. 19) for more information.

Then and Now Images 451 highlights ‘Then and Now’ sliders 65. If they are linked somehow to the featured ‘Site of the Day’ or ‘On This Day’ items, they will appear first. If nothing is available, they will be random. The curator will have the option to recaption them if needed. They will play on a carousel. On click, the user will go to the site. Refer to Then and Now Images (FIG. 18) for more information.

What Happened Here 463 highlights the Sites that are Events and Stories Category 21 on a carousel. If they are linked somehow to the featured ‘Site of the Day’ or ‘On this Day’ items, they will appear first. If nothing is available they will be random. The curator will have the option to recaption them if needed. On click, the user will go to the site. Refer to What Happened Here (FIG. 15) for more information.

The cultureNOW Collection highlights the main collections. The curator has the option of selecting which ones to feature on the Home Page. On the front page Public Art 433, Built Environment 365, History 397, People 421, and Podcast 431 collections are highlighted. The curator can select the two sites which will be featured. Items can be dragged and dropped or selected from the list view. The front page also has some statistics for each collection (how many sites) where most of them are located and the media (podcasts) and tours that will change depending on what the curator selects. The text can be modified as needed. The action buttons on these pages will send the users to the relevant collection pages.

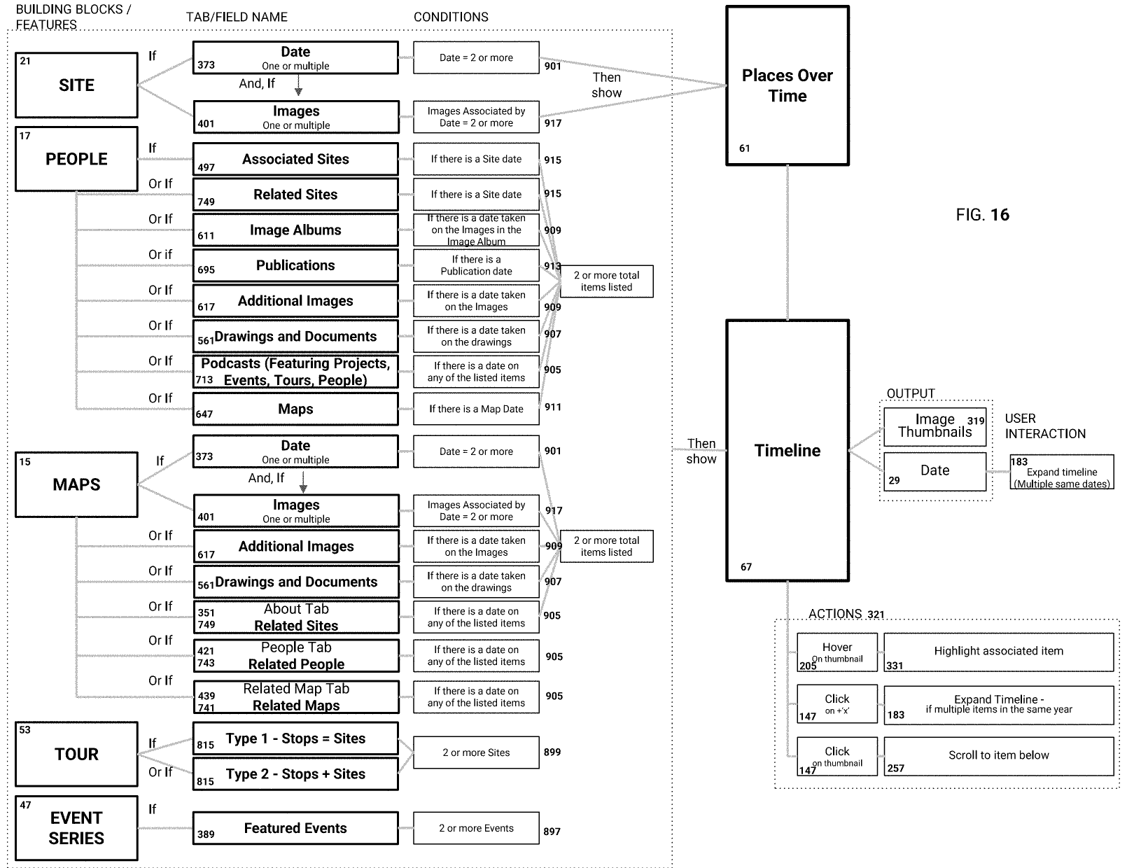

Places Over Time 425 shows one of the Places over Time timelines. It will be chosen by the ‘Site of the Day’ featured item. If nothing is available, it will be populated from the Architecture Collection sites that are featured. If nothing has a timeline, then it will be chosen randomly. What will show on the frontend is the timeline. Refer to Places Over Time (FIG. 16) for more information.

Attach Maps 359 highlights the maps. The image for the maps will be chosen from the Map collection. The curator can select one map from the add a maps list page and adjust the description if needed. Refer to Add a Map (FIG. 8A) for more information.

Tours 457 Features tours that are selected by the curator. The description can be modified. Refer to Tours (FIG. 11) for more information.

Upcoming Events 461 automatically populates with Events near the user's location. They are chronologically organized, but the curator can override the chronological order and highlight or remove certain Events. Refer to Events (FIG. 9) for more information.

Near Me/What's Around Me 465 shows the user items near them. The CMS section is designed for the user who has not provided access to their location information on their mobile phone and will provide default Building Blocks 9 and Features 41. The curator can select which georeferenced map they want the user to see. Two map windows move parallelly, one window shows a georeferenced map and the second is a current map. Both windows will have geotagged markers for the site visible below.

Relationship Mapping 441 is an interactive map feature showing the relationship map for the featured Item of the Day (Site, Person, Tour, Event, etc.) if available. If not, then the platform will select a Site randomly, or the curator can override and select one. Refer to Relationship Mapping (FIG. 20) for more information.

Static Images 449 can be changed and the text can be edited by the curator. For the following sections at the end of the page: Image Search for App 615, Curate Your Own Collection 545, Contribute Content 531, Join The Community 631, and Donate 559.

Frontend UI

Website

The Home Page will refresh daily, highlighting major components. The website user interface has a couple of special features. It is fully responsive. The menu bar highlights the static pages, collections, calendar, explore, and user accounts.

App

The Home Page of the App is very similar to the Home Page on the website. However, the app view is a little different to reflect the available real estate. A person using their phone will have the option of finding out what is near to them and to search for buildings, artwork, and even street views that they might want to find out more about by simply snapping a photo on the camera and querying it.

Special Curated Feature:

What Happened Here

FIG. 15

Definition

Since every Site is geotagged, the platform can display the Events and Stories, Site category, and the places where they occurred or places nearby. The feature attaches historic or recent events to the places where they occurred. A Site which has an Events and Stories category (primary or secondary) comes under the What Happened Here section.

Content Management System

FIG. 15 outlines data input and management that shape the What Happened Here feature output. If the Category 27 of a Site is set to Events and Stories (primary or secondary) under Add a Site 21, then the What Happened Here field appears with the On This Day/In This Photo 417 tab. Within the What Happened Here 69 section, the What Happened Here Editor 177 programmatically populates with the following elements. The Image 401 field is populated by the Site Banner Image 379 by default, which the curator can override and edit 171 with any other image from the Site. The curator can make the content live/not live 337, preview 217 it on the frontend, and view the Live Preview Panel while editing the content.

The Caption 515 is Populated by the first Site date 373 (month, day, year) in bold font, the Site Title 797 in bold font, and the Site Description 471 in regular font, within the same text box by default. The Curator has two actions 321 available to them with respect to the caption 515. The curator can override and edit 517 the text. Once the text is edited, if the curator wants to go back to the original default content in the caption 515, he can click on Refresh 249.

Frontend UI

Website

All What Happened Here items show up under the Collection 45 called Events and Stories 69. On the Home Page 49 (see FIG. 14), the highlighted What Happened Here (single or multiple) events of the day are displayed. If a user clicks on any of the What Happened Here items on the above two pages, the Large Image View opens where they can see additional details. The selected image is supported with the edited caption below in the gray section. Other items on the page are typical to the Large Image view.

App

All What Happened Here items show up under the Discover 939 (see FIG. 13) section called Events and Stories. On the Home Page and the What Happened Here pages, it is the same as the website.

Features:

Timeline

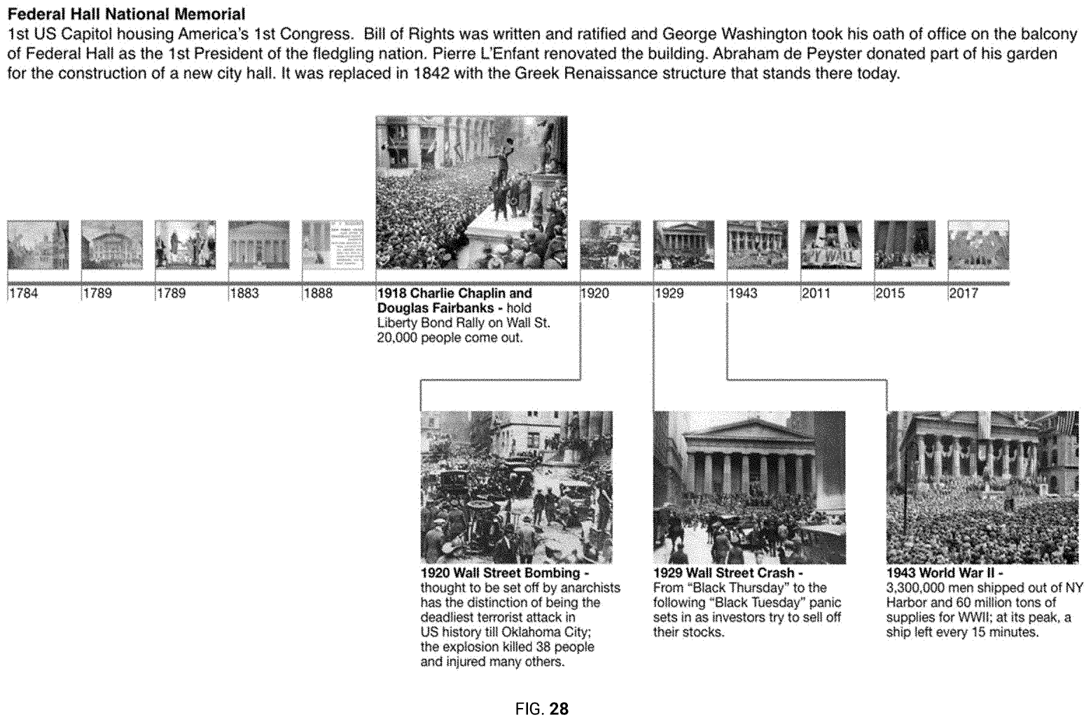

FIG. 16, FIG. 28

Definition

This feature utilizes the date field to create a timeline 67. All Sites, Peoples, Maps, Tours, and Event Series with more than one date meet the relevant conditions listed below under the Content Management System section and will have a timeline. On Sites, this is referred to as Places Over Time 61 (see Places Over Time FIG. 16).

Content Management System

FIG. 16 maps out the conditions for establishing a timeline on various Building Block and Features pages.

Within Sites 21, timelines are created when: 2 or more dates 901 are entered in the Date 373 tab, and one or more images by date 917 are associated with 2 or more dates in the Image 401 tab. Additional information that can be linked to the date timeline includes: the Category tab, with Category, Sub Category, Program/Type by date; the Location tab, with Addresses by date; the People tab, with People by date; the Description tab, with Description by date; the Podcasts tab, with Podcasts by date; the Awards & Designations tab, with Awards by date and Designations by date; and the Attach Map tab, with Maps by date. (See Site FIG. 16 for more details).

Within People 17, timelines are created when: there are one or more sites with dates 915 within the Associated Sites 497 or Related Sites 749 tab; there are one or more images with dates 909 under Image Albums 611; there are one or more publications with dates 913 under Publications 695; there are one or more items with dates 905 under Podcasts (Featuring Projects, Events, Tours, and People) 713; there are one or more drawings with dates taken 907 under the Drawings section of the Drawings and Documents 561 tab; there are one or more images with dates taken 909 under the Additional Images 617 tab; or there are one or more maps with dates 911 under the Maps 647 tab.

Within Maps 15, timelines are created when: 2 or more dates 901 are entered in the Date 373 tab, and one or more images by date 917 are associated with 2 or more dates in the Image 401 tab. Additional conditions include: if Additional Images 617 have ‘Date Taken’ 909 with ‘Show Date’ checkbox selected; or if Drawings and Documents 561 have ‘Date Taken’ 907 with ‘Show Date’ checkbox selected; or if Related Sites 749, within the About tab 351, have a ‘Date Event’ 905; or if Related People 743, within the People tab 421, have a ‘Date Event’ 905; or if Related Maps 741, within the Related Map Tab 439, have a ‘Date Event’ 905.

Within Tours 53, timelines are created for a Type 1—Stops=Sites 815 Tour when it has 2 or more Sites with dates 899, and for a Type 2—Stops+Sites 815 Tour when it has 2 or more Sites (within any Stop) with dates 899.

Within Event Series 47, timelines are created when there is more than one Event 897 under Featured Events 389 (note: all events have dates).

Frontend UI

Website

FIG. 28

Sites, People, Maps, Tours, and Event Series all have similar timelines. If the above CMS conditions are met, a scrollable timeline shows up by default on the respective frontend. A thumbnail image for each date, with the year underneath, is visible in a horizontal format chronologically organized. If there are more things than will fit in the visible browser screen, an arrow is visible on the ends to indicate to the user they can scroll the timeline. If there is more than 1 item in one year, show one thumbnail randomly with a ‘+x’ (x=number of items in that year) below.

The frontend user can interact with the Timeline 67 with the following Actions 321: On Hover 205 all items, except the relevant associated items to the timeline thumbnail, would become 35% transparent, highlighting the remaining items 331. ‘Clicking 147 on +x’ will be visible only if there are multiple items in that year. The timeline expands horizontally to show all items in that year 183. Clicking 147 on the Thumbnail will scroll down to the relevant item on the right side of the page below 257.

App

The default view on the mobile app for Sites, People, Maps, Tours, and Event Series will have a timeline visible under the banner image, title, and address. When clicking on any of the other tabs (like About, Images, Media, Map, Recipes, Tour Stops, Featured Events, etc.) for these items, the screen scrolls up to where the Timeline is visible under the title. The timeline can be pushed up to hide/minimized for smaller phone screens.

Features:

Places Over Time

FIG. 16, FIG. 28

Definitions

The Places Over Time 61 feature showcases all Sites that have a timeline (see Timeline 67 under Special Curated Features and refer to FIGS. 16 and 28). This appears on any Site that has more than one date, utilizing the “Images by date” field to create a timeline. The curator can also set “Description by date”, “Associated People by date”, “Category by date”, “Location by date”, “Awards by date”, “Designation by date”, “Maps by date”, “Podcasts by date”.

Content Management System

The CMS structure for Sites 21 can be found in FIG. 3B, which contains Date 373 and Image 401 tabs. Other relevant tabs populate the timeline with more items.

Website

FIG. 28

Under Collections 45 (see FIG. 13), all Places Over Time items show up under the Collection of the same name 61. On the Home Page 49 (see FIG. 14), the highlighted Places Over Time 425 Sites 21 (single or multiple) of the Day appear. Clicking on any of the Places Over Time 61 items on the above two pages takes the user to the typical Site page with a Timeline 67 where they can see additional details for the item.

App

Under Discover 939, all Places Over Time 61 items show up under the Discover section of the same name 61. On the Home Page 49 (see FIG. 14) and the Places Over Time 425 Site pages 21, it is the same as the website.

Features:

On this Day/in this Month/in this Year

FIG. 17

Definitions

This feature shows milestone date events occurring on a specific day, month, or year. On This Day/In This Month/In This Year pulls from Site, People, Maps, Events, and Tours.

Content Management System

Data for the On This Day/In This Month/In This Year Feature is pulled from typical CMS fields under Site, People, Maps, Events, and Tours listed below. The milestone conditions, along with image and caption outputs for creating this feature are listed below and outlined in FIG. 17.

The possible SITE 21 milestone conditions include the Date 373 tab, where a Site is allocated more than one date 891; or under the Description 351 tab, if a Site is allocated one or more Factoids with dates 893; or under the Awards 505 and Designations 555 fields, if a Site is allocated one or more Awards with dates 889 or one or more Designations with dates 895. Regarding Images for Sites, Dates under the Date tab pull from the first image associated by date, then the Site Banner if not available 919; Factoids under the Description tab pull the Site Banner 509; Awards under the Awards and Designations tab pull the Site Banner 509 and Designations pull the Site Banner 509. Regarding Captions 515 for Sites, Dates under the Date tab appear as ‘Date—Title (Site Title)—Milestone (What happened)—Description (Remarks)’; Factoids under the Description tab appear as ‘Date (Factoid Date)—Title (Site Title)—Description (Factoid here*remarks)’; Awards under the Awards and Designations tab appear as ‘Date (Award Date)—Title (Site Title)—Milestone (Award Name)—Description (Award Remarks)’, while Designations appear as ‘Date (Designation Date)—Title (Site Title) - Milestone (Designation Name)—Description (Designation Remarks)’.

The possible PEOPLE 17 milestone conditions include the Date 373 tab, where People are allocated more than one date 891; or under the About 351 tab, if People are allocated one or more Factoids with dates 893; or under the Awards 505 and Highlights 519 fields, if People are allocated one or more Awards (all) with dates 889, or one or more Career Highlights (Individuals) or Highlights (Organizations/Publications/Animals) with dates 895. Images for People (Headshot/Logo/Book Cover for all) 597 connect with Dates under the Date tab; Factoids under the About tab; and Awards (all), Career Highlights (Individuals), and Highlights (Organizations/Publications/Animals) under the Awards and Highlights tab. Regarding Captions 515 for People, Dates under the Date tab appear as ‘Date (Site Date)—Title (Site Title)—Milestone (What happened)—Description (Remarks)’; Factoids under the About tab appear as ‘Date (Highlight Date)—Title (Site Title)—Description (Highlight*remarks)’; and Awards (all) under the Awards and Highlights tab appear as ‘Date (Award Date)—Title (Site Title)—Milestone (Award Name)—Description (Award Remarks)’, while Career Highlights (Individuals) and Highlights (Organizations/Publications/Animals) appear as ‘Date (Designation Date)—Title (Site Title)—Milestone (Designation Name)—Description (Designation Remarks)’.

The possible MAP 15 milestone conditions include the Date 373 tab, where a Map is allocated more than one date 891; or under the About 351 tab, if a Map is allocated one or more Factoids with dates 893. Regarding Images for Maps, Dates under the Date tab pull from the first image associated by date, then the Map Banner if not available 919; and Factoids under the About tab pull the Map Banner 509. Regarding Captions 515 for Maps, Dates under the Date tab appear as ‘Date (Month Day, Year)—Title (Event Title)—Description (Date Remarks)’; and Factoids under the About tab appear as ‘Date (Factoids Month Day, Year)—Title (Event Title)—About (Factoids remarks)’.

The possible EVENT 11 milestone conditions include the Date 373 tab, where an Event is allocated more than one date 891; or under the About 351 tab, if an Event is allocated one or more Highlights with dates 895. Regarding Images for Events, Dates under the Date tab pull from the first image associated by date, then the Event Banner if not available 919; Highlights under the About tab pull the Event Banner 509. Regarding Captions 515 for Events, Dates under the Date tab appear as ‘Date (Month Day, Year)—Title (Event Title)—Description (Date Remarks)’; and Factoids under the About tab appear as ‘Date (Highlights Month Day, Year)—Title (Event Title)—About (Highlights remarks)’.

The possible TOUR 53 milestone conditions include the About 351 tab, if a Tour is allocated one or more Factoids with dates 893. Regarding Images for Tours, Factoids under the About tab pull the Tour Banner 509. Regarding Captions 515 for Tours, Factoids under the About tab appear as ‘Date (Month Day, Year)—Title (Site Title)—Milestone (What happened)—Description (Remarks)’.

See information about the Live Preview Panel 217 under the Content Management System description.

Website

Under Collections 45, all On This Day/In This Month/In This Year items show up under the Collection of the same name 59, showing a Date 373, Name/Title 797, Milestone 655, and Description 471. On the Home Page 49, (see FIG. 14) the highlighted On This Day/In This Month/In This Year (single or multiple) of the Day appear. Clicking on any of the On This Day/In This Month/In This Year items on the above two pages takes the user to the Large Image View 311 where they can see additional details for the feature page (refer to Images). The selected image is supported with the edited caption below in the grey section. Other items on the page are typical of the Large Image View. The only difference in the conditions between On This Day/In This Month/In This Year collections is that under the Date field 373, the first picks up all items that have at least Day 553 specified. The second needs Month 657 to be specified. The third needs Year 827 to be specified. But on the frontend, It will show all three—Day 553, Month 657, and Year 827, where available.

App

Under Discover 939, all On This Day/In This Month/In This Year items show up under the Discover section of the same name. On the Home Page 49 and the On This Day/In This Month/In This Year pages, it is the same as the web site.

Features:

Then and Now Images

FIG. 18, FIG. 26

Definitions

A ‘Then and Now’ image 65 slider shows how a place has changed over time (i.e. a cityscape) by comparing images taken from the same place across different dates. The Then and Now images can be standalone or be connected to any Building Block (Site, People, Maps, Events, Podcasts) or Features (Event Series, Playlist, or Tours). The platform can link unlimited images to the Then and Now Image slider.

Content Management System

To create a Then and Now Image Slider, a Curator can either add new Images or add Images already in the database 445 to a Then and Now slider. Curators can create the Then and Now image slider from two places:

1. The user can add a Then and Now Image from the Image CMS Backend table 297. The user can create a new slider image from new Images or from Images already in the database.

2. The user can also add a Then and Now Image Slider from the Then and Now section under the In This Photo/On This Day tab 417 on the Building Block or Feature CMS edit screen (See FIG. 21C).

Then and Now Image Editor

On the backend, a curator uploads two or more images of the same place, that are taken from the same position or manipulated to match as closely as possible. FIG. 18 displays the CMS workflow for how to modify a Then and Now Image 167.

This begins with the Edit Image Information 381 Tab, where the curator enters preliminary information about the media—writing a caption 515 and description 351, both entered as text fields. Captions are created by default as a summary of the attached individual image captions and descriptions, and can be overridden/edited here.

All individual Images added to the Then and Now Image are listed in Slider Images 445. The individual ‘Image Caption’ is visible here. If there is no individual Image Caption, the field will say ‘Image 1’ and so on. Users also have the ability to add 117 or delete 324 individual images here, if needed. The user can also click on the ‘Edit’ button 327 to edit the metadata for the individual image. The order of images from left to right can be reordered here.

The user will be asked if they want to add pre-existing Then and Now images to the Building Block or Feature, or if they want to create a new Then and Now Image 445. The user can also add individual images to the Then and Now Editor from the related items (Building Blocks/features) 127 or add a new image from the Computer, iPad, or Phone 129, or add an image from the cultureNOW Database 131. Unless the images are added from the related item image tab, they get added to the Building Block or Feature current or additional Image section. For the Then and Now Image Metadata: Photo Credits, Date Taken, Hashtags, and Alt Text are pulled by default from the individual slider Images and are not visible on the Then and Now Image Editor.

The Related Items 437 tab pulls from the main Images by default. The user can remove or add more items here. Related items can include: Sites 749, People 743, Events 579, Tours 811, and Special Features 733 (recipes, construction documents, instruction manuals). Refer to the Related Items tab in Images (FIG. 5B, 437).

The In This Photo 403 tab pulls from the main Images by default. The user can remove or add more items here. This feature allows users to tag Sites 21 and People 17 in Images. Refer to the In This Photo tab in Images (FIG. 5B, 403).

In the Edit Thumbnail 383 section, the thumbnail is created by default, centered on the image. Curators can preview and adjust the way an image will appear as a thumbnail. The image cropper is fixed in a 1.25:1 ratio 541, which the user can scale and/or move around to capture the desired portion of the image for display.

In the Edit Banner 379 section, curators can preview and adjust the way an image will appear as a banner. The image cropper is fixed in a 3.2:1 ratio 543, which the user can scale and/or move around to capture the desired portion of the image for display.

See information about the Live Preview Panel 217 under the Content Management System description.

Within the image editor, users have the option to replace 345 the individual slider images with other images, download 325 the slider image to their device, preview 341 the slider image frontend display page on the large image view, save 347 changes made in the editor, and edit the slider 175 image overlays by cropping 151, rotating 253, zooming into or out of 293, moving 233, or mirroring it 227.

Website

As shown in FIG. 18, highlighted Then and Now Images (single or multiple) 65 can be accessed from the Home Page 49 in a carousel. Then and Now Images also show up under Type 1 Collections 45 rows filtered for content relevant to the individual Collections. All Then and Now Images also show up under a Type 2 Collection of the same name, the Then and Now Collection 1023. They also show up on Building Block 9 and Feature pages 41.

Clicking on any of the Then and Now Images takes the user to the Large Image View 311 (See FIG. 26) The selected image is supported with an edited caption below in the gray section. Other items on the page are typical of the Large Image View. An image slider overlays the Images. Users can manipulate the slider from left to right to visualize the changes. All User Views 295 relevant to Images on the Large Image View apply to the Then and Now Image including Thumbnail 319, Banner 299, Full Screen View 305, and Deep Zoom 301 View. If there is a Then and Now Image linked to any Building Block (Site, People, Maps, or Events) or Feature (Event Series, Playlist, or Tours) on Building Block 9/Feature 41 Pages, the Then and Now image shows at the end of the item page—on the right side at the bottom of the page, under the In This Photo section. The Images used to make a Then and Now Image slider are linked to the composited Image, and their captions (linked to the final image) are made available from the Large Image View. If the Then and Now Image is linked to a Podcast, it becomes the banner of that Podcast.

App

Under Discover, 939 all Then and Now Images show up under the Discover section of the same name. The Home Page 49, Then and Now Image 65 pages, and Building Block 9/Feature 41 pages are the same as the website.

Features:

In this Photo

FIG. 19, FIG. 26

Definitions

The In This Photo 57 feature allows for image tagging and labeling in all images, including Images (photographs), 617 and Drawings and Documents 561. The labels are clickable and connect users to linked Site 21 or People 17 pages. Curators can tag People and places in images. One Image can have multiple different tags within them. The feature is used in four main ways, to tag: People and places within a photo or drawing of a scene (both historic and recent), buildings within a cityscape or aerial photo, details in a document or drawing (such as an architectural plan), or a portion of the text within a book.

Content Management System

FIG. 19

From the Edit an Image/Drawing/Document 169 screens, the user can access the edit Image tags 173 screen by clicking on the ‘+Add one’ button on the ‘In This Photo’ 403 tab. All tags on the Image get listed in this section. In the Edit Image Tag 173 screen, the user can click to draw a rectangle around the desired portion of the image over the Site/Person to be tagged 149; the box can be resized if necessary. A two-level dropdown appears 107. In the first dropdown, the user selects Site 21 or People 17. The second list updates accordingly with a list of Site titles or Person names which can be selected 265 by the curator. The user can click on the accept button 323 to create the tag 279. Clicking the remove button 343 removes the tagged item 281. Multiple tags can be added in the same way to one image 145.

After an image is tagged, the platform shows the user suggestions of similar images for items tagged on the previous image 271. The user can select the ones which are correct or make changes to individual suggested images. This makes it easier for the user to tag additional images on the platform, making the curation process easier, and image recognition faster and more efficient. On the Edit an Image/Drawing/Document 169 screen shows the tags in the Live Preview Panel 217 (See Live Preview Panel under Content Management System FIG. 21C).

Website

All images that have a tag 139 items show up as a group listed under a Type 2 Collection 45 of the same name, In This Photo Collection 964. On the Home Page 49, the highlighted In This Photo (single or multiple) of the Day 403 appears. Under Building Block 9 and Feature 51 pages, if one or more images on the page have a tag 139, the tagged Sites and People show up grouped together under the heading of In This Photo 269. Clicking 147 on any of the In This Photo items on the above three pages takes the user to the Large Image View 311 (See FIG. 26) where they can see additional details for the In This Photo page. The selected image is supported with an edited caption below the image. Most items on the page are typical to the Large Image view, except that there is an additional action button 321 to turn the labels On/Off 335, and the tagged item's names are visible on the base image 291 as well as under the image caption below the image 283. Hovering 205 on the tags shows the rectangular box 263 drawn on the CMS. Clicking 147 on the tag names takes you to the tagged Site 21 or People 17 pages to see more details about it/them.

App

Under Discover, 939 all In This Photo items show up under the Discover section of the same name. The Home Page, 49 Building Block 9 and Feature 41 pages, and In This Photo large image view 311 pages are the same as the website, except there is no Hover 205 feature available.

Features:

Relationship Mapping

FIG. 20A, FIG. 20B, FIG. 20C, FIG. 20D, FIG. 23A, FIG. 23B

Definitions

Relationship Maps are visualizations on the cultureNOW platform, displaying hierarchical relationships 751 in a dynamic, visual format showing links between various items. Relationship Mapping Visualizations and Network Maps provide the cultureNOW user with a holistic view of the database and its relation to a selected item, a user's search query (with the primary search query as the focus), or a Collection. The Relationship Mapping Visualization 869 (See FIG. 23A) can be georeferenced and overlaid on a global basemap, or the mapping can be visualized as a Network Diagram 861 (See FIG. 23B).

Linking is one of the major features of the platform, connecting Building Blocks and Features that are similar (i.e. Sites to Sites) or different (i.e. Sites to People), as well as the degrees of their relationships. It offers multiple curatorial possibilities for linking through various Elements. Items are linked across 4 Tiers 829 as listed below.

Tier 1 Relationship: Two items directly affiliated or credited or linked by location.

Tier 2 Relationship: Two items indirectly related to each other.

Tier 3 Relationship: Two items indirectly and coincidentally related to each other.

Tier 4 Relationship: Two items in the same image tagged under ‘In This Photo’, a peripheral relationship.

Content Management System

Relationship Mapping Visualization Details 885 for a Single Item 875

As shown in FIG. 20A, The Content Management System has a Relationship Mapping tab 441 section where the curator can confirm linked relationships, adjust their hierarchy, or remove items from the visualization. On the CMS for each Building Block and Feature, the 4 tiers 829 are listed in individual sections programmatically based on default conditions as described above. The Curator can see details of each item and a preview of the visualization of the Relationship Mapping in the Live Preview Panel 217. They can confirm relationships, change their tier position (reorder) of relevance/importance/strength, or remove from Relationship Map Visualizations 869 to adjust hierarchies that shape the way these visualizations appear. Removed items are still visible to the curator at the bottom of the CMS page under the section ‘Remove from Visualization’, and can be brought back to the main sections. This does not impact the original data structure, only the Relationship Mapping Visualizations appear to a frontend user as shown in FIG. 23A. The relationship hierarchy 751 between Site and People is specified below (see FIG. 20D). Relationships between other Building Blocks 9 (Site, People, Images, Podcasts, Maps, Events) and Features 41 (Event Series, Playlists, Tours, etc.) are also visualized with the Elements 23 (Date, Time, Hashtags, Theme, Category, Description, Location, etc.) as supporting data. They will have a similar CMS interface, relationship hierarchy, and visual output of the Relationship Mapping.

As shown in FIG. 20D, there are 4 tiers 829 for connecting SITE (S1) 877 to SITE (S2) 879. In Tier 1, either S1 and S2 are Associated Sites at that Location 499 (sites directly linked to another site by location), or S1 is an Associated Site at that location to S2 499+S2 is a Related Site 749 to S1. In Tier 2, S1 and S2 are Related Sites 749, and are therefore indirectly related to each other. In Tier 3, S1 and S2 are Factoids (Link-Related Sites) 585, where a site is indirectly and coincidentally related to another site. In Tier 4, S1 and S2 are Sites tagged on the same image under ‘In This Photo’, 621 which is a peripheral relationship.

Similarly, there are 4 tiers 829 for connecting SITE (51) 877 to PEOPLE (Person/Organization/Publication/Animal) (P1) 865. In Tier 1, P1 is directly credited to S1 695 so that the S1 becomes an Associated Site 497 to P1. In Tier 2, S1 is a Related Site 749 to P1 who is a Related Person 743 on S1. In Tier 3, linked through Factoid, S1 is a Factoid (Link-Related Sites) to P1 and P1 is a Factoid (Link-Related Person) to S1 585, or S1 is a (Link-Related Site) to P1 on a Career Highlight 519 and P1 is linked through Related People to S1 743. In Tier 4, S1 Site and P1 Person are tagged on the same image under ‘In This Photo’ 621.

The 4 tiers 829 for connecting PEOPLE (P1) 865 to PEOPLE (P2) 867 follow. In Tier 1, either P1 and P2 are Affiliated People 353, a Person is directly linked to another Person, or P1 and P2 are Career Highlights (Link-Related People) 519. In Tier 2, P1 and P2 are Related People 743 where a Person is indirectly related to another Person. In Tier 3, P1 and P2 are linked through Factoids (Link-Related People) 585. In Tier 4, P1 and P2 are People tagged on the same image under ‘In This Photo’ 621.

Frontend UI

Website

FIG. 20A maps out the data organization within Relationship Mapping, 63 which can be visualized for a single item 875, a word (keyword searcher), or a Collection 45. Users can transition between the Map View 81 and the Relationship Mapping Visualization 869 with the click of a button.

Visualizing Details 885 of a Single Item 875—On the dashboard, the user will be able to view and sift through various relationship hierarchies 751 as well as different degrees of separation 845 between the selected item (Building Block or Feature) and the related/associated people, places and events 833. The Degrees of Separation 845, FIG. 20B can be defined by the filter 187 available on the Relationship Mapping Map View FIG. 23A. The 4 tiers 829 link to an item (Parent) 863, and are defined as the first-degree connection to the item. The 4 tier links connected to any of the first-degree items become the second-degree to the Parent (original item). And so on. The relationship connection strength decreases as the Degree of Separation 845 increases. When the user clicks on a Child, 835 the sub item, it becomes the Parent 863, FIG. 20C.

Relationship Mapping 63 can be visualized on a Map 857 (Relationship Mapping Visualization 869) for all geotagged items, or as a Network Diagram 861 for things that may or may not be geotagged, (for example, a keyword searched by the user). Relationship Mapping visualizations without maps show the same data as those with maps, except that items displayed are not geotagged on a map 871.

Relationships between all the related/associated items 849 are represented by connectors 845 and graphic treatments that indicate the relationship hierarchy 751—i.e. line type 855, color 839, Line thickness 853, and transparency 883. Hovering 205 on a connector 845 shows the relationship between points in a text bubble 873. Clicking 147 on a connector zooms out/in to focus on the items on either end of the connector—either bringing them into view if they are beyond the frame or getting closer to them 887.

The relationship hierarchy 751 between the items 849 and the Parent 863 is visualized by Image size 881, color 839, and image transparency 883. The user sees the banner image 617 geotagged location 37 on the map by default 843. By hovering 205 on the item, its title 797 becomes visible. When clicking 147 on any of the items, the Child becomes the New Parent 837 and the side Information Preview Panel 847 (similar to the Map View) updates to show information about the Child instead—where the user can see the Item Banner Image 617, Name/Title 797, Address 483, Category 521, Description 471, and Podcasts 711.

Visualizing Details 885 of a Keyword Search 211—When a user searches for a keyword, the Relationship Mapping is broken down by degrees of relationship to Building Blocks, Features, and the keyword (similar to above), without geotagging items on the map 851.

Visualizing Details 885 of a Collection 45—When a user looks at the visualization of the relationships to the Collection 859, the visualization can be viewed on the map or without the map.

Filters 187—The user can filter by: Date, where the filter shows all items on the screen on the timeline, and the user can filter for items within a certain date range on a timeline filter 67; Degrees of Separation 845, where the user can filter for first, second, third, etc. degrees of separation from the Parent 863; Location (visible map area) 37; and other Elements like Category, Theme, Hashtags, Building Block Type, Feature Type, etc. 831.

Mobile App

Relationship Mapping Visualizations on the mobile app are similar to the website, just on a smaller screen. Users can transition between the Map View 315 and the Relationship Mapping Visualization 869 with the click of a button.

User Feature:

User Accounts

FIG. 21A, FIG. 21B

Original content, wherever possible, is taken from various Data Sources 241 (see FIG. 21B) like Architects, Designers, Artists, Engineers, Historians, Public Art collections, Libraries, Museum Collections, and Publications. This original content is uploaded into the Content Management System 73 by Curators for the cultureNOW collection 153.

Account Types

There are several types of Users 87 which are outlined in FIG. 21A and FIG. 21B.

Guest Users 97 are allowed to Browse 143 the Website and Mobile App. They can explore Sites, listen to Podcasts, participate in Events, and take Tours of the cultureNOW collection 153. The Map View and Directions and Navigation functions are available to them, along with Special Features (What Happened Here, Timeline, Places Over Time, On This Day/In This Month/In This Year, Then and Now, and In This Photo). They can perform Keyword Searches and can Share 267 content on Social Media.

Account Holders 89 are users who have repeated interaction with the site and create personal or organizational accounts with their email IDs. All content would be loaded one item at a time.

There are two types of Curator 93 accounts: Admin Curators and Limited Curators.

High-level Admin Curators 91 have super user backend access 277 and editing capability. They manage the cultureNOW collection 219. They can review and modify almost every component in the platform's administrative portal. They can add 119 and curate 159 (edit or filter) content out of a specific table before publishing, including adjusting all the tiered relationships between Sites, People, Dates, Media, and the written content to describe them. Admin Curators also have the ability to create Tours, Events, Event Series, Playlists, and the Home Page. To aid them, there is a continuous Live Preview, Tooltips that are attached to each of the data fields, and a Preview mode.

Limited Curator 99 accounts are designed for Collection Managers of a specific collection with Limited Backend Curation Management 215 capability. A Public Art Collection Manager, for instance, would have the ability to add 119 or curate (edit) 159 the content that is included in their collection. The site has additional collection management features to aid them (i.e. repair, accessions, notes). The Collection Manager will be able to establish relationships between People, Sites, Images, Media, and Events. There will be limited ability for these curators to link their content to items on the cultureNOW site so that it can be coordinated with the existing material and other collections. The cultureNOW Admin Curators would check and edit where required, the content very lightly to confirm that material is loaded and linked correctly, copyrights are preserved, and content is screened to prevent obviously illegal or pornographic content from being uploaded.

Portfolio 101 accounts could be for educators, businesses, or other organizations who might want to tailor the museum content for their audience and utilize the platform for more specialized material in a Private Collection 245. The whole cultureNOW collection 153 database and the relationships within it, would be available to them. They will have the ability to add links and establish relationships from their sites to any other Building Block or Feature on the platform which would be copies of the original content accessible to the general public. These would only be visible to the members of the private account. They would be able to create their own Podcasts and Sites, select whatever digital museum content is appropriate, and then publish them to their individual audiences. They access/edit/add content from the Frontend Interface V2 121, 125. Charges for these accounts would be tiered depending on the number of users accessing the platform.

For these accounts, the site would have the look and feel of the cultureNOW website Skin 155. Alternatively, another level of Portfolio account would allow the user to give an Exclusive website ‘skin’ 181 where the platform would filter the content and give it a new ‘front page’ and a different aesthetic for the individual views. This might be useful for organizations interested in having a smaller branded version of the platform which would only showcase their work that they find significant for potential clients. The account manager on that account would have the option of choosing from a limited palette of graphic choices to change the look and feel of the site, and to dress the user interface screens for the website and app so that they would be personalized. This type of account would be appropriate for an artist, architect, public art collection, or an arts/civic organization.

We have provided five examples of the Portfolio account below: An Educator, an Architecture Firm, a Public Art Collection, a Publication, or a Tour Guide.

1) An Educator (i.e. a Teacher or Professor) would be able to create content specific to their class material. They have the ability to utilize any content already on the platform to create Tours. They also have the ability to tailor the content so that it is appropriate for the class. This means that the teacher can record Podcasts and insert them into a Tour as needed. The teacher can also create pages for Sites or People that are not already in the database, as well as add Events (i.e. a class meeting). New Sites or People will remain private and only accessible to the class. In addition, the teacher can add Images and documents and drawings (including PDFs) to a Tour′. Furthermore, they can link the new content to existing Sites and People that would appear in Relationship Mapping, which would only be available to the class. They could also ‘copy’ an existing Site or Person and edit the content so that the information is germane to their lesson plan. They are able to incorporate additional information or create links that might not be appropriate for a general audience since the material would remain private. This flexibility would enable a teacher to give a class on a specific topic.

2) An Architecture Firm might want to highlight some of their work to show to potential clients. They might also want to show work that might not be appropriate for a general public audience, such as projects in development, residential projects, or offices. They might also want to highlight Sites and projects that they want their employees to review, projects that have interesting features (perhaps a new material or window), or projects that have solved similar design problems that they would use for reference. Again these could be Sites where the information they would like to show is either too specific or incomplete to publish for the general audience.

3) A Public Art Collection might want to have a branded website and app to showcase only the work in their collection. They might also want to supplement their ‘app’ with more information about the artists in their collection or their cities, and add podcasts about their programs which would be more appropriate for their local audience.

4) A website and app for a Book could be built around the publication feature of the site, which would only feature the writing from the book and the accompanying Podcasts or Videos.

5) Tour Guides could also create a visitor's tour of their ‘favorite places’ and include restaurants, stores, or watering holes that they would like to highlight.

Explorer 95 accounts mimic museum memberships and are tiered ranging from Individual to Duo, Family, and Patron accounts. They can also submit content from the Frontend Interface V1 121, 123, from the Website and App (i.e. Images, Podcasts, Sites, People, Events, Playlists, and Tours). The Explorer User has complete access to browse and search the website and the app. In addition to the features outlined above, the user will be given their own folder to house their personal collection where they are able to save Sites, People, Podcasts, Images, Events, Collections, and Maps.

Some of the common attributes shared between the Curator 93 and Portfolio Accounts 101 are Data Analytics, 549 which would be available to both users, to show who accessed the content, for how long, etc.

Some common attributes available to all frontend and backend Account Holders 89 are Browsing 143 all the content, Sharing 267 on Social Media, PDF Printing 83, and Content saving 347 for their own personal use. This saved content is available to the user under Bookmarks 140 as a list view 313/grid view 307 or on the Map view 315. Also available to all frontend users is the advanced Search 105 feature (including Image Search/Recognition 209 and Image Tagging using the In This Photo 621 feature).

Guest Users 97 cannot add content to the collection without creating an account.

User Feature:

Content Management System

FIG. 21C

Definition

The Content Management System (CMS) FIG. 21C is the ‘backend’ portal where the Curator 93 can access, edit, add to, and view the database. The CMS forms the foundation for the cultureNOW platform. The system is designed to facilitate the process of curatorship and administrative efficiency. The organization offers curators flexibility in how they enter information into the database. Functionality includes adding curatorial features, such as condition assessments and audience metrics, and coordinating copyright and image permissions.

The CMS allows for different levels of collection management, which is controlled by the User Accounts Holders. cultureNOW staff will have full access. For an individual organization, the CMS has been filtered to allow it to manage its own digital collection, either for private or public use. There is a simplified version of the CMS available which would allow individuals to add a single entry and view it from the frontend. Private content would be available immediately, while public content would need to be reviewed by cultureNOW's curators for accuracy before it can be incorporated into the larger collection.

Backend Table 297

As outlined in FIG. 21C, the CMS is divided into several ‘backends’ for various Elements 23 (Hashtags, Category, Theme, Awards, Designations, etc.), Building Blocks 9 (Sites, People, Images, Media, Events, Maps, Podcasts, Images, Special Features), Features 41 (Event Series, Playlists, Tours, Collections, Home Page, On This Day, What Happened Here, Places Over Time, Then and Now, In This Photo, etc.), wherein the curator can enter, edit, delete and view the information in a systematized, tabulated manner i.e. curate content from the CMS 159. Each backend version contains a specific form with multiple tabs and fields in different formats. These can be filled out to enter each different element of the data that would be needed to describe the features of the component. The tables have multiple columns that arrange, systematize, and catalog data points linked to entered Building Blocks. Tabulated content is filterable and searchable. The administrator can add and delete items to all of the global and collection lists.

All Elements, Building Blocks, and Features can be viewed as a Grid View 307 or a List View 313, across multiple pages. The former consists of multiple Thumbnail Images 319 with Item Name/Titles 797 below. The latter consists of a List View with buttons that allow the following Actions which have more details below 321 Edit 327, Live/Not Live 337, Preview 341, Download 325, Move 339, Delete 324; followed by various fields like Name, Location, Type, Dates, Site ID, Tags, Description, Awards and Designations/Highlights, other Related data which allow the Curator to identity items, identify missing or incorrect data on the items, and make the curation process easier. This is also the portal where the curator can search, sort, and filter.

Typical CMS Form—Tabs

Each Typical form on the Content Management System 73 follows a similar three-panel layout for all Building Blocks, Features, and Special Features. The left panel consists of tabs arranged as a ‘checklist’, each with sub-tiers, fields, and forms. This is used to navigate from one section to another by clicking on the tabs, and inform the Curator if the required information on each Tab is filled out yet. The middle panel is the primary space for content editing. The right panel contains multiple buttons for the following Actions 321 and the Live Preview 217 feature on each screen shows the curator exactly what information is being entered—helping them catch typographical errors; items that are mistagged, miscredited, or mislocated; or images that need to be reorganized. Live/Not Live 337 allows the curator to temporarily ‘hide’ the selected content from the frontend. It either makes content available or unavailable to frontend users. Content can only be made Live if the required conditions are fulfilled for each Building Block and Feature. Save 347 adds the edited content to the database. The Preview 341 button creates a frontend website/mobile app mockup for the curator. Instructions 333 are Tooltips with prompts, and suggestions relevant to the current Tab which appear on the ‘hover’ of the cursor. The Help 329 button leads the curator to instruction pop-ups relevant to that particular section of the platform, while Minimize/Maximize 225 allows for greater flexibility on the browser. There is one on the right and another on the left panel. These allow the curator to collapse the two side panels, which is useful for smaller screens.

Typically, the tabs on the left follow a standard order for data entry, beginning with The Name or Title tab 413, used to enter the name and alias, The Date Tab 377 used to add date-related information The Category Tab 367 is used to enter main and sub-categories for the subject of the page, which helps the database classify, systematize and organize the content for Collection pages. The Location Tab 407 is used to enter coordinates, draw areas or paths, and add addresses The People Tab 421 is used to link People (Person/Organization/Publication/Animal) as a first-tier link or as a secondary tier link as Related People to the main item. The About or Description Tab 351 is used to enter Descriptions 471, a text field which is descriptive of the main item. Hashtags 595 allow for additional indexed keywords that make searching and linking easier. Factoids 585 are short pieces of information that can be further linked to Related Sites or People as a third-tier relationship. Related Sites 749, which allow a 2nd tier relationship to the main item. On the Images Tab 401, the user can add, edit, delete, and organize images and drawings and documents; the user can also add images for Image Recognition for Sites and People; these images do not show up on the frontend Website and are used only for training the platform for Image Recognition The Podcasts Tab 431 is used to link Podcasts 711 and Playlists 709 to the main item. The Awards and Designations/Highlights Tab 363 are used to add Awards 505, won by Sites and People Designations 555, Landmark or sustainability status received by sites. Highlights 601 are added for Organizations, Publications, and Animals. Career Highlights 519, are added for an Individual Person. Awarding Organizations 504, for Organizations or Publications that give Award, a list of their awards also appear within organization and publication pages. The Events and Tours tab 387 is used to link Events 579, Event Series 573, Tours 811 to the main item. The Attach Maps Tab 359 inks one or more Maps 647 which are historically or descriptively related to the page, and not necessarily georeferenced. The On This Day/In This Photo tab 417 is used to enter information about the On This Day/Month/Year 673 to feature information on a defined date of significance. In This Photo 621 is used to tag Building Blocks in an Image. What Happened Here 823, which is applicable only for Sites with Events and Stories categories, shows stories that took place at a location. Then and Now Images 791 to create the overlay of two or more images with a slider interface. The Relationship Mapping tab 441 allows the user to curate—edit or delete the default relationship tiers for each item. The Meta Description tab 409 is used to enter Meta Description 651 text, Meta Keywords 653, OG Tags 671, and OG Images 669 for search-engine optimization SEO making search queries more accurate and social media ‘share’ posts The Collection Management Tab 369 has various fields to aid Collection Management for Curators. Internal Description 369, consists of Internal Description, Internal Tags, links, Remarks Attribution, Condition Report for sites, and Item of the Day. Accession 477 information shows when and who created the item, who last worked on it. Permissions 687 allows the Admin Curator to provide editing access to the item to a Limited Curator. Legal History 637, which shows a list of all submitted release forms. Data Analytics 549 is useful for Collection Management. The Legal Tab 405 is for Document Releases, Credits, and Rights for Images, Drawings, Documents, and Media through electronic authorization, digital signature, and approval forms 753.

Additional tabs can be found in certain forms, such as Associated Sites 357 which link other Sites that are at the same location.

Curator Interactions

The CMS backend involves multiple user interactions, which allow for efficient and systematic management of the collection. Static Page Content Management 275 allows the curator to determine the content and text for various Static Pages (i.e. About, Board & Staff, Partnerships, Awards, Press, Donate, Collaborate, Contact). Track Users 287 allows the curator to understand the various metrics and data analytics for the website. The Import CSV Bulk Information 79 functionality allows for uploading a large amount of information related to Sites 21, People 17, and Events 11 in a single window, making the process quick and streamlined. Data Health Check 161 is a systematic procedure building on internal and external analyses to determine the Collection's qualitative aspects. Legal History 637 creates a schedule of all the items in the database that have received permissions and rights to be displayed, and highlights the items with pending approvals. Provide Edit Access Permission to individual curators 247 allows the cultureNOW administrator to define which curator is allowed what level of CMS access, in order to ensure the quality of data uploaded.

Other Features

The Content Management System also permits individual manual adjustments to the data on every screen to accommodate curatorial needs. This is critical in order to make the content responsive to every anticipated or unforeseen condition that might arise. It allows the curator to establish links between Building Blocks, and tier them so that Relationship Mapping can be interactive. Certain action buttons are designed to assist the curatorial process. All Elements, Building Blocks, and Features are designed for accessibility. This includes a closed-captioning service for audio and video Podcasts, and the ability to adjust font sizes. Content that is deleted inadvertently by the user can be restored as well since the database auto-saves all entries in a digital ‘recycling bin’. This reduces the chances of broken links and curatorial errors. Another curatorial problem that has been addressed throughout the platform is the ability to incorporate new content into existing material. There is a ‘smart search’ feature, presented through dynamic suggestions and intuitive search results on the database.

User Feature:

Map View

Definitions

Each item page for People and Sites (places or events and stories) has a ‘Map View’ 81 that the user can access to see the location of their item of interest. Whether it's a landmark—a building, a sculpture, or the location of a historic event or a historic figure—the route of a tour, a region within a city, or sites neighboring the user's item of interest, all these can be viewed as pins, route-lines, and areas marked as polygons on an inbuilt map within the cultureNOW platform. On a Site, Person, Event, or Tour page, there is a key map on the Information Panel at the left which locates the Site, or all projects and items attached and related to a person, or items associated/related to an Event or a Tour (see FIG. 24). Once the user clicks on the Map View, the page is transformed into a large map of the area with information about Sites, People, Events, or Tours in a collapsible Information Preview Panel 847 on the left.

Any Site in the database that has a single location address is referred to as a Point location 977 on the platform and is depicted as a map marker with its name beside it. Any Site in the database that has a rectilinear quality, i.e. A Polyline Path 989, e.g. Freedom Trail, Curated Tour routes, Subway Systems, etc. is depicted as a line (dotted or otherwise) with its name beside it. Any Site in the database that covers an area is depicted as a translucent polygon area on the map 927 (e.g. Bowling Green, Foley Square, etc.) with its name beside it.

If a Site 21, whether a pin, a route, or a bounded area, has Associated Sites 499, they show up as a list under an Associated Sites tab on the Information Preview Panel 847 below the default Site description. These Sites are also seen on the map as numbered location pins corresponding to the numbers on the list on the left; the user can select any of these Associated Sites and explore nearby Sites. This also triggers a change in the mode of transport option. Hovering over one of these nearby Sites shows a probable navigation path and time (based on the selected mode of transportation).

A Nearby 237 tool, at the top of the left Information Preview Panel, shows more Sites, Tours, and Events in the vicinity of the selected item. Once clicked, it shows up as a Nearby tab in the Information Preview Panel under the default description of the primary Site, much like the opening of a new tab on a browser. In the case of Sites, it shows up next to the Associated Sites tab. When a Site is selected from the Nearby list, the user can choose a navigation option (walking, cycling, driving, or using public transport) from a dropdown menu at the top (between the ‘Explore This Area’ 185 and ‘Bookmark’ 140 buttons) to navigate between the primary item and the selected one. If, however, a location pin on the map is selected (from among locations in the vicinity of the primary item), the description on the left changes to that of the selected Site (address, description, podcasts, etc.). The Explore This Area 185 tool, shows all ‘Live’ items in the visible map area. The Bookmarks 140 tool populates the map with all content saved by the user.

In the case of Tours 53, the Map View shows routes as paths/lines, connecting all Tour Stops as location pins on that path. These Sites and stops are also listed on the info panel as Tour Stops, and each stop may also list Sites in the vicinity. In the case of Events 11, the Map View shows Related Sites as a list in the info panel and as location markers in the Map.

The Map View screen for People 17 pages shows all the projects attached and related to them, including Sites, Albums (if they have images attached to them), Tours, Events, and Related Sites. These show as adjacent tabs in the info panel, much like the tabs of a browser. Each tab contains its own list with thumbnails. The map also shows all this information as pins, lines, and polygons, so it may cover a large area. Consequently, the user can zoom in on any specific area or move around on the screen, aided by a navigation window in the top right corner of the map.

The Explore this Area 185 and Bookmark 140 tools, along with the Filter 187 option, offer a lot of flexibility in how the user can tailor the results on the dashboard. When activated, the Explore this Area 185 and Bookmark tools 140, along with the Nearby tab, are added to the existing tabs on any Site, Person, Tour, or Event page. However, unlike the existing tabs, these three can also be closed out when the user is done with them.

Any Georeferenced (GIS Data or Historic) map overlays 957 in the area on display, appearing on a panel at the bottom of the screen as thumbnails with labels and brief descriptions of each map. These thumbnails can be clicked to activate the maps as overlays on the larger basemap on the screen. Since they are perfectly georeferenced, it is possible for the user to compare historic locations on the maps with where they are located now. A transparency control, available next to the thumbnails, allows for greater insight. Multiple map overlays can be activated at the same time and the thumbnails can be dragged to rearrange the order of the overlay on the basemap. From the Map View, the user can also turn on navigation and use the map to get directions by car, public transit, or foot to the Site.

In case of a Map View page that isn't directed from any Site, Person, Tour, or Event, the Map area covers the vicinity of the user's location and shows location pins for all Sites within that area. If however, the user location is not shared, Lower Manhattan appears on the map by default with a list of Sites in that area. The Information Preview Panel 847 lists the same Sites for either of the cases; the user may then individually explore them.

Relationship Mapping Visualization 869 also appears in the Map View, which highlights the relationship of various items in the database. See information about Relationship Mapping 63 under Special Curated Features FIG. 20A.

User Feature:

Directions and Navigation

Definitions

The Directions and Navigation user feature (see FIG. 1, 75) is directly linked to the Maps and Location sections. The primary objective is to create a map-based user interface that will outline the path that the user can take to reach a particular geographically-placed Building Block 9 (such as a Site or Event) or Feature 41 (such as Tour). The map interface is available on both the Website 7 and Mobile App 1. There is no corresponding CMS for this user feature, and thus the path will be automatically generated by the external Map API integrated with the platform.

This user feature will pick the Location 37 entered in the database, or a general address, and create the path, starting from the user's own location (if permission is thus granted) and ending at the destination entered. Further, the user can select a historic map to overlay on the interface screen, which will simultaneously display how the area being viewed would have looked in the past. While the user is navigating, they have the ability to see content near the user (Near Me/What's Around Me) 235 on the Map to maximize the exploration potential of the platform. Additionally, cultureNOW has also set up the interface in a manner that the path created for the user will create an ‘experiential route’. Instead of showing the shortest distance or fastest route (as is typical of other navigation-based applications), the user will be shown a path that shows the most number of site markers that are part of the cultureNOW database, each of which will be displayed along the way.

User Feature:

Frontend Ui for Adding User Content

Definitions

There is a dedicated platform for Explorer 95 and Portfolio 101 users to add content, one item at a time, from the frontend on the Website 7 and App 1. This prevents untrained users from dealing with the detailed backend CMS. There are two frontend interfaces V1 (Version1) 123 and V2 (Version2). 125.

If the content is added to the cultureNOW database from Frontend Interface V1, 123 the entry fields are limited, and all content is confirmed by Admin Curator 91 users before making the item Live after the user submits content. This is done for 5 Building Blocks—Site 21, People (Person, Organization, Publication, Animal) 17, Events 11, Images 13, Podcasts 19 and 2 Features—Playlists 51 and Tours 53. If the content is added to a Portfolio account from Frontend Interface V2 125, then there are limited entry fields (more than V1), the user can make the item Live 337 themselves, and the content is not vetted by Admin Curators 91.

Portfolio Users 101 and Explorer Users 95 are required to set up a user account before they can add content so that Admin Curators 91 can collaborate with the user if there are questions.

Website Visitor Content Management System Frontend Interface Version 1 (V1) 123 Designed for Explorer 95 Account Holder, a modified frontend item page where they are able to add data from the Website and App. The user interface looks like a finished item page with boxes where the user can type or select content. The user types in text fields. Dropdown lists (i.e. People, date events, category, etc.) have an override option for typing. The advantage to the user is that they see the end result in the appropriate format as they input data.

When the user is ready, they push the submit button and receive a thank you email. Admin Curators 91 will access the content and confirm that the page content is appropriate, and properly labeled, described, credited, captioned, and located. If any of the content can be linked to other components in the database, they will do that. They will also confirm that the rights are applied correctly. If there are additional questions, Admin Curators will contact the Explorer User to discuss. When the page is ready, they will publish it.

When adding Images (see FIG. 5B, 13), the user can enter Image Captions, Descriptions, Date taken, and Image Credits (single or multiple). This is done in the Large Image View, where the areas for data entry are editable text fields.

When adding Podcasts (see FIG. 6, 19), the user can enter a Podcast Title, Descriptions, and Podcast Credits (single or multiple). This is done in the Podcast player view, where the areas for data entry are editable text fields.

When adding Sites (see FIG. 3B, 21), the user can type the Title and select the Category, Sub Category, and Program/Type from dropdown menus. The user can add People and their Role from a dropdown list, with an override option for typing. Descriptions are typed, as are dates and date events. If there are Podcasts, the user can add them here. The user can add multiple point site addresses with a movable pin on the map screen. Images, and limited metadata for the images, can be added by dragging and dropping or selecting from the user's computer. There is no image editing available.

When adding People (see FIG. 4A, 17), the user can type a Name and select a Profession. The user can add affiliations for the Name of an organization from a dropdown list, with an override option for typing. Their Role at the organization is typed into a text field. About is typed, as are dates and the date events. If there are Podcasts, the user can add them here. The user can add multiple point site addresses with a movable pin on the map screen. Additional photographs and Drawings and Documents, along with limited metadata for the Images, can be added by dragging and dropping or selecting from the user's computer. Organizations, publications, and animals have similar fields.

When adding Events (see FIG. 9, 11), the user can type the Name of the Event and select the Event Type. The user can add the Start and End Date and Time from dropdown fields, type in the price of the tickets, and type in (copy-paste) the link for acquiring tickets. The user can also add the affiliations—Hosted by, Sponsors, and other Participants from a dropdown list with an override for typing. ‘About’ is a typed description. The user can add multiple point site addresses with a movable pin on the map screen. Images and Drawings and Documents, along with limited metadata for the Images, can be added by dragging and dropping or selecting from the user's computer.

When adding Playlists (see FIG. 12, 51), the user can edit (add to/remove from/reorder) existing cultureNOW Playlists, or create new ones from the frontend interface. The user can add to the Title and Description text fields. In existing Playlists, the user can remove existing relationships including Events, Tours, Related People, Related Sites, Hashtags, More Playlists by the Curator, and Related Playlists. The user can not add new relationships.

When adding Tours (see FIG. 11, 53), the user can edit (add to/remove from/reorder) existing cultureNOW Tours, or create new ones from the frontend interface. The user can add to the Title and About text fields. In existing Tours, the user can remove existing relationships including Highlights, Duration, Podcasts, What Happened Here, Events, Related Tours, Related People, Related Sites, Historic Maps, Hashtags, and Walking Tour Photos. The user can not add new relationships. The user can add new or modify existing Sites and Stops. The Tour Path is updated automatically based on the Sites and Stops.

Website Visitor Content Management System Frontend Interface Version 2 (V2) 125 Designed for the Portfolio 101 Account Holder, the items above (Images, 13 Podcasts, 19 Sites, 21 People, 17 and Events 11) will have a second Frontend UI Adding Content interface V2, 125 where they can add content from the Frontend UI from the Website and App. The add/edit fields are similar to the ones listed above, but interface V2 will have additional fields which allow the Portfolio Account Holder to link Related People, Sites, Podcasts, Maps, Images, etc to their content. And they also have the ability to modify copies of cultureNOW's original content. This content is published within a closed group and does not affect the cultureNOW database.

User Feature:

Import Csv Bulk Information

Description

The Import CSV Bulk Information feature (see FIG. 21C, 79) is for Collections that have a large amount of pre-organized data.

Content Management System

They will be asked to provide a CSV file of the data. The data is then restructured in a certain way on the CSV so that when we upload it to the platform, the data set maps to the correct fields. Building Blocks 9 that can be uploaded this way are: Site 21, People (Person, Organization, Publication or Animal) 17, and Events 11. After an item is uploaded this way, it is Not Live. The curator will have to go through each entry and confirm the dataset mapping, upload all required information for each entry (for example, Images), and make the item Live.

User Feature:

Print Pdf

Description

Frontend Users can Print PDFs (see FIG. 21B, 83) of all Building Block (Sites. People, Maps, Events, Podcasts and Images) and various Features (Event Series, Playlist, Tours, On This Day/In This Month/In This Year, What Happened Here, Places Over Time, Then and Now and In This Photo) from their respective pages. The PDF layout is programmatically generated, similar to the page layout.

Frontend UI

The first section of the page at the very top has the cultureNOW logo and item title, nickname, and address. The second section is divided into two columns, containing all text content and a location map. The third section has a timeline, if available, in two columns. The fourth section is also divided into two columns and has all Images, drawings and documents, Associated Sites, Tour stops, and Sites. The fifth section has full-page layouts of any attached Maps.

Search

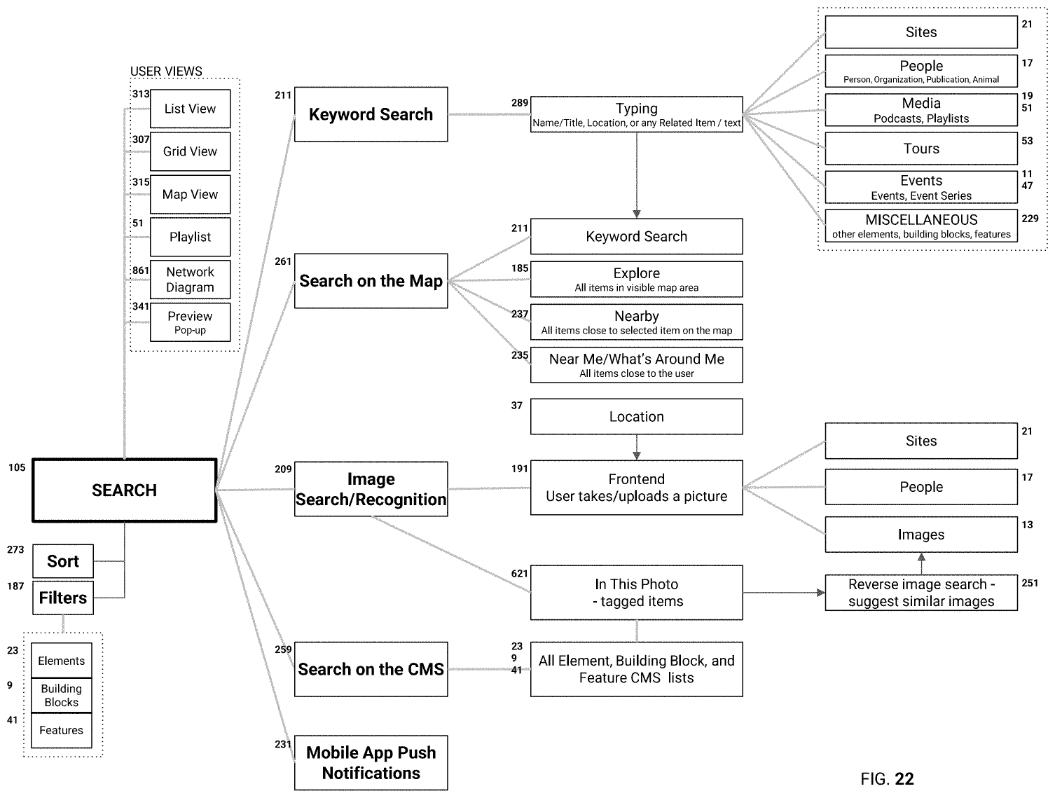

FIG. 22

Description

As shown in FIG. 22, there are four ways that frontend users can interact with the vast database through search: Keyword Search, Search on Map, Image Search, and Mobile App Push Notifications. Backend users utilize search to help with the curation process. Both types of users can use Filters to narrow down search results.

When performing a typed Keyword Search 211, a search query is processed when the user starts typing. 289 The query shows a list of suggested searches based on a predictive autocomplete feature from an external API. The user can select from the suggested items, which saves the user time and effort from typing the entire search keyword. This is programmed to encompass titles from all Building Blocks, Features, possible Locations, and categories to be relevant and responsive to the user.

Search results are presented in a variety of ways:

The default view for search results is broken down into different sections of Building Blocks and Features as headings: Sites 21, People (Person/Individual, Organization, Publication, Animal) 17, Media (Podcasts 19 and Playlists 51), Tours 53, Events (Events 11 and Event Series 47), and Miscellaneous (Images, Maps, On This Day/In This Month/In This Year, What Happened Here, Places Over Time, Then and Now and In This Photo) 229. The results within each section appear in a horizontal scrollable row. The results are organized by relevance to the searched keyword.

Search results can be sorted 273 in various ways (Title, Type, Location, Date, Category, Theme, etc.) to see a different view. For example, search results can be viewed as one continuous Grid View 307 of thumbnails instead of the content being divided up into rows in the List View 313. The results can also be viewed in the Map view 315. All the podcasts in the searched results can be viewed as a Playlist 51 by the user. From the List view, the user can see Preview Pop-up 341 before clicking to go to the item page.

Search results can also be visualized as a Relationship Mapping Network Diagram 861, based on relevance to the searched keyword. Refer to Relationship Mapping on 63, FIG. 20A under Special Curated Features.

The Search on the Map 261 functionality provides the user with multiple ways to explore content on the Map. With a Keyword Search 211, the user can search for a keyword on the map and see relevant results. Explore 185 shows the user items in the visible map area. Nearby 237 allows the user to see items based on proximity to a selected item. Near Me/What's Around Me 235 shows the user items based on proximity to the user's location (for example, if they are standing at a single spot in a city). This feature is also very useful while the user is navigating to a Site or Event, or through a Tour; the user can explore additional items en route. Refer to Map View 315 under User Features for more information about some of these tools.

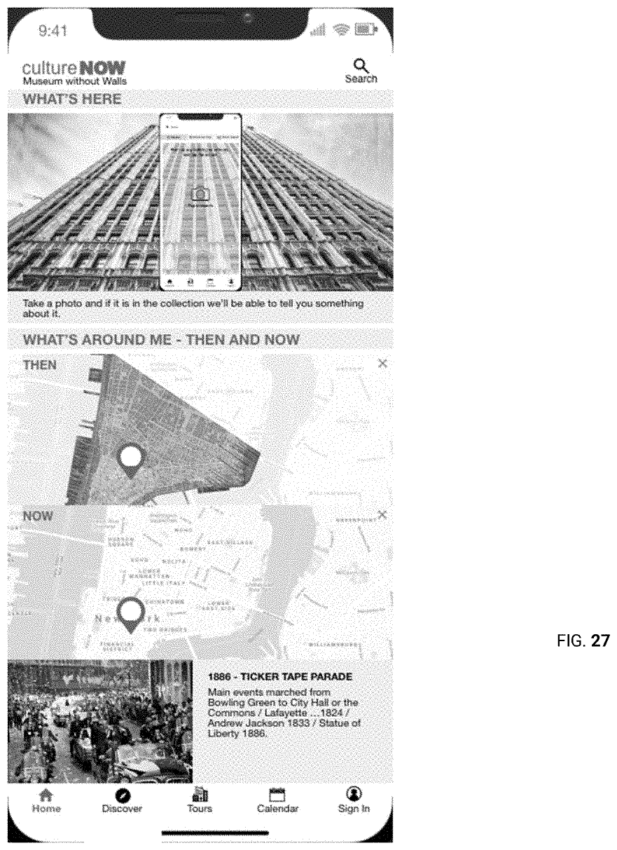

The Image Search/Recognition 209 feature on the website is set up so that it can ‘learn’ as more pictures are uploaded (see FIG. 27). Site and People have additional sections called ‘For Image Recognition’. These Images are uploaded to the backend and do not show up on the frontend. They are used for training the Image recognition API and thus provide more accurate results to the user. Images have a section called In This Photo 621, where tagging Sites and People trains the platform to provide more accurate results for them (refer to In This Photo under Special Curated Features, FIG. 19). The Image recognition API would be overlaid with a Location 37 search for where the image was taken to narrow down the vicinity of the possible results, thus making it more accurate.

The platform provides feedback in the form of Images 13 (that are linked to Sites and People in the photo), as well as Site 21 and People 17 pages where the user can read all related information. On the mobile app frontend, users can take a photo of a sculpture, building, or person and find out what it is. On the website frontend, users can upload a picture for a reverse image search 191.

The user can Search on the CMS 259, a search function is implemented on each individual Element 23, Building Block 9, and Feature 41 CMS lists. Backend users utilize it to narrow down lists, which makes adding, editing, and deleting in the curation process easier. The Reverse Image search 251 function is used after a user tags an image using the In This Photo feature 621. The platform will suggest other images on the database using Reverse Image Search, which has the tagged item. The user can confirm or cancel tagging the additional images. The additional tagged images will make the image search more accurate. Refer to In This Photo under Special Curated Features, FIG. 19.

Mobile App Push Notifications 231 are available on the mobile app. As the user walks through a city, they have the ability (through an action button) to receive pop-up alerts on their phone or on the map with phrases like, “Did You Know?”, “On This Date”, or “What's Around”. They can also see available Podcasts and Then and Now Maps and Images. The user can see things nearby or Highlights of the Day on a locked screen.

With Sort 273 and Filters 187, the user can sort and further narrow down their search results based on Elements 23, Building Blocks 9, or Features 41—title, type, category, theme, affiliation, location, proximity, etc. A similar sort and filter structure is also used for Collections.

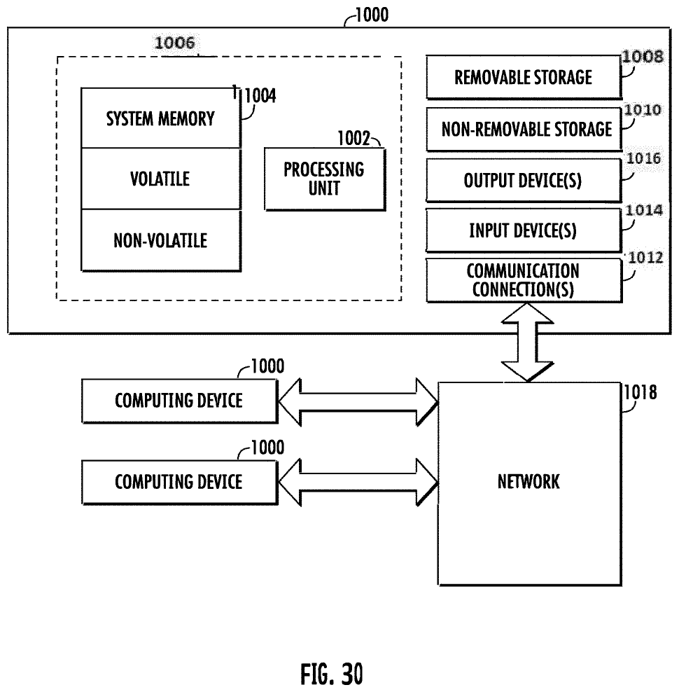

FIG. 30 depicts an exemplary computing environment in which various embodiments of the invention may be implemented and upon which various embodiments of the invention may be employed. The computing system environment is only one example of a suitable computing environment and is not intended to suggest any limitation as to the scope of use or functionality. Numerous other general-purpose or special-purpose computing system environments or configurations may be used. Examples of well-known computing systems, environments, and/or configurations that may be suitable for use include, but are not limited to, personal electronic devices such as smartphones and smartwatches, tablet computers, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 30, an exemplary system for implementing aspects described herein includes a computing device, such as computing device 1000. In its most basic configuration, computing device 1000 typically includes at least one processing unit 1002 and memory 1004. Depending on the exact configuration and type of computing device, memory 1004 may be volatile (such as random access memory (RAM), non-volatile (such as read-only memory (ROM), flash memory, etc.), or some combination of the two. This most basic configuration is illustrated in FIG. 30 by a dashed line 1006. Computing device 1000 may have additional features/functionality. For example, computing device 1000 may include additional storage (removable and/or non-removable) including, but not limited to, magnetic or optical disks or tape. Such additional storage is illustrated in FIG. 30 by removable storage 1008 and non-removable storage 1010. Computing device 1000 as used herein may be either a physical hardware device, a virtual device, or a combination thereof.

Computing device 1000 typically includes or is provided with a variety of computer-readable media. Computer-readable media can be any available media that can be accessed by computing device 1000 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 1004, removable storage 1008, and non-removable storage 1010 are all examples of computer storage media. Computer storage media includes, but is not limited to, Random Access Memory (RAM), Read-Only Memory (ROM), electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can accessed by computing device 1000. Any such computer storage media may be part of computing device 1000.

Computing device 1000 may also contain communications connection(s) 1012 that allow the device to communicate with other devices. Each such communications connection 1012 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media as used herein includes both storage media and communication media.

Computing device 1000 may also have input device(s) 1014 such as keyboard, mouse, pen, voice input device, touch input device, etc. Output device(s) 1016 such as a display, speakers, printer, etc. may also be included. All these devices are generally known and therefore need not be discussed in any detail herein except as provided.

Notably, computing device 1000 may be one of a plurality of computing devices 100p0 interconnected by a network 1018, as is shown in FIG. 30. As may be appreciated, the network 1018 may be any appropriate network; each computing device 1000 may be connected thereto by way of a connection 1012 in any appropriate manner, and each computing device 1000 may communicate with one or more of the other computing devices 1000 in the network 1018 in any appropriate manner. For example, the network 1018 may be a wired or wireless network within an organization or home or the like, and may include a direct or indirect coupling to an external network such as the internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as universal serial bus (USB) flash drives, Secure Digital (SD) memory cards, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations. In an embodiment, the system can be developed using the following languages, for example: Mobile: Flutter; Web: Next.js; CMS: React.js; Backend: Node.js; JSX HTML CSS vanilla JavaScript.

Although exemplary embodiments may refer to utilizing aspects of the presently disclosed subject matter in the context of one or more stand-alone computer systems, the subject matter is not so limited, but rather may be implemented in connection with any computing environment, such as a network 1018 or a distributed computing environment. Still further, aspects of the presently disclosed subject matter may be implemented in or across a plurality of processing chips or devices, and storage may similarly be affected across a plurality of devices in a network 1018. Such devices might include personal computers, network servers, and handheld devices, for example.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. A computer-based system for curating disparate data sets for a museum-level user experience of presentation of the data sets, comprising:
at least one computer server;
a relational database residing at least in part on said computer server, said relational database including a plurality of types of data building blocks, each of said types of data building blocks representing a respective data set, each of said types of data building blocks including a plurality of data elements, each of said data elements representing a type of data and having a plurality of data points, wherein said data building blocks are linkable by shared data in their respective of said data elements, at least one of said data elements appearing in more than one of said data building blocks and functioning as a linking node to respective common of said data building blocks; and
software residing at least partially on at least one user computing device, said software including a user interface enabling a user to interact with said relational database.

2. A computer-based system for curating disparate data sets according to claim 1, wherein said shared data further comprises at least one of interconnected or nested data, thereby enabling cross-referencing across said data building blocks.

3. A computer-based system for curating disparate data sets according to claim 2, wherein said plurality of types of data building blocks include at least two of sites, people, images, maps, or media.

4. A computer-based system for curating disparate data sets according to claim 3, wherein said interconnected or nested data comprises:
site data in said people building block;
at least one of people, location, events, or images in said sites building block;
at least one of people, sites, or events in said images building block.

5. A computer-based system for curating disparate data sets according to claim 2, further comprising a content management system in communication with said relational database and adapted to allow a curator user to connect existing information from said database between different said types of data building blocks.

6. A computer-based system for curating disparate data sets according to claim 5, said content management system further comprising a plurality of building block-specific modules allowing the curator user to link at least two of said data building blocks via predetermined of said data elements.

7. A computer-based system for curating disparate data sets according to claim 1, said software receiving geolocation information from the user computing device and alerting the user via said user interface when the user computing device is within a predetermined distance of a geotagged one of said data points.

8. A computer-based system for curating disparate data sets according to claim 1, said software receiving image information from the user computing device and alerting the user via said user interface about any of said data points that are connected to the received image information.

9. A computer-based system for curating disparate data sets according to claim 8, wherein the image information user alerts include hyperlinks, activatable by the user via said user interface, that link to other of said data points.

10. A computer-based system for curating disparate data sets according to claim 2, wherein said interconnected data includes date-tagged map image data having the same location but different date tags.

11. A computer-based system for curating disparate data sets according to claim 2, wherein said interconnected data includes date-tagged map image data having the same location but different date tags, wherein said interconnected date-tagged map image data is presented on said user interface as two or more images of the same location at different points in time.

12. A computer-based system for curating disparate data sets according to claim 11, wherein the user interface enables the user to toggle between said two or more images via a slider selectively showing a first part of one of said images and a second part of another of said images simultaneously.

13. A computer-based system for curating disparate data sets according to claim 1, said relational database further comprising data features each including multiple of said data building blocks.

14. A computer-based system for curating disparate data sets according to claim 13, said software further comprising a relationship mapping visualization module, adapted to display on said user interface hierarchical relationships between at least one of:
i) two of said data building blocks;
ii) two of said data features; or
iii) one of said data building blocks and one of said data features.

15. A computer-based system for curating disparate data sets according to claim 1, said software further comprising a portfolio management module, adapted to enable a user to create a private portfolio of data with customizable and selectable of at least one of said data building blocks or said data elements and links therebetween.

16. A relational database structured to enable curation of disparate data sets for a museum-level user experience of presentation of the data sets, comprising:
a plurality of types of data building blocks, each of said types of data building blocks representing a respective data set, each of said types of data building blocks including a plurality of data elements, each of said data elements representing a type of data and having a plurality of data points,
wherein said data building blocks are linkable by shared data in their respective of said data elements, at least one of said data elements appearing in more than one of said data building blocks and functioning as a linking node to respective common of said data building blocks.

17. A relational database structured to enable curation of disparate data sets according to claim 16, wherein said shared data further comprises at least one of interconnected or nested data, thereby enabling cross-referencing across said data building blocks.

18. A relational database structured to enable curation of disparate data sets according to claim 17, wherein said plurality of types of data building blocks include at least two of sites, people, images, maps, or media.

19. A relational database structured to enable curation of disparate data sets according to claim 18, wherein said interconnected or nested data comprises:
site data in said people building block;
at least one of people, location, events, or images in said sites building block;
at least one of people, sites, or events in said images building block.

20. A relational database structured to enable curation of disparate data sets according to claim 17, further comprising a content management system in communication with said relational database and adapted to allow an admin user to connect existing information from said relational database between different said types of data building blocks.

21. A relational database structured to enable curation of disparate data sets according to claim 20, said content management system further comprising a plurality of building block-specific modules allowing the curator user to link at least two of said data building blocks via predetermined of said data elements.

22. A relational database structured to enable curation of disparate data sets according to claim 16, further comprising data features each including multiple of said data building blocks.
